(19) United States
(12) Patent Application Publication
(10) Pub. No.: US 2020/0199452 A1
(43) Pub. Date: Jun. 25, 2020

(54) POLYMERIZABLE LIQUID CRYSTAL COMPOSITION, OPTICAL FILM INCLUDING THE SAME, AND METHOD FOR PRODUCING OPTICAL FILM

(71) Applicant: DIC Corporation, Tokyo (JP)

(72) Inventors: Hidetoshi Nakata, Kita-adachi-gun (JP); Yasuhiro Kuwana, Kita-adachi-gun (JP)

(73) Assignee: DIC Corporation, Tokyo (JP)

(21) Appl. No.: 16/615,302

(22) PCT Filed: May 29, 2018
(86) PCT No.: PCT/JP2018/020477

§ 371 Date: Nov. 20, 2019

(30) Foreign Application Priority Data
Jun. 9, 2017 (JP) 2017-114285

(51) Int. Cl. C09K 19/38; C09K 19/54; C08F 222/20; C08F 220/30; G02B 5/30

(52) U.S. Cl. CPC C09K 19/3857; C09K 19/54; C08F 2800/20; C08F 220/303; G02B 5/3016; C08F 222/205

(57) ABSTRACT

A polymerizable liquid crystal composition suitable for a heat-resistant, optical film that has a small selective wavelength shift due to thermal history is disclosed. The polymerizable liquid crystal composition contains a bifunctional polymerizable liquid crystal compound represented by the following general formula (I-2), a chiral compound, and an oxime ester polymerization initiator. In formula (I-2), P¹²¹ and P¹²² denote a polymerizable functional group, Sp¹²¹ and Sp¹²² denote a C1-18 alkylene group, a single bond, or the like, X¹²¹ and X¹²² denote —O—, —S—, or the like, q121 and g122 denote 0 or 1, and MG¹²² denotes a mesogenic group represented by the general formula (I-2-b). In the general formula (I-2-b), A1, A2, and A3 denote a 1,4-phenylene group, a 1,4-cyclohexylene group, or the like, Z1 and Z2 denote —COO—, —OCO—, or the like, and r1 denotes 0, 1, 2 or 3.

P¹²¹-(Sp¹²¹-X¹²¹)_{q121}-MG¹²¹-(X¹²²-Sp¹²²)_{q122}-P¹²² (I-2)

-(A1-Z1)ᵣ₁-A2-Z2-A3- (I-2-b)

### TECHNICAL FIELD

The present invention relates to a polymerisable liquid crystal composition useful as an optically anisotropic body, reflective polarizer, or constituent for use in optical compensation of liquid crystal devices, displays, optical components, colorants, security marking, laser emission components, liquid crystal displays, or the like, an optical film formed of the composition, and an image display apparatus including the optical film.

### BACKGROUND ART

Polymerizable liquid crystal compositions are useful as constituents of optically anisotropic bodies. Optically anisotropic bodies are used in various liquid crystal displays as optical films, such as polarizing films and retardation films, for example. A polarizing film or a retardation film is formed by applying a polymerizable liquid crystal composition to a substrate, evaporating the solvent, and heating the polymerizable liquid crystal composition aligned by an alignment film or irradiating the polymerizable liquid crystal composition aligned by an alignment film with an active energy beam to cure the polymerizable liquid crystal composition. Polymerizable cholesteric liquid crystal compositions containing a polymerizable liquid crystal composition and a chiral compound can be used to form layers that reflect only a particular wavelength, that is, layers that have a selective reflection wavelength, and their applications to various optical filters, infrared reflectors (heat ray cut filters) (PTL 1), and circular polarization splitters are under study. In particular, the use of a circular polarization splitter to improve the color purity of a display is under study (PTL 2 and PTL 3).

Although a circular polarization splitter produced by using a polymerizable cholesteric liquid crystal composition can be used to improve the initial color purity, a liquid crystal panel itself is usually exposed to a high temperature in the range of approximately 50° C. to 60° C. during use of the liquid crystal display, and the use of the liquid crystal display shifts the selective reflection wavelength region to the minus or plus side over time and gradually impairs the initial color reproducibility.

Thus, the heat resistance of an optical device including a circular polarization splitter is an important indicator of the durability of the optical device. After the optical device is held at high temperature, it is desirable that the selective reflection wavelength should not shift.

### CITATION LIST

### Patent Literature

PTL 1: Japanese Unexamined Patent Application Publication No. 2016-4211
PTL 2: Japanese Unexamined Patent Application Publication No. 2004-262884
PTL 3: Japanese Unexamined Patent Application Publication No. 2008-129483

### SUMMARY OF INVENTION

### Technical Problem

It is an object of the present invention to provide a polymerizable liquid crystal composition suitable for a heat-resistant optical film that has a small selective wavelength shift due to thermal history, an optical film formed of the composition, a method for producing the optical film, and an image display apparatus including the optical film.

### Solution to Problem

As a result of extensive studies to achieve the above object, the present inventors have completed the present invention by finding that a cholesteric liquid crystal film formed by polymerizing a polymerizable liquid crystal composition containing a particular bifunctional polymerizable liquid crystal compound, a chiral compound, and an oxime ester polymerization initiator has high heat resistance.

The present invention relates to a polymerizable liquid crystal composition that contains a bifunctional polymerizable liquid crystal compound represented by the following general formula (I-2), a chiral compound, and an oxime ester polymerization initiator.

P¹²¹-(Sp¹²¹-X¹²¹)_{q121}-MG¹²¹-(X¹²²-Sp¹²²)_{q122}-P¹²² (I-2)

(wherein P₁₂₁ and P122 independently denote a polymerizable functional group, Sp¹²¹ and Sp¹²² independently denote an alkylene group having 1 to 18 carbon atoms or a single bond, one —CH₂— or two or more nonadjacent —CH₂— groups in the alkylene group are independently optionally substituted with —COO—, —OCO—, or —OCO—O—, and one or two or more hydrogen atoms of the alkylene group are optionally substituted with a halogen atom or a CN group,

X¹²¹ and X¹²² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P²²¹-Sp¹²¹, P¹²²-Sp¹²², -Sp₁₂₁-X¹²¹, and -Sp¹²²-X¹²² have no direct bonding of heteroatoms), and q121 and q122 independently denote 0 or 1, and

MG¹²² denotes a mesogenic group represented by the general formula (I-2-b), and

[Chem. 1]

-(A1-Z1)ᵣ₁-A2-Z2-A3- (I-2-b)

in the general formula (I-2-b), A1, A2, and A3 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, Z1 and Z2 independently denote —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having 2 to 10 carbon atoms and optionally having a halogen atom, or a single bond, r1 denotes 0, 1, 2, or 3, a plurality of A1s, if present, may be the same or different, and a plurality of Z1s, if present, may be the same or different)

The present invention also relates to an optical film formed of a cured product of the polymerizable liquid crystal composition.

The present invention also relates to a method for producing an optical film that includes applying the polymerizable liquid crystal composition to a substrate, drying the polymerizable liquid crystal composition, and then irradiating the polymerizable liquid crystal composition with ultraviolet light.

The present invention also relates to an image display apparatus including the optical film.

### Advantageous Effects of Invention

A polymerizable liquid crystal composition according to the present invention can provide a polymerizable liquid crystal composition suitable for a heat-resistant optical film that has a small selective wavelength shift due to thermal history, an optical film formed of the composition, a method for producing the optical film, and an image display apparatus including the optical film.

### BRIEF DESCRIPTION OF DRAWINGS

FIG. 1 is a schematic conceptual view of a central value (λ) of a selective reflection wavelength and its half-width (Δλ) in the measurement of spectral transmittance.

### DESCRIPTION OF EMBODIMENTS

Embodiments of a polymerizable liquid crystal composition according to the present invention are described below. The term “liquid crystal” in a polymerizable liquid crystal composition, as used herein, is intended to refer to liquid crystallinity after an organic solvent is removed from the polymerizable liquid crystal composition applied to a substrate. The term “liquid crystal” in a polymerizable liquid crystal compound, as used herein, is intended to refer to liquid crystallinity of only one polymerizable liquid crystal compound to be used or liquid crystallinity of a mixture with another liquid crystal compound. A polymerizable liquid crystal composition can be polymerized by light irradiation, such as ultraviolet radiation, by heating, or by a combination thereof, to produce a polymer (film).

### (Bifunctional Polymerizable Liquid Crystal Compound)

### (Bifunctional Polymerizable Liquid Crystal Compound Represented by General Formula (I-2))

As described above, a bifunctional polymerizable liquid crystal compound used in the present invention is represented by the following general formula (I-2).

[Chem. 2]

P¹²¹-(Sp¹²¹-X₁₂₁)_{q121}-MG₁₂₁-(X¹²²Sp¹²¹)_{q122}P¹²² (I-2)

(wherein P¹²¹ and p¹²² independently denote a polymerizable functional group, Sp¹²¹ and Sp¹²² independently denote an alkylene group having 1 to 18 carbon atoms or a single bond, one —CH₂— or two or more nonadjacent —CH₂— groups in the alkylene group are independently optionally substituted with —COO—, —OCO—, or —OCO—O—, and one or two or more hydrogen atoms of the alkylene group are optionally substituted with a halogen atom (preferably a fluorine atom, a chlorine atom, a bromine atom, or an iodine atom) or a CN group, X¹²¹ and X¹²² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P¹²¹-Sp¹²¹, P¹²²-Sp¹²², Sp¹²¹-X¹²¹, and Sp¹²²-X¹²² have no direct bond of heteroatoms), q121 and q122 independently denote 0 or 1, and MG¹²¹ denotes a mesogenic group)

In the general formula (I-2), p¹²¹ and P¹²² independently denote a polymerizable functional group, preferably a group selected from the following formulae (P-1) to (P-17).

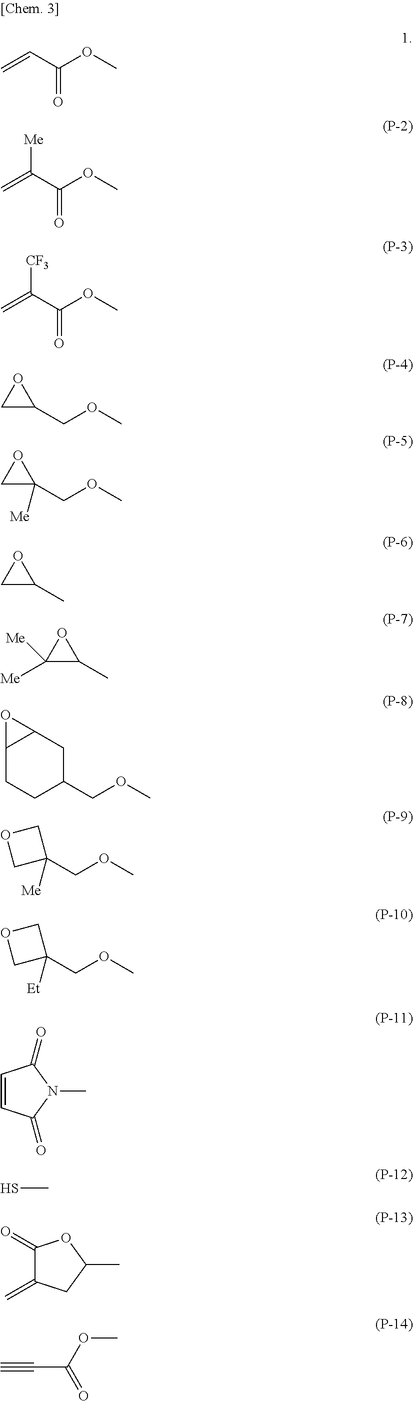

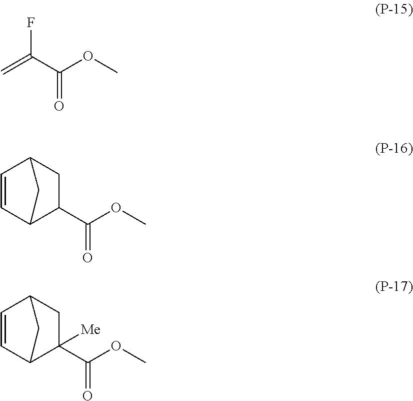

These polymerizable groups are polymerized by radical polymerization, radical addition polymerization, cationic polymerization, or anionic polymerization. In particular, when ultraviolet polymerization is performed as a polymerization method, the formula (P-1), (P-2), (P-3), (P-4), (P-8), (P-10), (P-12), or (P-15) is preferred, the formula (P-1), (P-2), (P-3), (P-4), (P-8), or (P-10) is more preferred, the formula (P-1), (P-2), or (P-3) is still more preferred, and the formula (P-1) or (P-2) is particularly preferred.

In the general formula (I-2), Sp¹²¹ and Sp¹²² preferably independently denote an alkylene group having 1 to 15 carbon atoms, one —CH₂— or two or more nonadjacent —CH₂— groups in the alkylene group are independently optionally substituted with —COO—, —OCO—, or —OCO—O—, and one or two or more hydrogen atoms of the alkylene group are optionally substituted with a halogen atom (preferably a fluorine atom, a chlorine atom, a bromine atom, or an iodine atom) or a CN group, Sp¹¹ and Sp¹² more preferably independently denote an alkylene group having 1 to 12 carbon atoms, and one —CH₂— or two or more nonadjacent —CH₂— groups in the alkylene group are independently optionally substituted with —O—, —COO—, —OCO—, or —OCO—O—.

In the general formula (I-2), X¹²¹ and X¹²² preferably independently denote —O—, —OCH₂—, —CH₂O—, —CO—, —COO—, —OCO—, —O—CO—O—, —CO—NH—, —NH—CO—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and X¹²¹ and X¹²² more preferably independently denote —O—, —OCH₂—, —CH₂O—, —CO—, —COO—, —OCO—, —O—CO—O—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C≡C—, or a single bond.

MG¹²² denotes a mesogenic group, the general formula (I-2-b)

[Chem. 4]

-(A1-Z1)ᵣ₁-A2-Z2-A3- (I-2-b)

In the general formula (I-2-b), A1, A2, and A3 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have as a substituent L² at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms,

Z1 and Z2 independently denote —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having 2 to 10 carbon atoms and optionally having a halogen atom (preferably a fluorine atom, a chlorine atom, a bromine atom, or an iodine atom), or a single bond, Z1 and Z2 preferably independently denote a —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, or a single bond, more preferably —COO—, —OCO—, —OCH₂—, —CH₂O—, —CH₂CH₂O—, —CH₂CH₂OCO—, —COOCH₂CH₂—, —OCOCH₂CH₂—, or a single bond, r1 denotes 0, 1, 2, or 3, a plurality of A1s, if present, may be the same or different, and a plurality of Z1s, if present, may be the same or different. Among these, A1, A2, and A3 preferably independently denote a 1,4-phenylene group, a 1,4-cyclohexylene group, or a 2,6-naphthylene group (the 1,4-phenylene group and 2,6-naphthylene group optionally have the substituent L2).

Examples of the general formula (I-2) include, but are not limited to, the compounds represented by the following general formulae (I-2-1) to (I-2-4).

[Chem. 5]

P¹²¹-(Sp¹²¹-X¹²¹)_{q121}-A2-Z2-A3-(X¹²²-Sp¹²²)_{q122}-P¹²² (I-2-1)

P¹²¹(Sp¹²¹-X¹²¹)_{q121}-A11-Z11-A2-Z2-A3-(X¹²²-Sp¹²²)_{q122}-P¹²² (I-2-2)

P¹²¹-(Sp¹²¹-X¹²¹)_{q121}-A11-Z11-A12-Z12-A2-Z2-A3-(X¹²²-Sp¹²²)_{q122}-P¹²² (I-2-3)

P¹²¹-(Sp¹²¹-X¹²¹)_{q121}-A11-Z11-A12-Z12-A13-Z13-A2-Z2-A3-(X¹²²-Sp¹²²)_{q122}-P¹²² (I-2-4)

In the formulae, P¹²¹, Sp¹¹², X¹²¹, q121, X¹²², Sp¹²², q122, and p¹²² are the same as defined in the general formula (I-2),

A11 and A12 and A13, A2, and A3 are the same as A1 to A3 defined in the general formula (I-2-b) and may be the same or different, and

Z11 and Z12 and Z13, and Z2 are the same as Z1 and Z2, respectively, defined in the general formula (I-2-b) and may be the same or different.

Among the compounds represented by the general formulae (I-1-1-1) to (I-1-1-4), the compounds represented by the general formulae (I-2-2) to (I-2-4) and having three or more ring structures are preferably used in terms of good alignment of an optically anisotropic body formed, and the compounds represented by the general formula (I-2-2) and having three ring structures are particularly preferably used.

Examples of the compounds represented by the general formulae (I-2-1) to (I-2-4) include, but are not limited to, the compounds represented by the following formulae (I-2-1-1) to (I-2-1-21).

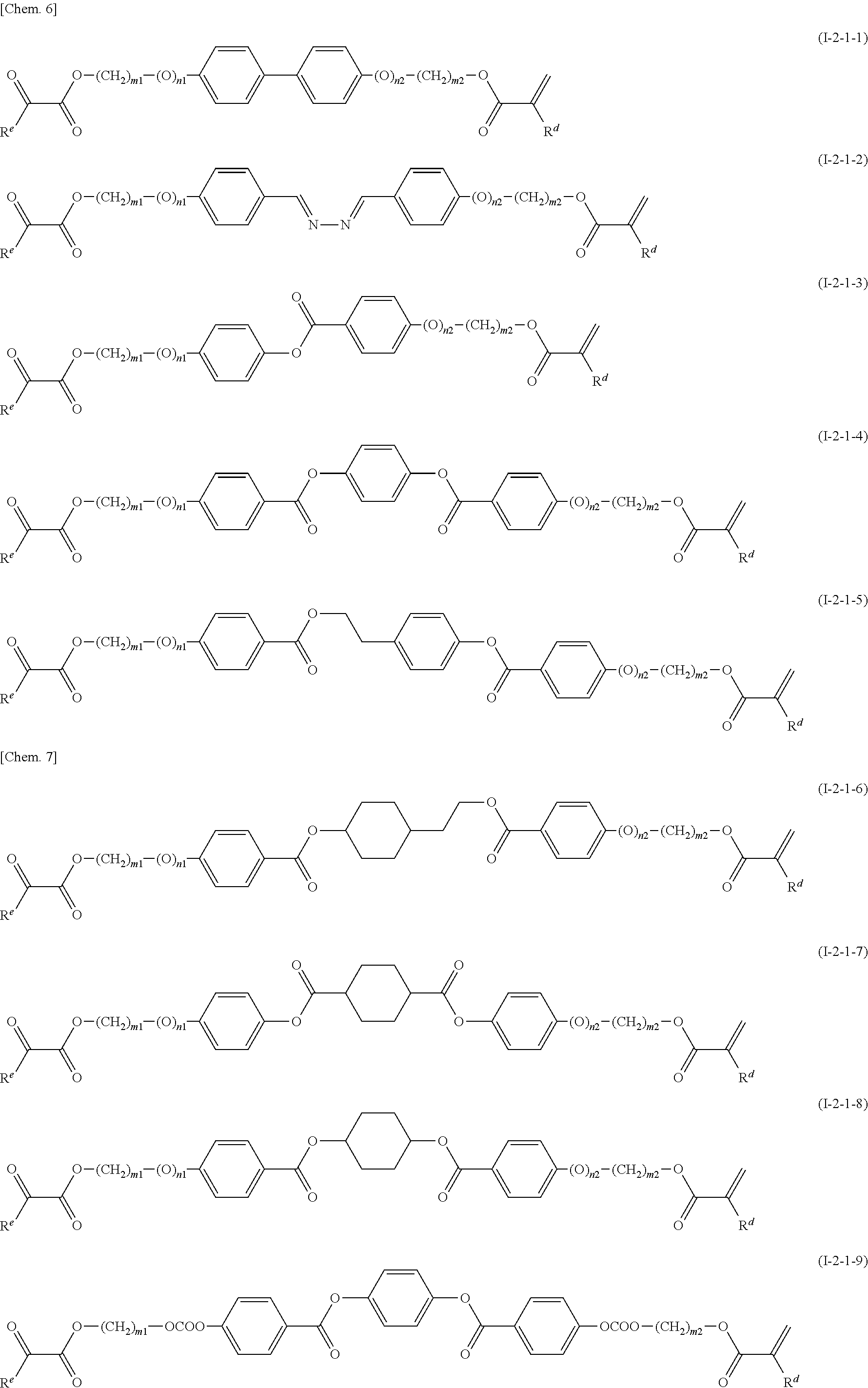

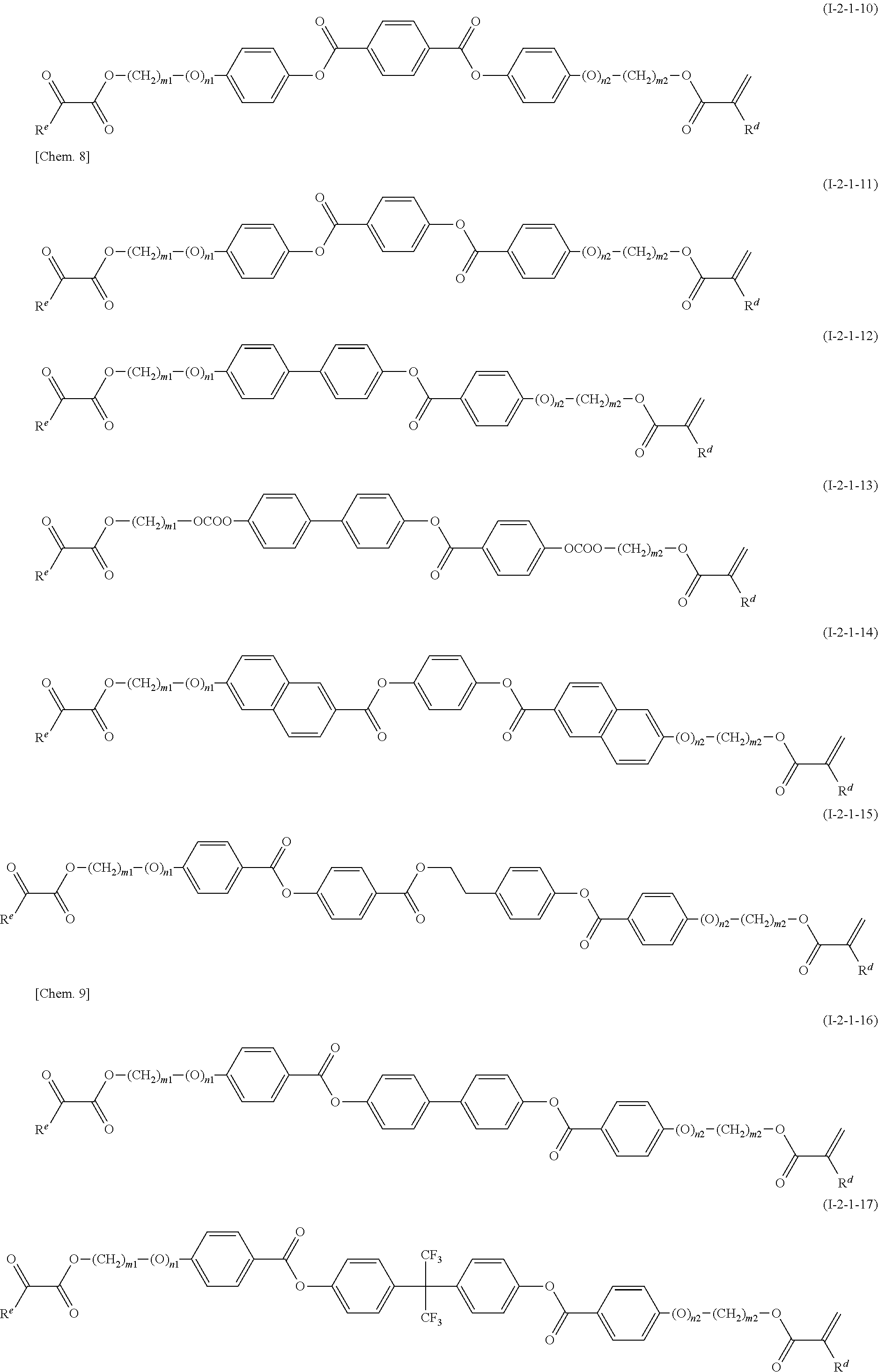

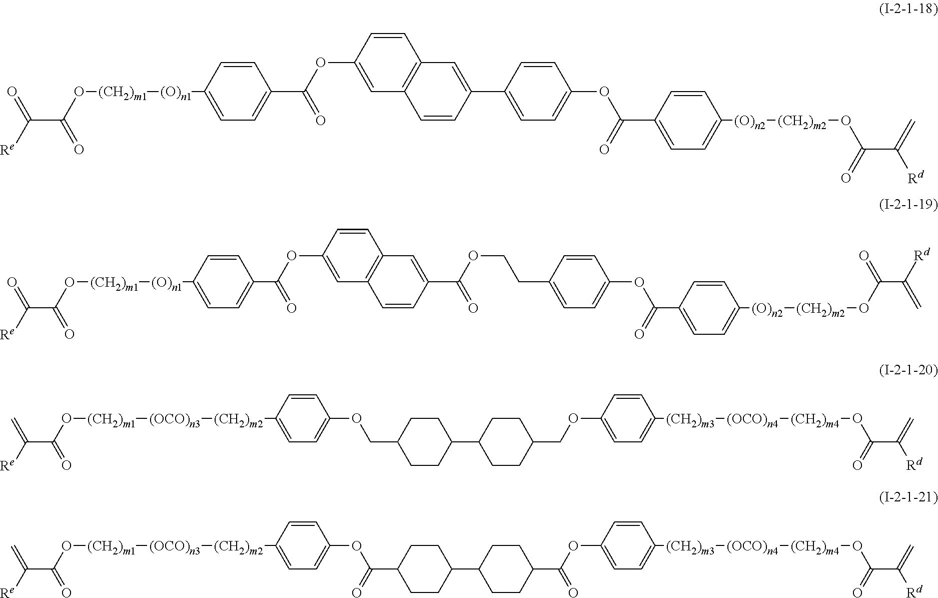

In the general formulae (I-2-1-1) to (I-2-1-21), R^{d} and R^{e} independently denote a hydrogen atom or a methyl group,

the cyclic groups may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, or alkenoyloxy group having 2 to 8 carbon atoms, and

m1, m2, m3, and m4 independently denote an integer in the range of 0 to 18, preferably independently an integer in the range of 0 to 8, and n1, n2, n3, and n4 independently denote 0 or 1.

One or two or more bifunctional polymerizable liquid crystal compounds represented by the general formula (I-2) may be used. The total amount of bifunctional polymerizable liquid crystal compounds represented by the general formula (I-2) preferably ranges from 0% to 50% by mass, more preferably 0% to 30% by mass, of the total amount of polymerizable liquid crystal compounds used in a polymerizable liquid crystal composition. To facilitate the formation of a twisted nematic phase or a cholesteric phase when a chiral compound is added to a polymerizable liquid crystal composition, a polymerizable liquid crystal compound preferably has an asymmetrical structure or preferably has a substituent in its mesogenic skeleton portion, and such a polymerizable liquid crystal compound particularly preferably constitutes 0% to 20% by mass of the total amount of polymerizable liquid crystal compounds used in the polymerizable liquid crystal composition. More specifically, these percentage ranges are also preferred in the use of compounds represented by the general formulae (I-2-1) to (I-2-4) or even compounds represented by the general formulae (I-2-1-1) to (I-2-1-21).

More specifically, examples of the compounds represented by the general formulae (I-2-1-1) to (I-2-1-21) include, but are not limited to, the compounds represented by the following general formulae (I-2-2-1) to (I-2-2-24).

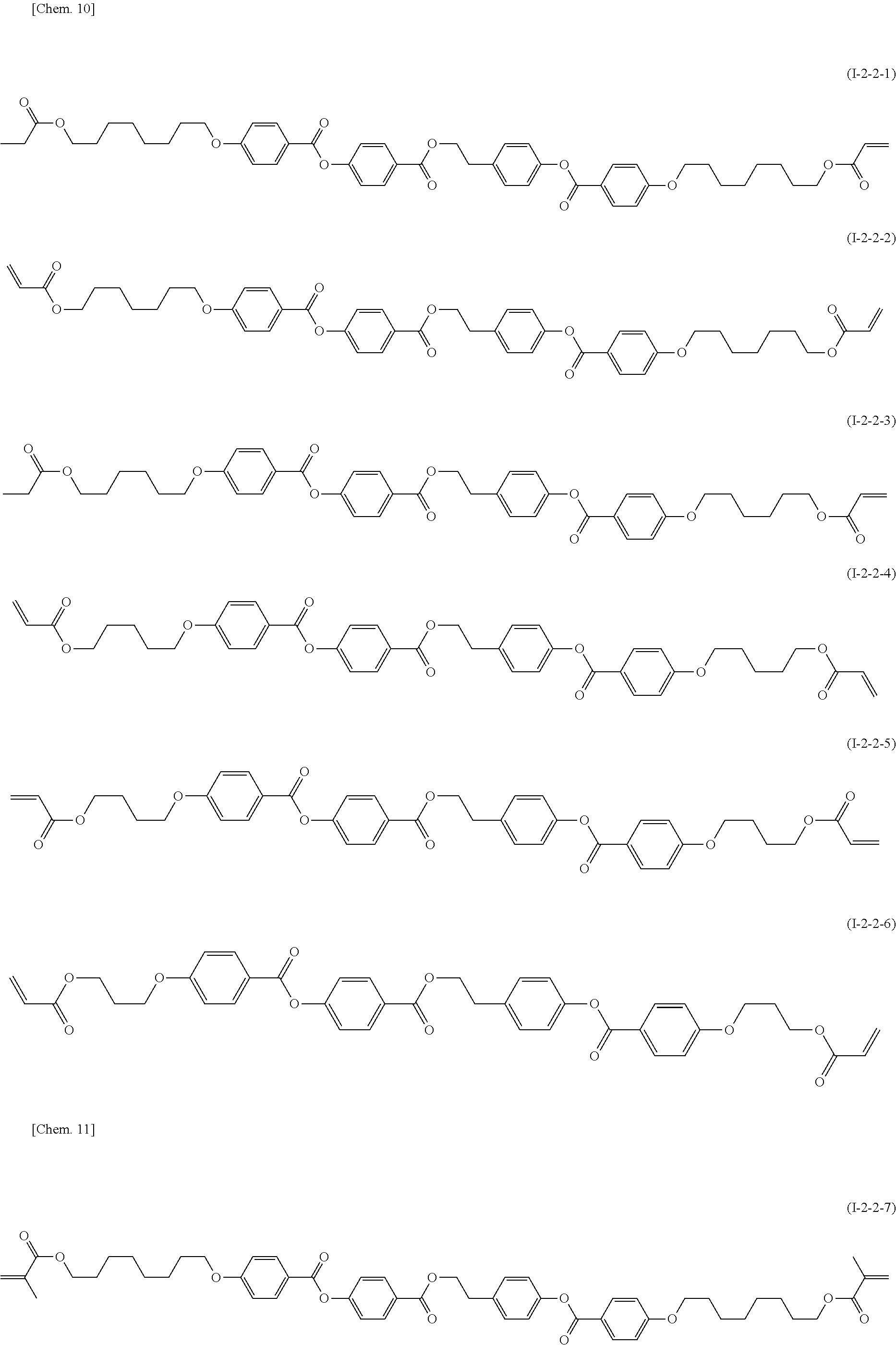

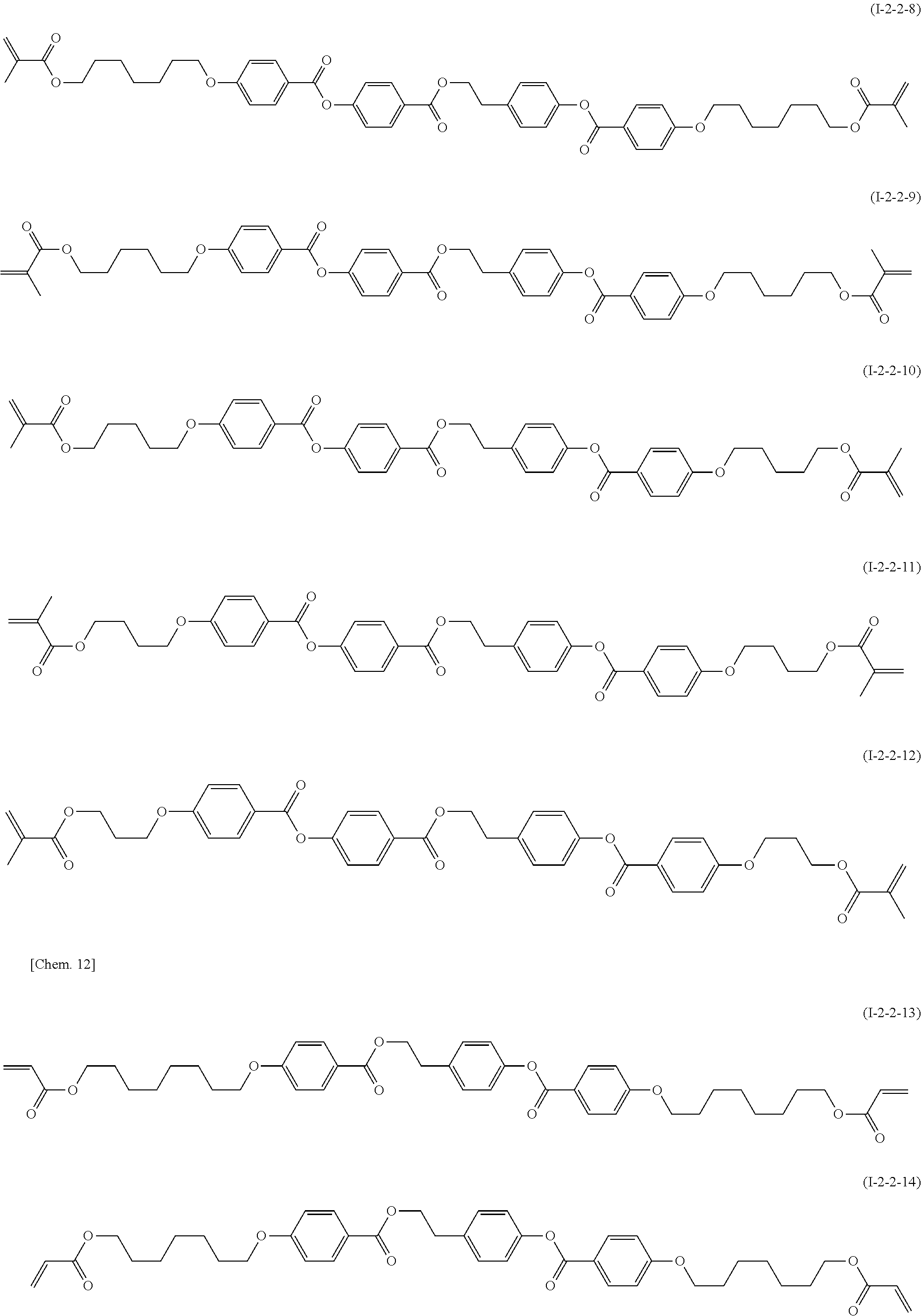

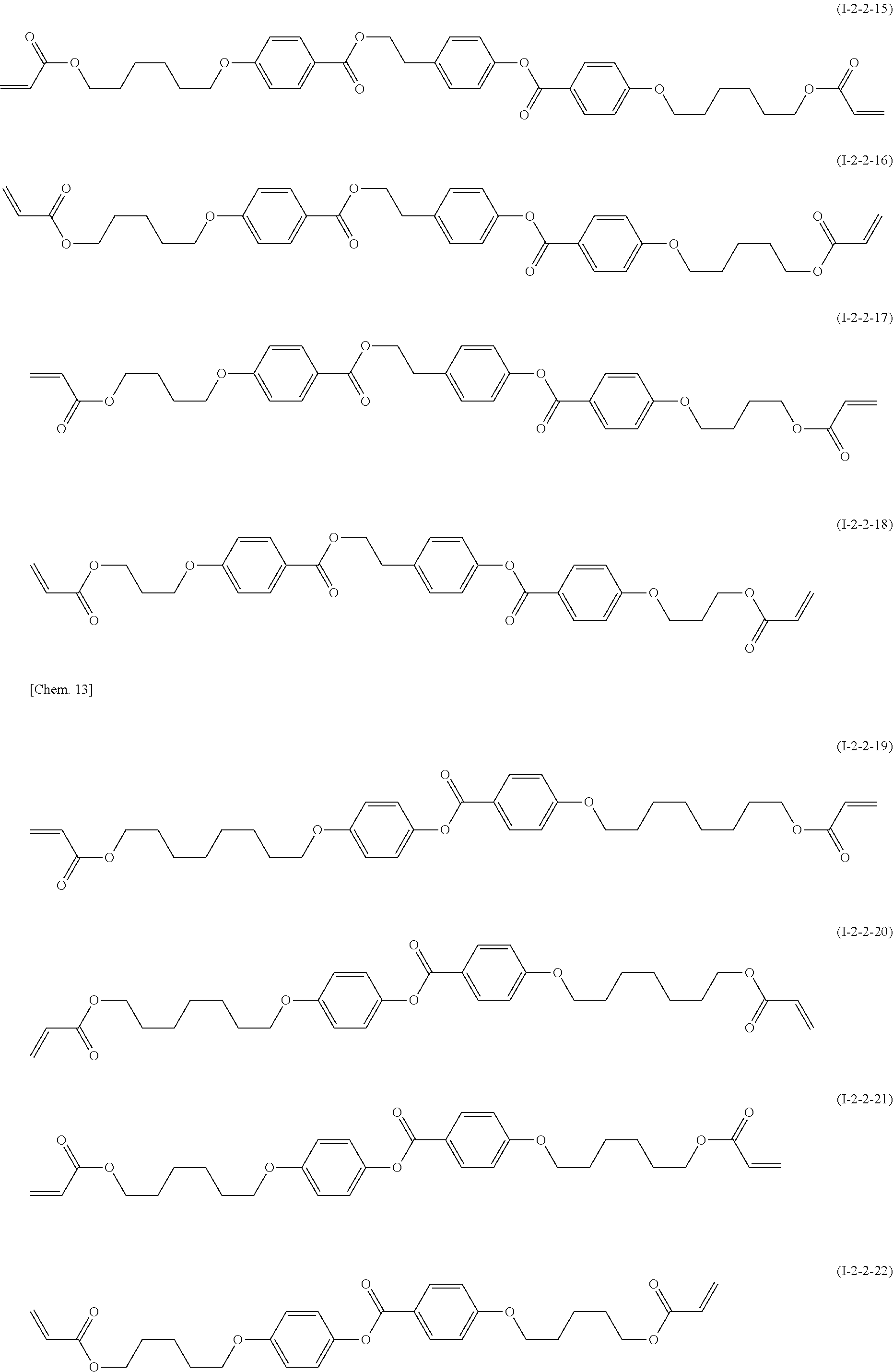

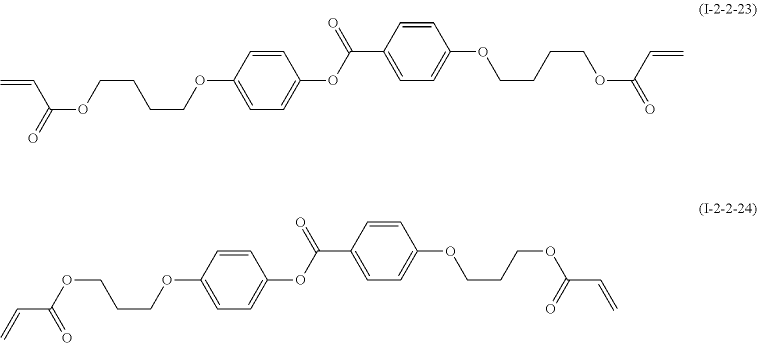

One or two or more bifunctional polymerizable liquid crystal compounds represented by the general formula (I-2) may be used. The total amount of bifunctional polymerizable liquid crystal compounds represented by the general formula (I-2) preferably ranges from 16% to 100% by mass, more preferably 20% to 100% by mass, particularly preferably 30% to 90% by mass, most preferably 50% to 90% by mass, of the total amount of polymerizable liquid crystal compounds used in a polymerizable liquid crystal composition.

### (Bifunctional Polymerizable Liquid Crystal Compound Represented by General Formula (I-1))

Among the compounds represented by the general formula (I-2), more preferred are the polymerizable liquid crystal compounds represented by the following general formula (I-1).

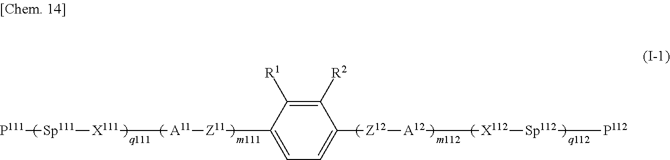

(wherein P¹¹¹ and P¹¹² independently denote a polymerizable functional group,

Sp¹¹¹ and Sp¹¹² independently denote an alkylene group having 1 to 18 carbon atoms or a single bond, one —CH₂— or two or more nonadjacent —CH₂— groups in the alkylene group are independently optionally substituted with —COO—, —OCO—, or —OCO—O—, and one or two or more hydrogen atoms of the alkylene group are optionally substituted with a halogen atom or a CN group,

X¹¹¹ and X¹¹² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P¹¹¹-Sp¹¹¹, P¹¹²-Sp¹¹², Sp¹¹¹-X¹¹¹, and Sp¹²²-X¹¹² have no direct bonding of oxygen atoms),

q111 and q112 independently denote 0 or 1,

A¹¹ and A¹² independently denote a 1,4-phenylene group, a 1,4-cyclohexylene group, a bicyclo[2,2,2]octane-1,4-diyl group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, and these groups are unsubstituted or optionally substituted with at least one substituent L,

L denotes a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, an optionally substituted phenyl group, an optionally substituted phenylalkyl group, an optionally substituted cyclohexylalkyl group, or a linear or branched alkyl group having 1 to 20 carbon atoms in which one —CH₂— or two or more nonadjacent —CH₂— groups are independently optionally substituted with —O—, —S—, —CO—, —COO—, —OCO—, —CO—S—, —S—CO—, —O—CO—O—, —CO—NR⁰—, —NR⁰—CO—, —CH═CH—COO—, —CH═CH—OCO—, —COO—CH═CH—, —OCO—CH═CH—, —CH═CH—, —N═N—, —CR⁰═N—, —N═CR⁰—, —CH═N—N═CH—, —CF═CF—, or —C≡C— (wherein R⁰ denotes a hydrogen atom or an alkyl group having 1 to 8 carbon atoms), a hydrogen atom of the alkyl group is optionally substituted with a fluorine atom, a plurality of Ls, if present, in the compound may be the same or different, a plurality of Arts, if present, may be the same or different, and a plurality of A¹²s, if present, may be the same or different,

Z¹¹ and Z¹² independently denote —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, a plurality of Z¹¹s, if present, may be the same or different, and a plurality of Z¹²s, if present, may be the same or different,

m111 and m112 independently denote an integer in the range of 0 to 2, and

R¹ and R² independently denote a hydrogen atom, a fluorine atom, a cyano group, a hydroxy group, a nitro group, an alkyl group having 1 to 10 carbon atoms, an alkoxy group having 1 to 10 carbon atoms, an acyl group having 2 to 10 carbon atoms, an alkylcarbonyloxy group having 2 to 10 carbon atoms, or an alkoxycarbonyl group having 2 to 10 carbon atoms, R¹ or R² denotes a group other than a hydrogen atom, or R², together with the substituent L of adjacent A², denotes a cyclic group)

In the general formula (I-1), P¹¹¹ and p¹¹² independently denote a polymerizable functional group, preferably a group selected from the following formulae (P-1) to (P-17).

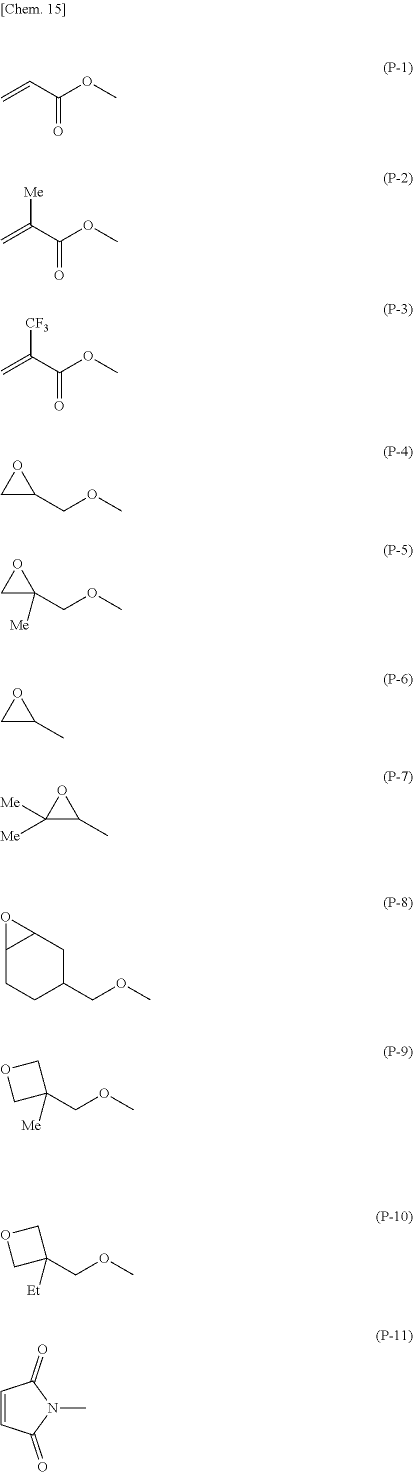

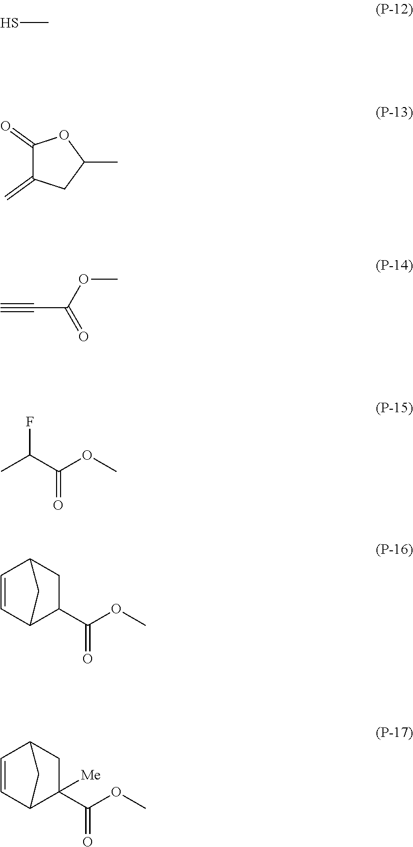

These polymerizable groups are polymerized by radical polymerization, radical addition polymerization, cationic polymerization, or anionic polymerization. In particular, when ultraviolet polymerization is performed as a polymerization method, the formula (P-1), (P-2), (P-3), (P-4), (P-8), (P-10), (P-12), or (P-15) is preferred, the formula (P-1), (P-2), (P-3), (P-4), (P-8), or (P-10) is more preferred, the formula (P-1), (P-2), or (P-3) is still more preferred, and the formula (P-1) or (P-2) is particularly preferred.

In the general formula (I-1), gill and q112 independently denote 0 or 1, particularly preferably 1.

In the general formula (I-1), Sp¹¹¹ and Sp¹¹² independently denote an alkylene group having 1 to 18 carbon atoms or a single bond, one —CH₂— or two or more nonadjacent —CH₂— groups in the alkylene group are independently optionally substituted with —COO—, —OCO—, or —OCO—O—, and one or two or more hydrogen atoms of the alkylene group are optionally substituted with a halogen atom (preferably a fluorine atom, a chlorine atom, a bromine atom, or an iodine atom) or a CN group. Sp¹¹¹ and Sp¹¹² more preferably independently denote an alkylene group having 1 to 12 carbon atoms, and one —CH₂— or two or more nonadjacent —CH₂— groups in the alkylene group are independently optionally substituted —COO—, —OCO—, or —OCO—O—. Sp¹¹¹ and Sp¹¹² independently particularly preferably denote an alkylene group having 1 to 8 carbon atoms.

In the general formula (I), X¹¹¹ and X¹¹² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond. X¹¹¹ and X¹¹² more preferably independently denote —O—, —OCH₂—, —CH₂O—, —CO—, —COO—, —OCO—, —O—CO—O—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C≡C—, or a single bond. X¹¹¹ and X¹¹² particularly preferably independently denote —O— or a single bond.

In the general formula (I-1), A¹¹ and A¹² independently denote a 1,4-phenylene group, a 1,4-cyclohexylene group, a bicyclo[2,2,2]octane-1,4-diyl group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, and these groups are unsubstituted or optionally substituted with at least one substituent L. In terms of the ease of synthesis, availability of raw materials, and liquid crystallinity, A¹¹ and A¹² preferably independently denote a 1,4-phenylene group, a 1,4-cyclohexylene group, a bicyclo[2,2,2]octane-1,4-diyl group, a naphthalene-2,6-diyl group, or a naphthalene-1,4-diyl group each unsubstituted or optionally substituted with at least one substituent L, and more preferably independently denote a group selected from the following formulae (A-1) to (A-16).

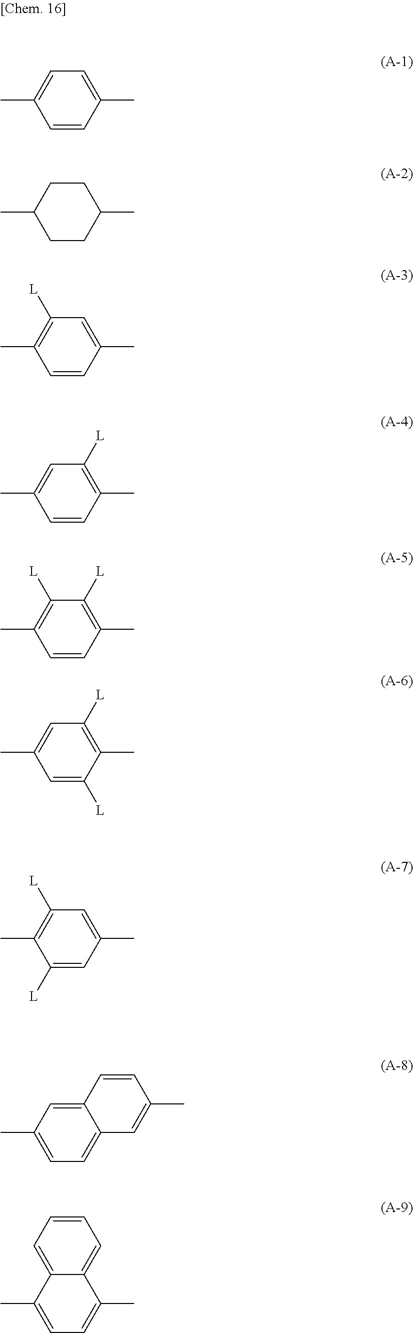

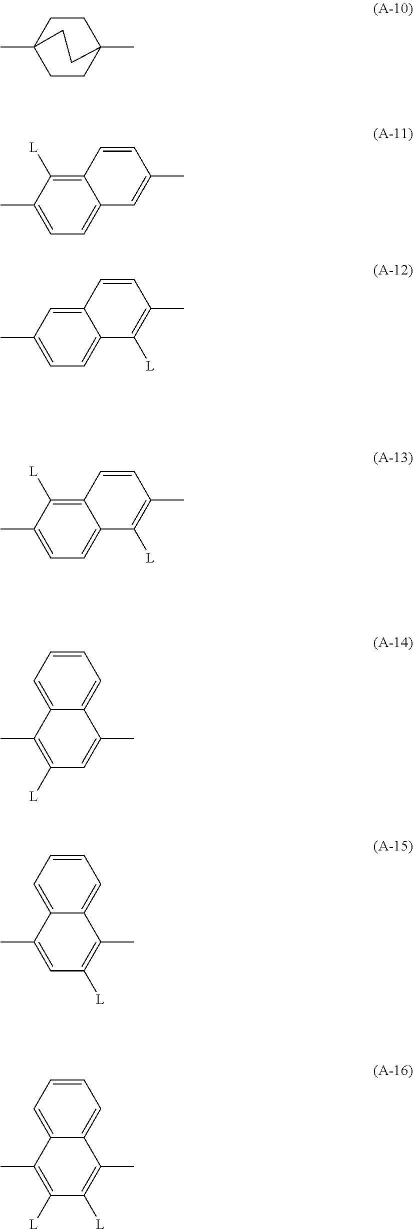

Furthermore, in terms of the viscosity of the compound, A¹¹ and A¹² present more preferably independently denote a group selected from the formulae (A-1) to (A-7) and (A-10). A¹¹ and A¹² present still more preferably independently denote a group selected from the formulae (A-1) to (A-7). A¹¹ and A¹² present particularly preferably independently denote a group selected from the formulae (A-1) to (A-4). A plurality of A¹¹s, if present, may be the same or different, and a plurality of A¹²s, if present, may be the same or different.

In the general formula (I-1), L denotes a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, an optionally substituted phenyl group, an optionally substituted phenylalkyl group, an optionally substituted cyclohexylalkyl group, or a linear or branched alkyl group having 1 to 20 carbon atoms in which one —CH₂— or two or more nonadjacent —CH₂— groups are independently optionally substituted with —O—, —S—, —CO—, —COO—, —OCO—, —CO—S—, —S—CO—, —O—CO—O—, —CO—NR₀—, —NR⁰—CO—, —CH═CH—COO—, —CH═CH—OCO—, —COO—CH═CH—, —OCO—CH═CH—, —CH═CH—, —N═N—, —CR⁰═N—, —N═CR⁰—, —CH═N—N═CH—, —CF═CF—, or —C≡C— (wherein R⁰ denotes a hydrogen atom or an alkyl group having 1 to 8 carbon atoms), a hydrogen atom of the alkyl group is optionally substituted with a fluorine atom, and a plurality of Ls, if present, in the compound may be the same or different. In terms of liquid crystallinity and the ease of synthesis, the substituent L preferably denotes a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which a hydrogen atom is optionally substituted with a fluorine atom and in which one —CH₂— or two or more nonadjacent —CH₂— groups are independently optionally substituted with a group selected from —O—, —S—, —CO—, —COO—, —OCO—, —O—CO—O—, —CH═CH—, —CF═CF—, and —C≡C—. The substituent L more preferably denotes a fluorine atom, a chlorine atom, or a linear or branched alkyl group having 1 to 12 carbon atoms in which a hydrogen atom is optionally substituted with a fluorine atom and in which one —CH₂— or two or more nonadjacent —CH₂— groups are independently optionally substituted with a group selected from —O—, —COO—, and —OCO—. The substituent L still more preferably denotes a fluorine atom, a chlorine atom, or a linear or branched alkyl group or alkoxy group having 1 to 12 carbon atoms in which a hydrogen atom is optionally substituted with a fluorine atom. The substituent L particularly preferably denotes a fluorine atom, a chlorine atom, or a linear alkyl group or linear alkoxy group having 1 to 8 carbon atoms.

In the general formula (I-1), Z¹¹ and Z¹² independently denotes —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH═CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, a plurality of Z¹¹, if present, may be the same or different, and a plurality of Z¹¹s, if present, may be the same or different. In particular, attaching importance to fewer alignment defects, a plurality of Z¹¹s, if present, may be the same or different, a plurality of Z¹²s, if present, may be the same or different, and Z¹¹ and Z¹² preferably independently denote —OCH₂—, —CH₂O—, —CH₂CH₂—, —COO—, —OCO—, —CO—NH—, —NH—CO—, —CH═CH—COO—, —OCO—CH═CH—, —COO—CH₂CH₂—, —CH₂CH₂—OCO—, —CH═CH—, —N═N—, —CH═N—, —N═CH—, —CH═N—N═CH—, —CF═CF—, —C≡C—, or a single bond. More preferably, a plurality of Z¹¹s, if present, may be the same or different, a plurality of Z¹²s, if present, may be the same or different, and Z¹¹ and Z¹² independently denote —OCH₂—, —CH₂O—, —COO—, —OCO—, —CO—NH—, —NH—CO—, —CH═CH—COO—, —OCO—CH═CH—, —CH═CH—, —N═N—, —CH═N—N═CH—, —CF═CF—, —C≡C—, or a single bond. Still more preferably, a plurality of Z¹¹s, if present, may be the same or different, a plurality of Z¹²s, if present, may be the same or different, and Z¹¹ and Z¹¹ independently denote —OCH₂—, —CH₂O—, —COO—, —OCO—, —CO—NH—, —NH—CO—, or a single bond. Particularly preferably, a plurality of Z¹¹s, if present, may be the same or different, a plurality of Z¹² s, if present, may be the same or different, and Z¹¹ and Z¹² independently denote —OCH₂—, —CH₂O—, —COO—, —OCO—, or a single bond.

In the general formula (I-1), mill and m112 independently denote an integer in the range of 0 to 2, m111+m112 is preferably 1 or 2, m111+m112 is more preferably 2, and both m11 and m112 are particularly preferably 1.

In the general formula (I-1), R¹ and R² independently denote a hydrogen atom, a fluorine atom, a cyano group, a hydroxy group, a nitro group, an alkyl group having 1 to 10 carbon atoms, an alkoxy group having 1 to 10 carbon atoms, an acyl group having 2 to 10 carbon atoms, an alkylcarbonyloxy group having 2 to 10 carbon atoms, an alkoxycarbonyl group having 2 to 10 carbon atoms, or an aromatic ring group having 5 to 12 carbon atoms, and R¹ or R² denotes a group other than a hydrogen atom. A preferred group other than a hydrogen atom is more preferably a fluorine atom, a cyano group, a hydroxy group, a nitro group, an alkyl group having 1 to 6 carbon atoms, or an alkoxy group having 1 to 6 carbon atoms, still more preferably a fluorine atom, an alkyl group having 1 to 4 carbon atoms, or an alkoxy group having 1 to 4 carbon atoms, particularly preferably an alkyl group having 1 to 4 carbon atoms or an alkoxy group having 1 to 4 carbon atoms. R¹ or R² denotes a group other than a hydrogen atom, and one of R¹ and R² preferably denotes a hydrogen atom, and the other preferably denotes a group other than a hydrogen atom.

Alternatively, R², together with the substituent L of adjacent A¹², denotes a cyclic group.

More specifically, the compounds represented by the general formula (I-1) are preferably the compounds represented by the following formulae (I-1-1) to (I-1-7).

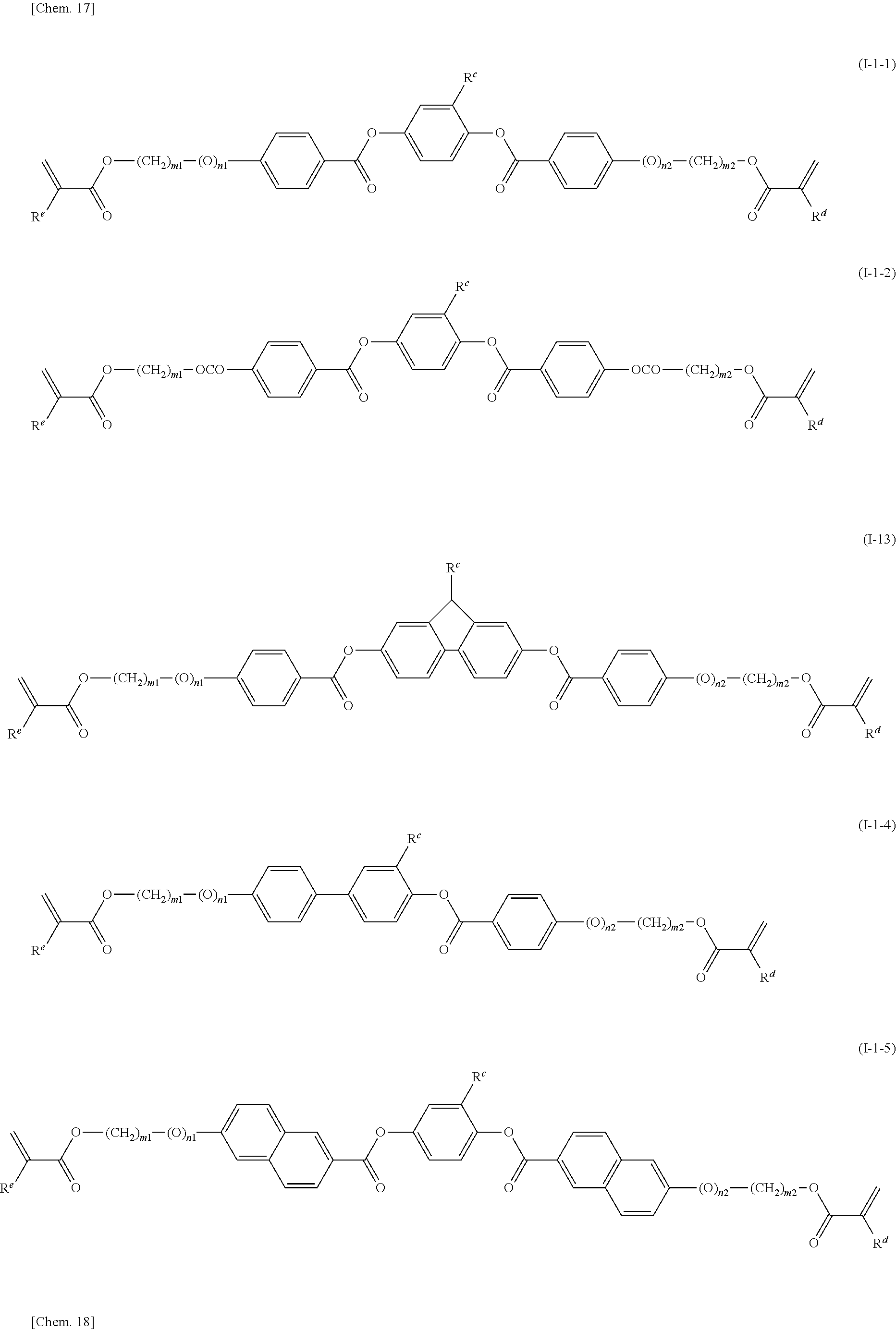

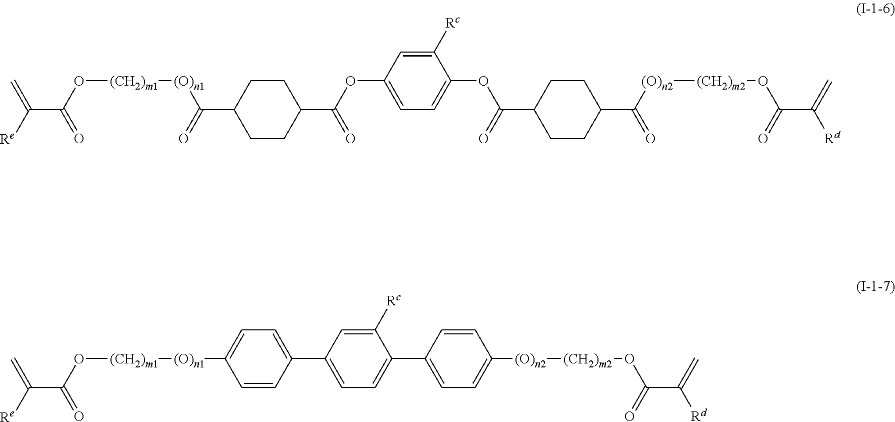

(In the general formulae (I-1-1) to (I-1-7), R^{e} and R^{d} independently denote a hydrogen atom or a methyl group, m1 and m2 independently denote an integer in the range of 0 to 8, n1 and n2 independently denote 0 or 1, and n1 denotes 0 if m1 is 0, and n2 denotes 0 if m2 is 0.) Among the general formulae (I-1-1) to (I-1-7), a compound represented by the general formula (I-1-1) is most preferred.

One or two or more bifunctional polymerizable liquid crystal compounds represented by the general formula (I-1) may be used. The total amount of bifunctional polymerizable liquid crystal compounds represented by the general formula (I-1) preferably ranges from 16% to 100% by mass, more preferably 20% to 100% by mass, particularly preferably 30% to 90% by mass, most preferably 50% to 90% by mass, of the total amount of polymerizable liquid crystal compounds used in a polymerizable liquid crystal composition. More specifically, these percentage ranges are also preferred in the general formulae (I-1-1) to (I-1-5).

### (Monofunctional Polymerizable Liquid Crystal Compound)

### (Monofunctional Polymerizable Liquid Crystal Compound Represented by General Formula (II-2))

A polymerizable liquid crystal composition according to the present invention contains a bifunctional polymerizable liquid crystal compound represented by the general formula (I-2), preferably a bifunctional polymerizable liquid crystal compound represented by the general formula (I-1). In addition to such a bifunctional polymerizable liquid crystal compound, a monofunctional polymerizable liquid crystal compound represented by the following general formula (II-2) is also preferably used to improve the compatibility of the polymerizable liquid crystal composition and to reduce a shift in the selective reflection wavelength after being held at high temperature when measured at a practical level of UV radiation.

[Chem. 19]

P²²¹-Sp²²¹-X²²¹MG²²¹-R²²¹ (II-2)

In the formula, p²²¹ denotes a polymerizable functional group, Sp²²¹ denotes an alkylene group having 1 to 18 carbon atoms or a single bond, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (preferably a fluorine atom, a chlorine atom, a bromine atom, or an iodine atom) or a CN group, X²²¹ denotes —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P²²¹-Sp²²¹ and Sp²²¹-X²²¹ have no direct bonding of heteroatoms other than C or H), MG²²¹ denotes a mesogenic group, R²²¹ denotes a hydrogen atom, a halogen atom (preferably a fluorine atom, a chlorine atom, a bromine atom, or an iodine atom), a cyano group, a linear or branched alkyl group having 1 to 12 carbon atoms, or a linear or branched alkenyl group having 1 to 12 carbon atoms, one —CH₂— or two or more nonadjacent —CH₂— groups in the alkyl group and the alkenyl group are independently optionally substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—, one or two or more hydrogen atoms of the alkyl group and the alkenyl group are independently optionally substituted with a halogen atom (preferably a fluorine atom, a chlorine atom, a bromine atom, or an iodine atom) or a cyano group, and a plurality of substituents, if present, may be the same or different.

In the general formula (II-2), p²²¹ denotes a polymerizable functional group, preferably a group selected from the following formulae (P-1) to (P-17).

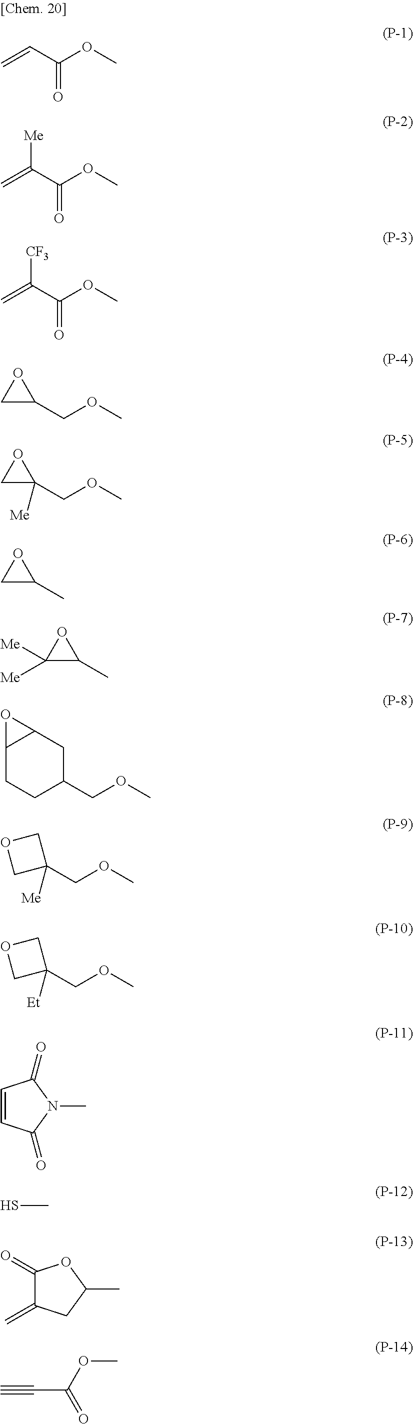

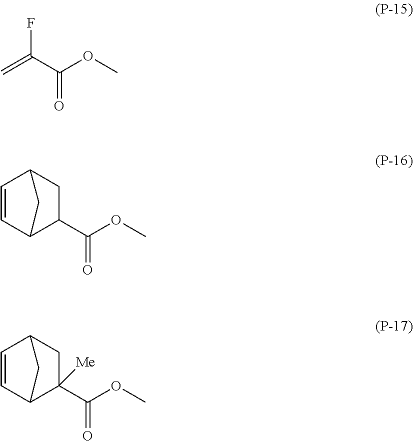

These polymerizable groups are polymerized by radical polymerization, radical addition polymerization, cationic polymerization, or anionic polymerization. In particular, when ultraviolet polymerization is performed as a polymerization method, the formula (P-1), (P-2), (P-3), (P-4), (P-8), (P-10), (P-12), or (P-15) is preferred, the formula (P-1), (P-2), (P-3), (P-4), (P-8), or (P-10) is more preferred, the formula (P-1), (P-2), or (P-3) is still more preferred, and the formula (P-1) or (P-2) is particularly preferred.

In the general formula (II-2), Sp²²¹ preferably denotes a single bond or an alkylene group having 1 to 8 carbon atoms, one —CH₂— or two or more nonadjacent —CH₂— groups in the alkylene group are independently optionally substituted with —O—, —COO—, —OCO—, or —OCO—O—, and one or two or more hydrogen atoms of the alkylene group are optionally substituted with a halogen atom (preferably a fluorine atom, a chlorine atom, a bromine atom, or an iodine atom) or a CN group.

In the general formula (II-2), X²²¹ preferably denotes —O—, —OCH₂—, —CH₂O—, —CO—, —COO—, —OCO—, —O—CO—O—, —CO—NH—, —NH—CO—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and X²²¹ more preferably denotes —O—, —OCH₂—, —CH₂O—, —CO—, —COO—, —OCO—, —O—CO—O—, —CFO⁰—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C≡C—, or a single bond.

In the general formula (II-2), MG²²¹ denotes a mesogenic group, the general formula (II-2-b)

[Chem. 21]

-(A1-Z1)ᵣ₁-A2-Z2-A3- (II-2-b)

(wherein A1, A2, and A3 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, fluorene-2,7-diyl group, a cholesteryl group, or a cholestaryl group, and may have as the substituent L² at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms, and A1 to A3 preferably independently denote a 1,4-phenylene group, a 1,4-cyclohexylene group, or a 2,6-naphthylene group each optionally having the substituent L². The substituent L² is preferably F, an alkyl group having 1 to 8 carbon atoms, or an alkoxy group having 1 to 8 carbon atoms.

In the general formula (II-2), R²²¹ more preferably denotes a hydrogen atom, a halogen atom (preferably a fluorine atom, a chlorine atom, a bromine atom, or an iodine atom), a cyano group, a linear or branched alkyl group having 1 to 8 carbon atoms, or a linear or branched alkenyl group having 1 to 8 carbon atoms, one —CH₂— or two or more nonadjacent —CH₂— groups in the alkyl group and the alkenyl group are independently optionally substituted with —O—, —CO—, —COO—, —OCO—, —O—CO—O—, —CH═CH—COO—, —CH═CH—OCO—, —COO—CH═CH—, —OCO—CH═CH—, —CH═CH—, or —C≡C—, one or two or more hydrogen atoms of the alkyl group and the alkenyl group are independently optionally substituted with a halogen atom (preferably a fluorine atom, a chlorine atom, a bromine atom, or an iodine atom) or a cyano group, and a plurality of substituents, if present, may be the same or different.

Examples of the general formula (II-2) include, but are not limited to, the compounds represented by the following general formulae (II-2-1) to (II-2-4).

[Chem. 22]

P²²¹-Sp²²¹-X²²¹-A2-Z2-A3-R²²¹ (II-2-1)

P²²¹Sp²²¹-X²²¹-A11-Z11-A2-Z2-A3-R²²¹ (II-2-2)

P²²¹Sp²²¹-X²²¹-A11-Z11-A12-Z12-A2-Z2-A3-R²²¹ (II-2-3)

P²²¹Sp²²¹-X²²¹-A11-Z11-A12-Z12-A13-Z13-A2-Z2-A3-R²²¹ (II-24)

In the formulae, P²²¹, Sp²²¹, X²²¹, and R²²¹ are the same as defined in the general formula (II-2),

A11, A12, A13, A2, and A3 are the same as A1 to A3 defined in the general formula (II-2-b) and may be the same or different, and

Z11, Z12, Z13, and Z2 are the same as Z1 to Z3 defined in the general formula (II-2-b) and may be the same or different.

Examples of the compounds represented by the general formulae (II-2-1) to (II-2-4) include, but are not limited to, the compounds represented by the following formulae (II-2-1-1) to (II-2-1-26).

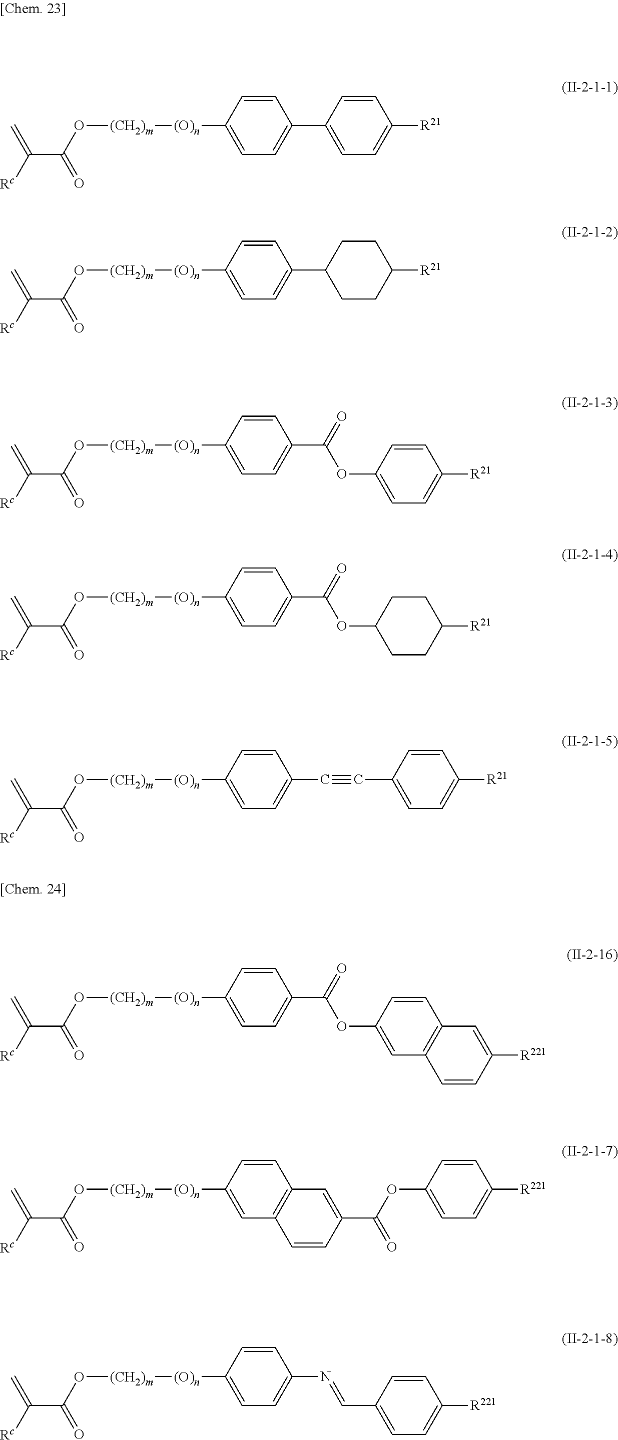

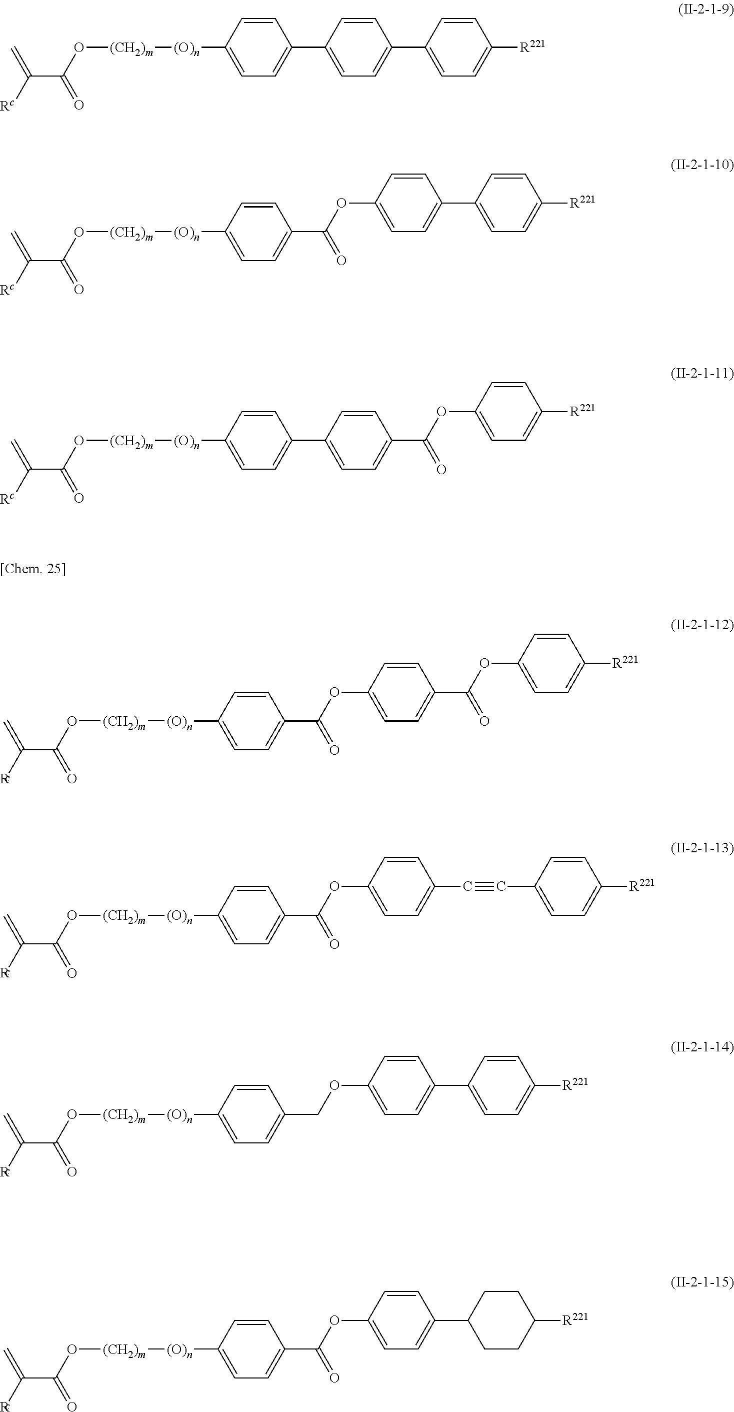

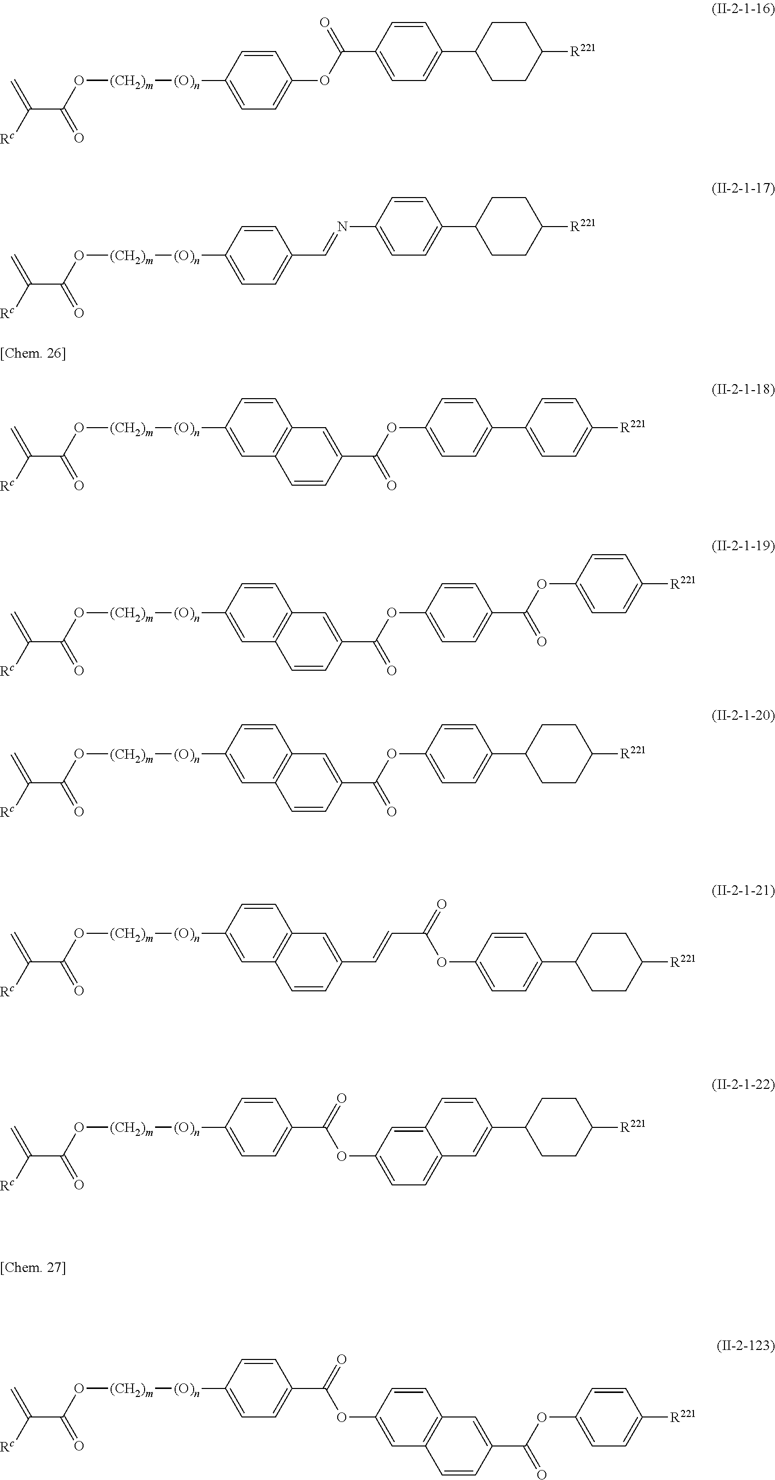

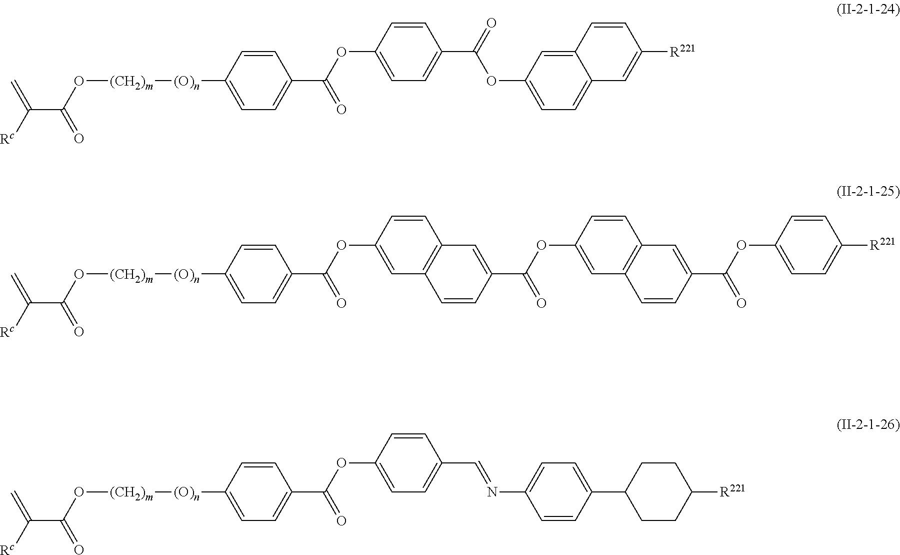

In the general formulae (II-2-1-1) to (II-2-1-26), R^{c} denotes a hydrogen atom or a methyl group, m denotes an integer in the range of 0 to 8, n denotes 0 or 1, R²²¹ has the same definition as in the general formula (II-2-1) to (II-2-4), and R²²¹ preferably denotes a hydrogen atom, a halogen atom (preferably a fluorine atom, a chlorine atom, a bromine atom, or an iodine atom), a cyano group, or a linear alkyl group having 1 to 6 carbon atoms or a linear alkenyl group having 1 to 6 carbon atoms in which one —CH₂— is optionally substituted with —O—, —CO—, —COO—, or —OCO—.

In the general formulae (II-2-1-1) to (II-2-1-26), the cyclic groups may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, or alkenoyloxy group having 2 to 8 carbon atoms.

One or two or more monofunctional polymerizable liquid crystal compounds represented by the general formula (II-2) may be used. The total amount of monofunctional polymerizable liquid crystal compounds represented by the general formula (II-2) preferably ranges from 0% to 84% by mass, more preferably 5% to 80% by mass, particularly preferably 10% to 70% by mass, most preferably 10% to 50% by mass, of the total amount of polymerizable liquid crystal compounds used in a polymerizable liquid crystal composition.

### (Monofunctional Polymerizable Liquid Crystal Compound Represented by General Formula (II-1))

In the present invention, among the monofunctional polymerizable liquid crystal compounds represented by the general formula (II-2), a monofunctional polymerizable liquid crystal compound represented by the following general formula (II-1) is preferably used to further decrease the half-width (Δλ) of the selective reflection wavelength. For cholesteric liquid crystals with a selective reflection wavelength, the relationship between the selective reflection wavelength (λ) and the helical pitch (p) is typically represented by λ=p·N (N denotes the average refractive index of the cholesteric liquid crystal composition), and the half-width (Δλ) of the selective reflection wavelength is represented by the product of the birefringence anisotropy (Δn) of the polymerizable liquid crystal composition and p. To selectively reflect only a particular wavelength, it is desirable to decrease the wavelength width (Δλ) of the selective reflection. Polymerization of a polymerizable liquid crystal composition containing a polymerizable liquid crystal compound represented by the general formula (II-1) with one polymerizable functional group directly linked to a cyclic group without a spacer group produces a polymer with low alignment order because a mesogenic skeleton portion of the polymerizable liquid crystal compound represented by each general formula has a partly different alignment. This can reduce the birefringence anisotropy (Δn) and thereby reduce the wavelength width (Δλ) of the selective reflection.

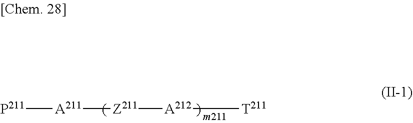

(In the general formula (II-1), P2¹¹ denotes a polymerizable functional group, A²¹¹ and A²¹² independently denote a 1,4-phenylene group, a 1,4-cyclohexylene group, a bicyclo[2,2,2]octane-1,4-diyl group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, and these groups are unsubstituted or optionally substituted with at least one substituent L,

L denotes a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, an optionally substituted phenyl group, an optionally substituted phenylalkyl group, an optionally substituted cyclohexylalkyl group, or a linear or branched alkyl group having 1 to 20 carbon atoms in which one —CH₂— or two or more nonadjacent —CH₂— groups are independently optionally substituted with —O—, —S—, —CO—, —COO—, —OCO—, —CO—S—, —S—CO—, —O—CO—O—, —CO—NR⁰—, —NR⁰—CO—, —CH═CH—COO—, —CH═CH—OCO—, —COO—CH═CH—, —OCO—CH═CH—, —CH═CH—, —N═N—, —CR⁰═N—, —N═CR⁰—, —CH═N—N═CH—, —CF═CF—, or —C≡C— (wherein R⁰ denotes a hydrogen atom or an alkyl group having 1 to 8 carbon atoms), a hydrogen atom of the alkyl group is optionally substituted with a fluorine atom, a plurality of Ls, if present, in the compound may be the same or different, and a plurality of A²¹²s, if present, may be the same or different,

Z²¹¹ denotes —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, and a plurality of Z²¹¹s, if present, may be the same or different,

m211 denotes an integer in the range of 1 to 3, and

T²¹¹ denotes a hydrogen atom, a —OH group, a —SH group, a —CN group, a —COOH group, an —NHz group, a —NO₂ group, a —COCH₃ group, —O(CH₂)ₙCH₃, or —(CH₂)ₙCH₃, and n denotes an integer in the range of 0 to 20.)

In the general formula (II-1), P²¹¹ denotes a polymerizable functional group, preferably a group selected from the following formulae (P-1) to (P-17).

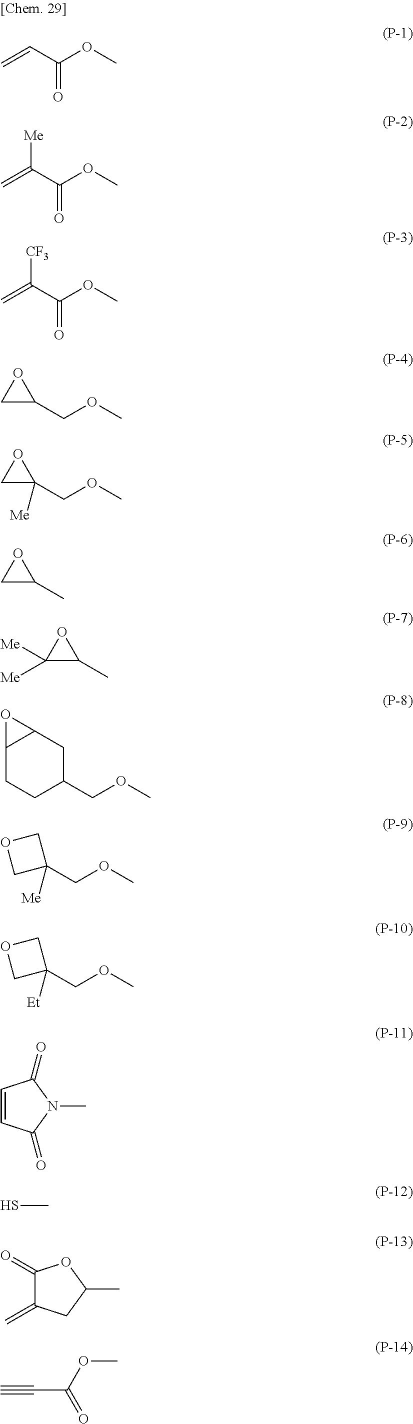

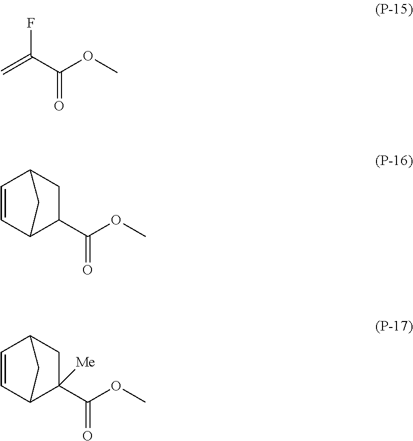

These polymerizable groups are polymerized by radical polymerization, radical addition polymerization, cationic polymerization, or anionic polymerization. In particular, when ultraviolet polymerization is performed as a polymerization method, the formula (P-1), (P-2), (P-3), (P-4), (P-8), (P-10), (P-12), or (P-15) is preferred, the formula (P-1), (P-2), (P-3), (P-4), (P-8), or (P-10) is more preferred, the formula (P-1), (P-2), or (P-3) is still more preferred, and the formula (P-1) or (P-2) is particularly preferred.

In the general formula (II-1), A²¹¹ and A²¹² independently denote a 1,4-phenylene group, a 1,4-cyclohexylene group, a bicyclo[2,2,2]octane-1,4-diyl group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, and these groups are unsubstituted or optionally substituted with at least one substituent L. In terms of the ease of synthesis, availability of raw materials, and liquid crystallinity, A²¹¹ and A²¹² preferably independently denote a 1,4-phenylene group, a 1,4-cyclohexylene group, a bicyclo[2,2,2]octane-1,4-diyl group, a naphthalene-2,6-diyl group, or a naphthalene-1,4-diyl group each unsubstituted or optionally substituted with at least one substituent L, and more preferably independently denote a group selected from the following formulae (A-1) to (A-16).

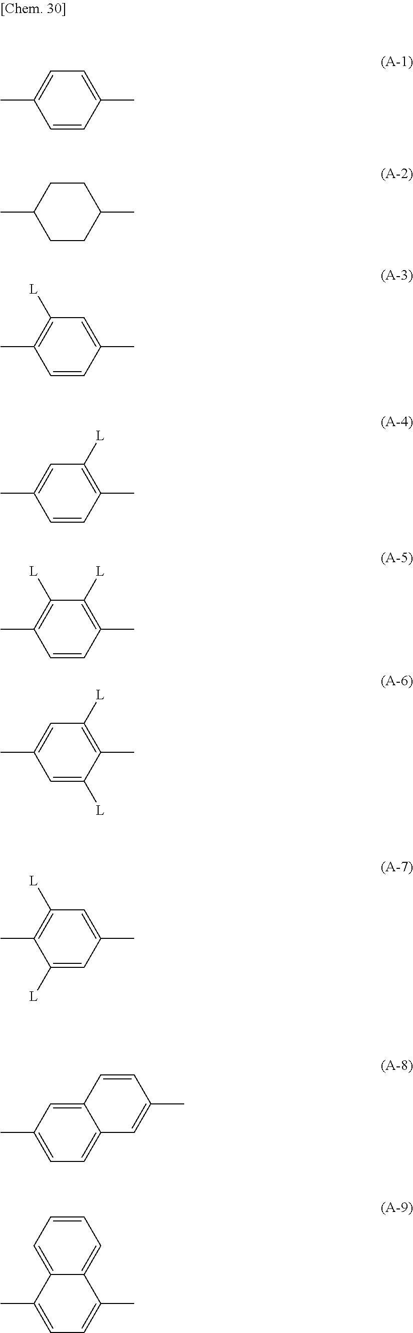

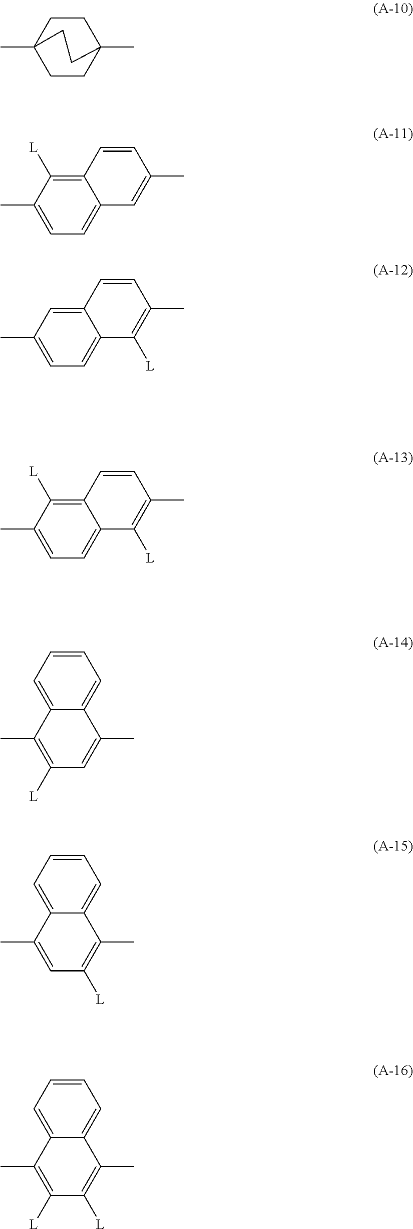

Furthermore, in terms of low refractive index anisotropy, more preferably, at least one of A²¹¹ and A²¹² denotes a group selected from the formulae (A-2) and (A-10), and the remainder independently denotes a group selected from the formulae (A-1) to (A-7) and (A-10). Still more preferably, at least one of A²¹¹ and A²¹² denotes a group represented by the formula (A-2), and the remainder independently denotes a group selected from the formulae (A-1) to (A-7). Particularly preferably, at least one of A²¹¹ and A²²¹ denotes a group represented by the formula (A-2), and the remainder independently denotes a group selected from the formulae (A-1) to (A-4). A plurality of A²¹²s, if present, may be the same or different.

In the general formula (II-1), L denotes a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, an optionally substituted phenyl group, an optionally substituted phenylalkyl group, an optionally substituted cyclohexylalkyl group, or a linear or branched alkyl group having 1 to 20 carbon atoms in which one —CH₂— or two or more nonadjacent —CH₂— groups are independently optionally substituted with —O—, —S—, —CO—, —COO—, —OCO—, —CO—S—, —S—CO—, —O—CO—O—, —CO—NR⁰—, —NR⁰—CO—, —CH═CH—COO—, —CH═CH—OCO—, —COO—CH═CH—, —OCO—CH═CH—, —CH═CH—, —N═N—, —CR⁰═N—, —N═CR⁰—, —CH═N—N═CH—, —CF═CF—, or —C≡C— (wherein R⁰ denotes a hydrogen atom or an alkyl group having 1 to 8 carbon atoms), a hydrogen atom of the alkyl group is optionally substituted with a fluorine atom, and a plurality of Ls, if present, in the compound may be the same or different. In terms of liquid crystallinity and the ease of synthesis, the substituent L preferably denotes a fluorine atom, a chlorine atom, a pentafluorosulfuranyl group, a nitro group, a methylamino group, a dimethylamino group, a diethylamino group, a diisopropylamino group, or a linear or branched alkyl group having 1 to 20 carbon atoms in which a hydrogen atom is optionally substituted with a fluorine atom and in which one —CH₂— or two or more nonadjacent —CH₂— groups are independently optionally substituted with a group selected from —O—, —S—, —CO—, —COO—, —OCO—, —O—CO—O—, —CH═CH—, —CF═CF—, and —C≡C—. The substituent L more preferably denotes a fluorine atom, a chlorine atom, or a linear or branched alkyl group having 1 to 12 carbon atoms in which a hydrogen atom is optionally substituted with a fluorine atom and in which one —CH₂— or two or more nonadjacent —CH₂— groups are independently optionally substituted with a group selected from —O—, —COO—, and —OCO—. The substituent L still more preferably denotes a fluorine atom, a chlorine atom, or a linear or branched alkyl group or alkoxy group having 1 to 12 carbon atoms in which a hydrogen atom is optionally substituted with a fluorine atom. The substituent L particularly preferably denotes a fluorine atom, a chlorine atom, or a linear alkyl group or linear alkoxy group having 1 to 8 carbon atoms.

In the general formula (II-1), Z²¹² denotes —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, and a plurality of Z²¹²s, if present, may be the same or different.

In the general formula (II-1), attaching importance to fewer alignment defects, a plurality of Z²¹²s, if present, may be the same or different and preferably denote —OCH₂—, —CH₂O—, —CH₂CH₂—, —COO—, —OCO—, —CO—NH—, —NH—CO—, —CF₂O—, —OCF₂—, —CH═CH—COO—, —OCO—CH═CH—, —COO—CH₂CH₂—, —CH₂CH₂—OCO—, —CH═CH—, —N═N—, —CH═N—, —N═CH—, —CH═N—N═CH—, —CF═CF—, —C≡C—, or a single bond. More preferably, a plurality of Z²¹²s, if present, may be the same or different and denote —COO—, —OCO—, —CO—NH—, —NH—CO—, —CF₂O—, —OCF₂—, —CH═CH—COO—, —OCO—CH═CH—, —CH═CH—, —N═N—, —CH═N—N═CH—, —CF═CF—, —C≡C—, or a single bond. Still more preferably, a plurality of Z₂₁₂s, if present, may be the same or different and denote —COO—, —OCO—, —CO—NH—, —NH—CO—, —CF₂O—, —OCF₂—, or a single bond. Particularly preferably, a plurality of Z²¹²s, if present, may be the same or different and denote —COO—, —OCO—, —CF₂O—, —OCF₂—, or a single bond.

In the general formula (II-1), m211 preferably denotes an integer in the range of 1 to 3, m211 is preferably 1 or 2, and m211 is preferably 1.

In the general formula (II-1), T²¹¹ denotes a hydrogen atom, a —OH group, a —SH group, a —CN group, a —COOH group, an —NH₂ group, a —NO₂ group, a —COCH₃ group, —O(CH₂)ₙCH₃, or —(CH²)ₙCH₃ (n denotes an integer in the range of 0 to 20), T²¹¹ preferably denotes a hydrogen atom, —O(CH₂)ₙCH₃, or —(CH₂)ₙCH₃ (n denotes an integer in the range of 0 to 10), and T²¹¹ particularly preferably denotes —O(CH₂)ₙCH₃ or —(CH₂)ₙCH₃ (n denotes an integer in the range of 0 to 8).

More specifically, the compounds represented by the general formula (II-1) are preferably the compounds represented by the following formulae (II-1-1) to (II-1-7).

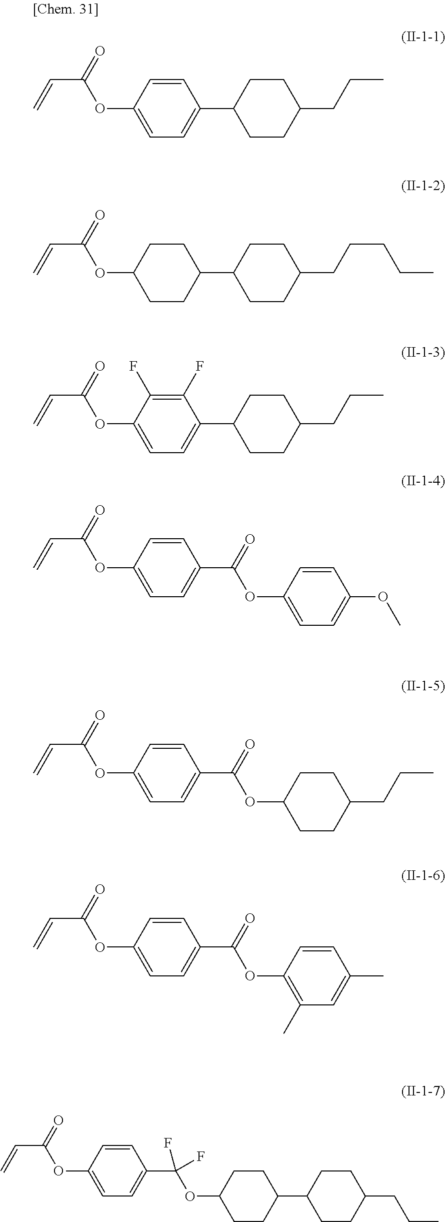

One or two or more monofunctional polymerizable liquid crystal compounds represented by the general formula (II-1) may be used. The total amount of monofunctional polymerizable liquid crystal compounds represented by the general formula (II-1) preferably ranges from 0% to 84% by mass, more preferably 5% to 80% by mass, particularly preferably 10% to 70% by mass, most preferably 10% to 40% by mass, of the total amount of polymerizable liquid crystal compounds used in a polymerizable liquid crystal composition. The abundance ratio [bifunctional polymerizable liquid crystal compound/monofunctional polymerizable liquid crystal compound] of a bifunctional polymerizable liquid crystal compound represented by the general formula (I-2) to a monofunctional polymerizable liquid crystal compound represented by the general formula (II-2) based on mass in the present invention preferably ranges from 90/10 to 30/70, particularly preferably 90/10 to 50/50, in terms of good compatibility and the effects of improving heat resistance.

In the present invention, a compound represented by the general formula (I-1) is preferably used as a bifunctional polymerizable liquid crystal compound, and a compound represented by the general formula (II-1) is preferably used as a monofunctional polymerizable liquid crystal compound. In this case, the abundance ratio [(I-1)/(II-1)] based on mass preferably ranges from 90/10 to 30/70, particularly preferably 90/10 to 50/50, in terms of compatibility, heat resistance, and further improved color purity due to a further narrow half-width (Δλ).

### (Polyfunctional Polymerizable Liquid Crystal Compound)

A polymerizable liquid crystal composition according to the present invention may contain a polymerizable liquid crystal compound having three or more polymerizable functional groups in its molecules, without impairing the physical properties. Examples of the polymerizable liquid crystal compound having three or more polymerizable functional groups in its molecules include the compounds represented by the following general formulae (III-1) and (III-2).

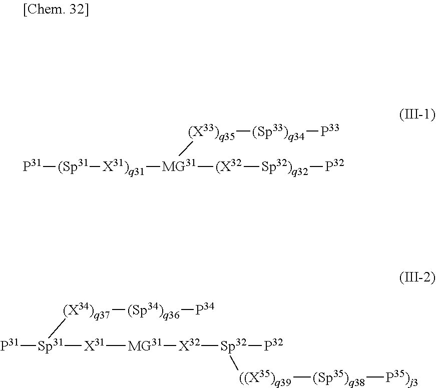

(wherein P³¹ to P³⁵ independently denote a polymerizable functional group, Sp³¹ to S³⁵ independently denote an alkylene group having 1 to 18 carbon atoms or a single bond, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (preferably a fluorine atom, a chlorine atom, a bromine atom, or an iodine atom) or a CN group, X₃₁ to X³⁵ independently denote —O—, —S—, —OCH₂—, —CH₂OO—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P³¹-Sp³¹, P³²-Sp³², P³³-Sp³³, P³⁴-Sp³⁴, P³⁵-Sp³⁵, Sp³¹-X³¹, Sp³²-X³², Sp³³-X³³, Sp³⁴-X³, and Sp³⁵-X³⁵ have no direct bonding of oxygen atoms), q31, q32, q34, q35, q36, q37, q38, and q39 independently denote 0 or 1, j3 denotes 0 or 1, and MG³¹ denotes a mesogenic group)

In the general formulae (III-1) and (III-2), P³¹ to p³⁵ preferably independently denote a substituent selected from the polymerizable groups represented by the following formulae (P-2-1) to (P-2-20).

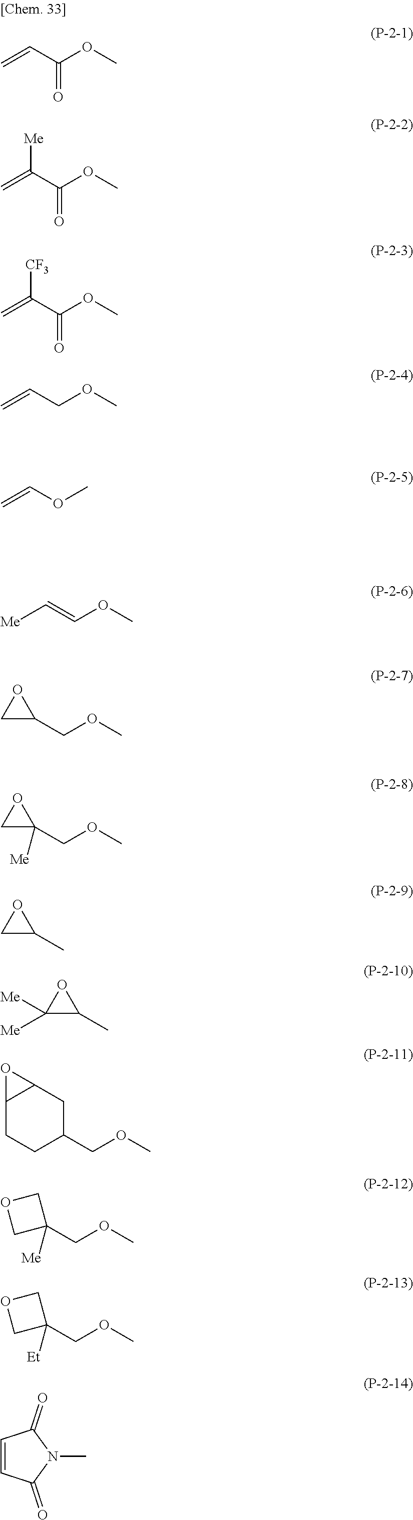

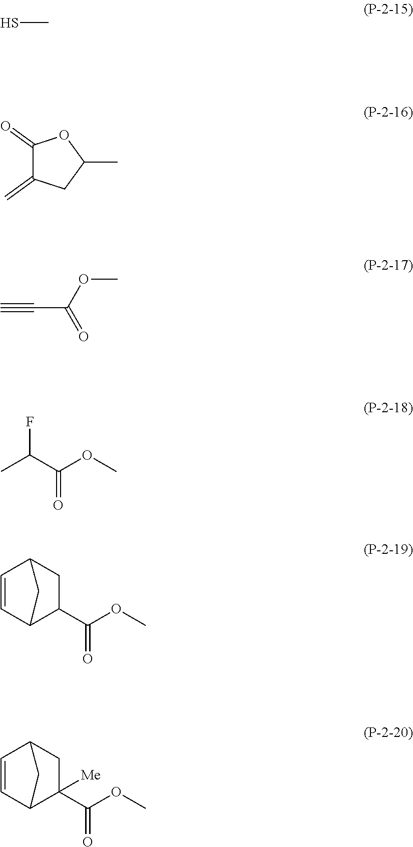

Among these polymerizable functional groups, in terms of high polymerization reactivity, the formulae (P-2-1), (P-2-2), (P-2-7), (P-2-12), and (P-2-13) are preferred, and the formulae (P-2-1) and (P-2-2) are more preferred.

In the general formulae (III-1) and (III-2), Sp³¹ to Sp³⁵ preferably independently denote an alkylene group having 1 to 15 carbon atoms, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom (preferably a fluorine atom, a chlorine atom, a bromine atom, or an iodine atom) or a CN group, Sp³¹ to Sp³⁵ more preferably independently denote an alkylene group having 1 to 12 carbon atoms, and one —CH₂— or two or more nonadjacent —CH₂— groups in the alkylene group are independently optionally substituted with —O—, —COO—, —OCO—, or —OCO—O—.

In the general formulae (III-1) and (III-2), X³¹ to X³⁵ preferably independently denote —O—, —OCH₂—, —CH₂O—, —CO—, —COO—, —OCO—, —O—CO—O—, —CO—NH—, —NH—CO—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond, and X³¹ to X³⁵ more preferably independently denote —O—, —OCH₂—, —CH₂O—, —CO—, —COO—, —OCO—, —O—CO—O—, —CF₂O—, —OCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —CF═CF—, —C≡C—, or a single bond.

In the general formulae (III-1) and (III-2), MG³¹ denotes a mesogenic group and is represented by the general formula (III-A).

[Chem. 34]

-(A1-Z1)ᵣ₁-A2-Z2-A3- (III-A)

In the formula, A1, A2, and A3 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms. When a structure represented by the general formula (III-1) is formed, any of A1, if present, A2, and A3 has a —(X³³)_{q35}-(Sp³³)_{q34}-P³³ group. Z1 and Z2 independently denote —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having 2 to 10 carbon atoms and optionally having a halogen atom (preferably a fluorine atom, a chlorine atom, a bromine atom, or an iodine atom), or a single bond, Z1 and Z2 preferably independently denote a —COO—, —OCO—, —CH₂CH₂—, —OCH₂—, —CH₂O—, —CH═CH—, —C≡C—, —CH═CHCOO—, —OCOCH═CH—, —CH₂CHzCOO—, —CH₂CH₂OCO—, —COOCH₂CH₂—, —OCOCH₂CH₂—, or a single bond, r1 denotes 0, 1, 2, or 3, a plurality of A1s, if present, may be the same or different, and a plurality of Z1s, if present, may be the same or different) A1, A2, and A3 preferably independently denote a 1,4-phenylene group, a 1,4-cyclohexylene group, or a 2,6-naphthylene group.

Examples of the general formula (III) include, but are not limited to, the compounds represented by the following general formulae (III-1-1) to (III-1-8) and (III-2-1) and )III-2-2).

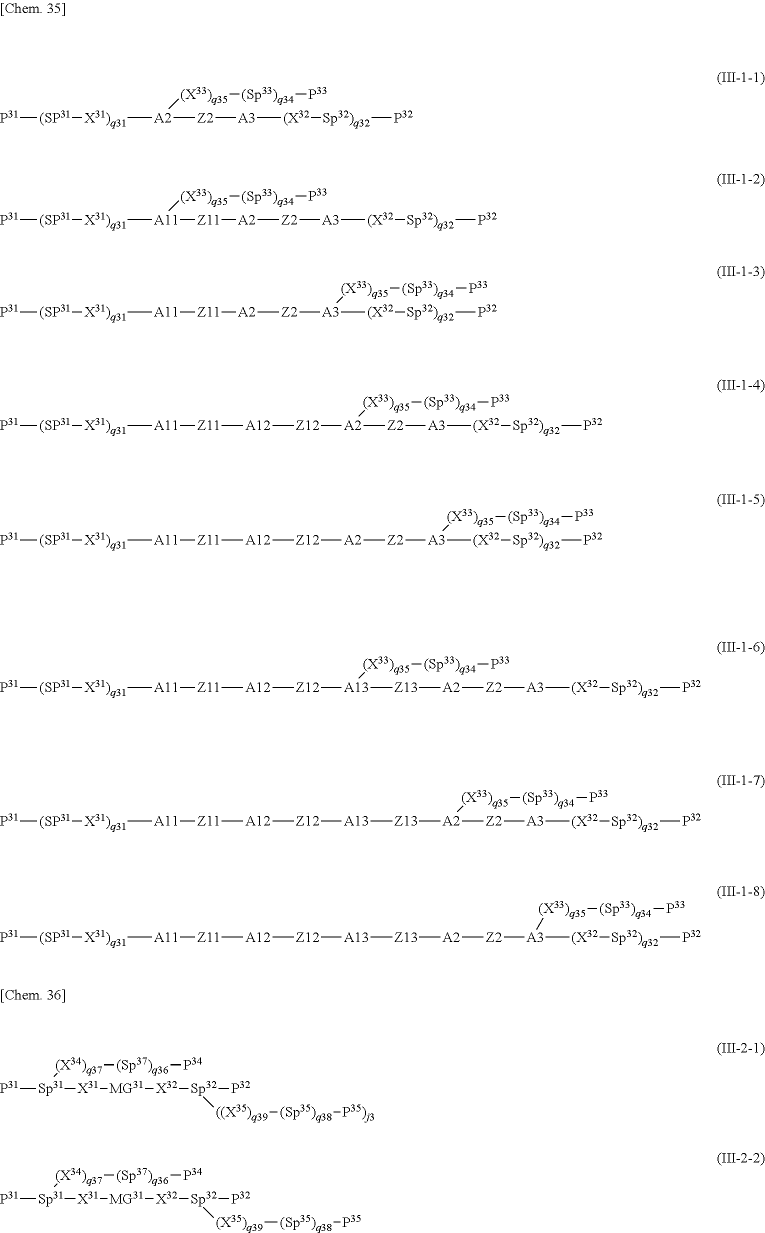

In the formulae, P³¹ to P³⁵, Sp³¹ to Sp³⁵, X³¹ to X³⁵, and q31 to q39MG³¹ have the same definition as in the general formulae (III-1) and (III-2),

A11 and A12 and A13, A2, and A3 are the same as A1 to A3 defined in the general formula (III-A) and may be the same or different, and

Z11 and Z12 and Z13, and Z2 are the same as Z1 and Z2 defined in the general formula (III-A) and may be the same or different.

Examples of the compounds represented by the general formulae (III-1-1) to (III-1-8), (III-2-1), and (III-2-2) include, but are not limited to, the compounds represented by the following general formulae (III-9-1) to (III-9-6).

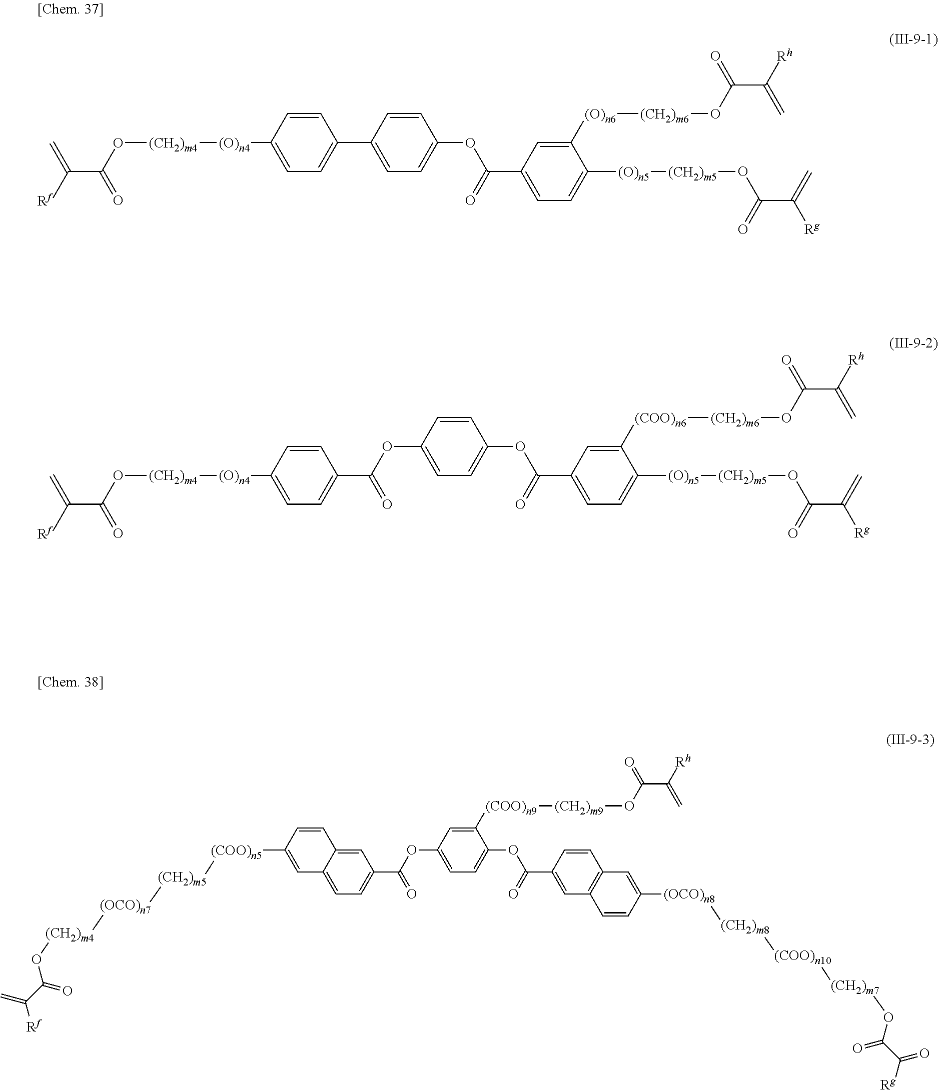

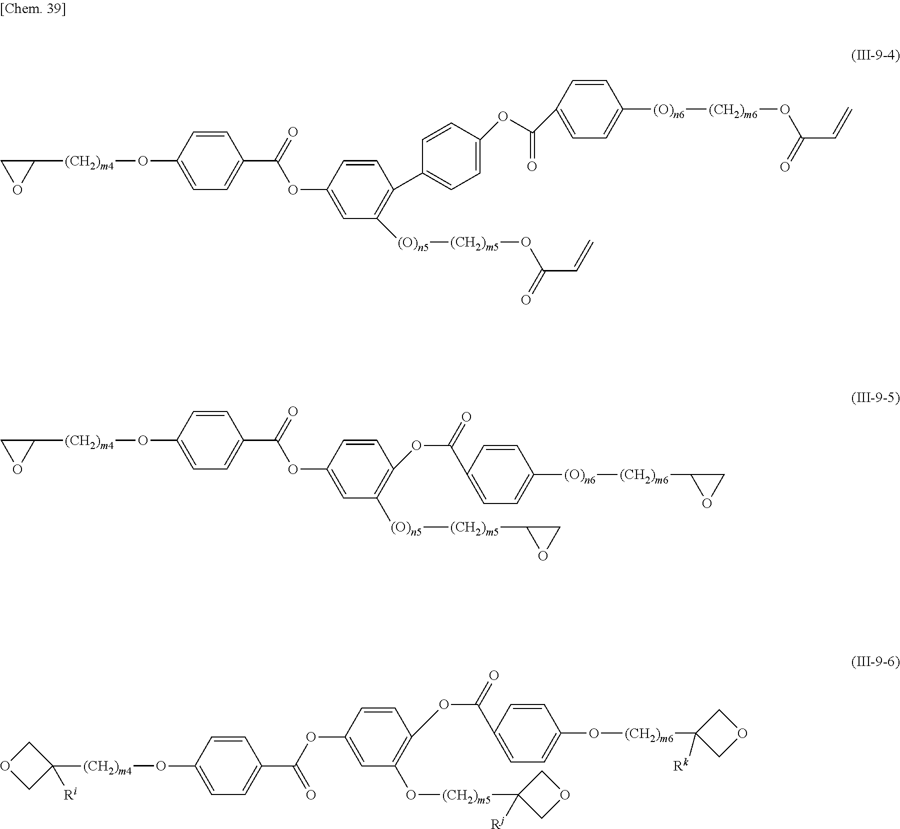

In the general formula (III-9-1) to (III-9-6), R^{f}, R^{g}, and R^{h} independently denote a hydrogen atom or a methyl group, and Rⁱ, R^{j}, and R^{k} independently denote a hydrogen atom, a halogen atom (preferably a fluorine atom, a chlorine atom, a bromine atom, or an iodine atom), an alkyl group having 1 to 6 carbon atoms, an alkoxy group having 1 to 6 carbon atoms, or a cyano group. If these groups are alkyl groups having 1 to 6 carbon atoms or alkoxy groups having 1 to 6 carbon atoms, all the groups may be unsubstituted or substituted with one or two or more halogen atoms (preferably fluorine atoms, chlorine atoms, bromine atoms, or iodine atoms). The cyclic groups may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, or alkenoyloxy group having 2 to 8 carbon atoms.

m4 to m9 independently denote an integer in the range of 0 to 18, and n4 to n10 independently denote 0 or 1.

One or two or more polyfunctional polymerizable liquid crystal compounds with three or more polymerizable functional groups may be used.

The total amount of polyfunctional polymerizable liquid crystal compounds each having three polymerizable functional group in the molecules is preferably 20% or less by mass, particularly 10% or less by mass, particularly preferably 5% or less by mass, of the total amount of polymerizable liquid crystal compounds used in a polymerizable liquid crystal composition.

### (Other Liquid Crystal Compounds)

A compound without a polymerizable group and with a mesogenic group may be added to a polymerizable liquid crystal composition according to the present invention. Examples of such a compound include compounds for use in common liquid crystal devices, for example, super-twisted nematic (STN) liquid crystals, twisted nematic (TN) liquid crystals, and thin-film transistor (TFT) liquid crystals.

More specifically, the compound without a polymerizable functional group and with a mesogenic group is preferably a compound represented by the following general formula (5).

[Chem. 40]

R⁵¹-MG3-R⁵² (5)

A mesogenic group or mesogenic support group represented by MG3 may be a compound represented by the general formula (5-b).

[Chem. 41]

⁻Z0^{d-}(A1^{d-}Z1^{d})ₙₑ⁻A2^{d-}Z2^{d-}A3^{d-}Z3^{d-} (5⁻b)

(wherein A1^{d}, A2^{d}, and A3^{d} independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms,

Z0^{d}, Z1^{d}, Z2^{d}, and Z3^{d} independently denote —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkylene group having 2 to 10 carbon atoms and optionally having a halogen atom (preferably a fluorine atom, a chlorine atom, a bromine atom, or an iodine atom), or a single bond,

n^{e} denotes 0, 1, or 2, and

R⁵¹ and R⁵² independently denote a hydrogen atom, a halogen atom (preferably a fluorine atom, a chlorine atom, a bromine atom, or an iodine atom), a cyano group, or an alkyl group having 1 to 18 carbon atoms, the alkyl group is optionally substituted with at least one halogen atom (preferably fluorine atom, chlorine atom, bromine atom, or iodine atom) or CN, and one CH₂ group or two or more nonadjacent CH₂ groups in the alkyl group are independently optionally substituted with —O—, —S—, —NH—, —N(CH₃)—, —CO—, —COO—, —OCO—, —OCOO—, —SCO—, —COS—, or —C≡C— without direct bonding of oxygen atoms)

Specific examples are described below. However, the present invention is not limited to these examples.

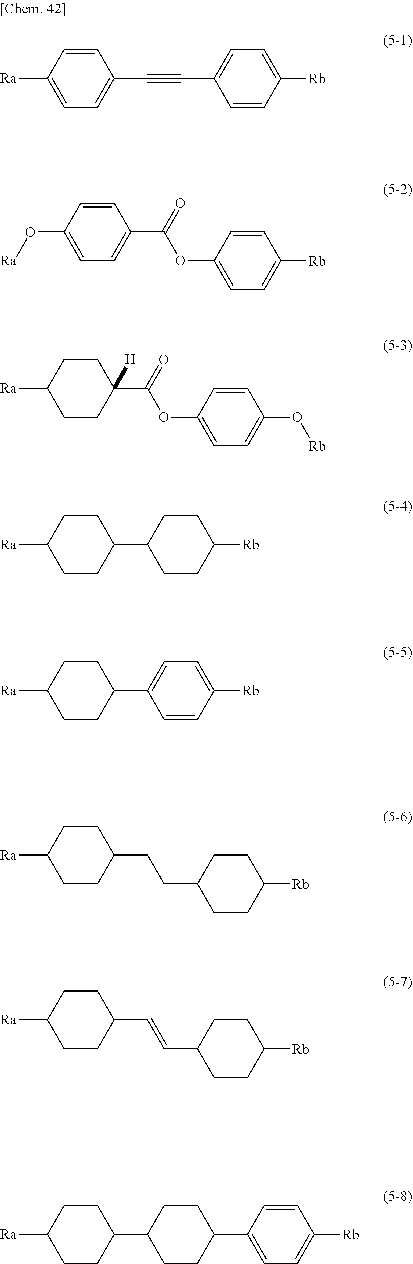

Ra and Rb independently denote a hydrogen atom, an alkyl group having 1 to 6 carbon atoms, an alkoxy group having 1 to 6 carbon atoms, an alkenyl group having 1 to 6 carbon atoms, or a cyano group, and if these groups denote an alkyl group having 1 to 6 carbon atoms or an alkoxy group having 1 to 6 carbon atoms, all the groups may be unsubstituted or substituted with one or two or more halogen atoms.

The total amount of compounds with a mesogenic group preferably ranges from 0% to 20% by mass of the total amount of the polymerizable liquid crystal composition, and when used, 1% or more by mass, 2% or more by mass, or 5% or more by mass is preferred, and 15% or less by mass or 10% or less by mass is preferred.

### (Chiral Compound)

A polymerizable liquid crystal composition according to the present invention contains a chiral compound to impart cholesteric liquid crystallinity to a resulting optical film. The chiral compound may or may not have liquid crystallinity. Among chiral compounds, polymerizable chiral compounds with polymerization reactivity are preferably used.

A polymerizable chiral compound for use in the present invention preferably has one or more polymerizable functional groups. Examples of such a compound include polymerizable chiral compounds containing a chiral saccharide, such as isosorbide, isomannitol, or glucoside, and having a rigid moiety, such as a 1,4-phenylene group 1,4-cyclohexlene group, and a polymerizable functional group, such as a vinyl group, an acryloyl group, a (meth)acryloyl group, or a maleimide group, as described in Japanese Unexamined Patent Application Publication No. 11-193287, Japanese Unexamined Patent Application Publication No. 2001-158788, Japanese Unexamined Patent Application Publication (Translation of PCT Application) No. 2006-52669, and Japanese Unexamined Patent Application Publications No. 2007-269639, No. 2007-269640, and No. 2009-84178, polymerizable chiral compounds composed of a terpenoid derivative, as described in Japanese Unexamined Patent Application Publication No. 8-239666, polymerizable chiral compounds composed of a mesogenic group and a spacer with a chiral moiety, as described in NATURE, VOL. 35, pp. 467-469 (Nov. 30, 1995) and NATURE, VOL. 392, pp. 476-479 (Apr. 2, 1998), and polymerizable chiral compounds with a binaphthyl group, as described in Japanese Unexamined Patent Application Publication (Translation of PCT Application) No. 2004-504285 and Japanese Unexamined Patent Application Publication No. 2007-248945. Among others, chiral compounds with high helical twisting power (HTP) are preferred in a polymerizable liquid crystal composition according to the present invention.

Among chiral compounds, the chiral compounds with high helical twisting power (HTP) may be represented by the following general formulae (3-1) to (3-4). A chiral compound selected from the general formulae (3-1) to (3-3) is preferably used. Among the chiral compounds selected from the general formulae (3-1) to (3-3), a polymerizable chiral compound with a polymerizable group represented by the general formula (3-a) described below is particularly preferably used, and a compound in which R^{3a} and R^{3b} in the general formula (3-1) are (P1) is particularly more preferred.

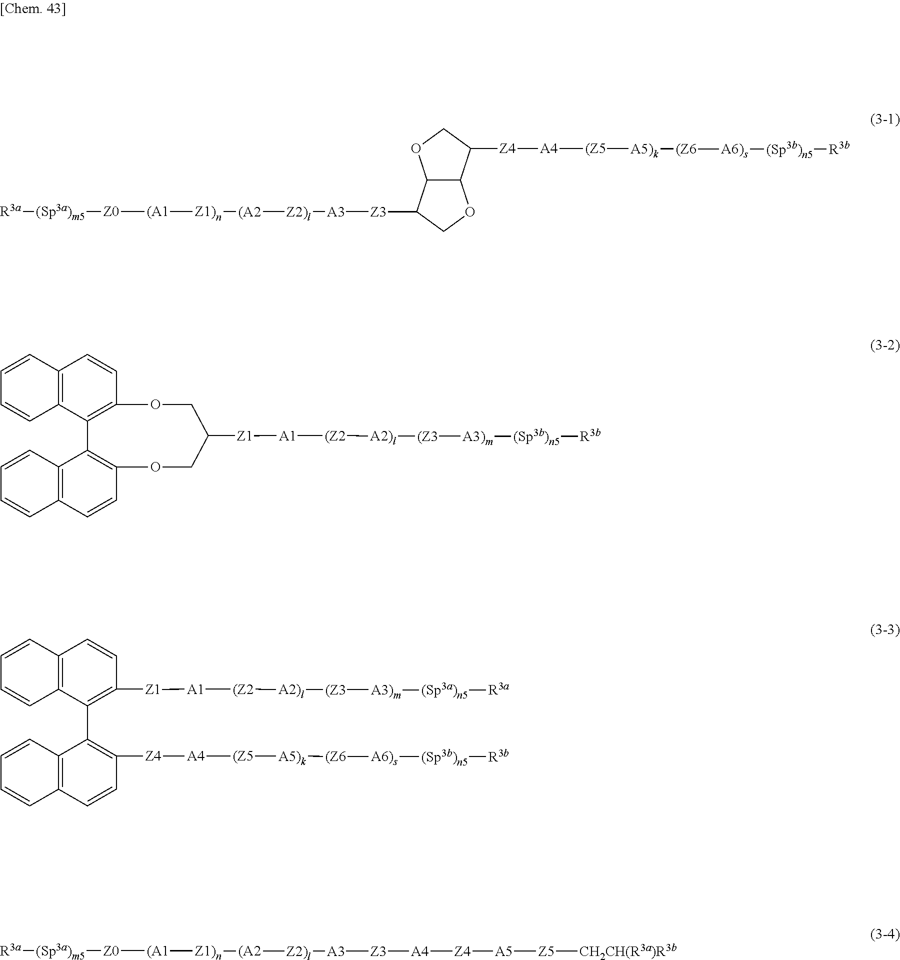

In the formulae, Sp^{3a} and Sp^{3b} independently denote an alkylene group having 0 to 18 carbon atoms, the alkylene group is optionally substituted with at least one halogen atom, CN group, or alkyl group having a polymerizable functional group and having 1 to 8 carbon atoms, and one CH₂ group or two or more nonadjacent CH₂ groups in the alkyl group are independently optionally substituted with —O—, —S—, —NH—, —N(CH₃)—, —CO—, —COO—, —OCO—, —OCOO—, —SCO—, —COS—, or —C≡C— without direct bonding of oxygen atoms,

A1, A2, A3, A4, A5, and A6 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-2,5-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group-, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[3,2-b]selenophene-2,7-diyl group, or a fluorene-2,7-diyl group, and may have as a substituent at least one F, Cl, CF₃, OCF₃, CN group, alkyl group having 1 to 8 carbon atoms, alkoxy group having 1 to 8 carbon atoms, alkanoyl group having 1 to 8 carbon atoms, alkanoyloxy group having 1 to 8 carbon atoms, alkoxycarbonyl group having 1 to 8 carbon atoms, alkenyl group having 2 to 8 carbon atoms, alkenyloxy group having 2 to 8 carbon atoms, alkenoyl group having 2 to 8 carbon atoms, and/or alkenoyloxy group having 2 to 8 carbon atoms. A1, A2, A3, A4, A5, and A6 preferably independently denote a 1,4-phenylene group, a 1,4-cyclohexylene group, or a 2,6-naphthylene group, and may have as a substituent at least one F, CN group, alkyl group having 1 to 8 carbon atoms, or alkoxy group having 1 to 8 carbon atoms.

n, l, k, and s independently denote 0 or 1,

Z0, Z1, Z2, Z3, Z4, Z5, and Z6 independently denote —COO—, —OCO—, —CHz CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —CONH—, —NHCO—, an alkyl group having 2 to 10 carbon atoms and optionally having a halogen atom, or a single bond,

n5 and m5 independently denote 0 or 1,

R^{3a} and R^{3b} denote a hydrogen atom, a halogen atom, a cyano group, or an alkyl group having 1 to 18 carbon atoms, the alkyl group is optionally substituted with at least one halogen atom or CN, and one CH₂ group or two or more nonadjacent CH₂ groups in the alkyl group are independently optionally substituted with —O—, —S—, —NH—, —N(CH₃)—, —CO—, —COO—, —OCO—, —OCOO—, —SCO—, —COS—, or —C≡C— without direct bonding of oxygen atoms,

or R^{3a} and R^{3b} are the general formula (3-a)

[Chem. 44]

⁻p^{3a} (3⁻a)

(wherein P^{3a} denotes a polymerizable functional group)

p^{3a} preferably denotes a substituent selected from the polymerizable groups represented by the following formulae (P-1) to (P-20).

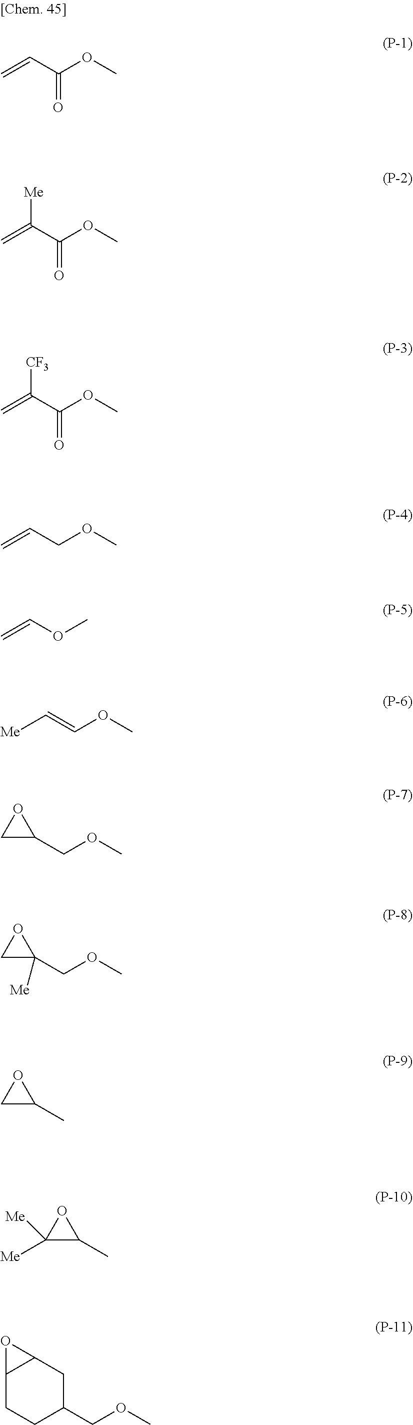

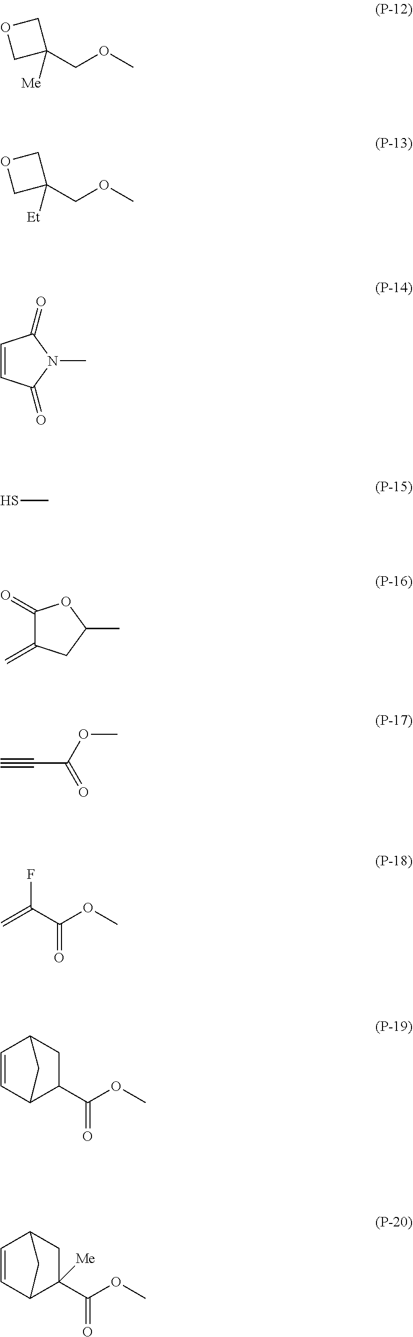

Among these polymerizable functional groups, in terms of high polymerization reactivity and storage stability, the formula (P-1) or the formula (P-2), (P-7), (P-12), or (P-13) is preferred, and the formula (P-1), (P-7), or (P-12) is more preferred.

Specific examples of the polymerizable chiral compounds include, but are not limited to, the compounds (3-5) to (3-26).

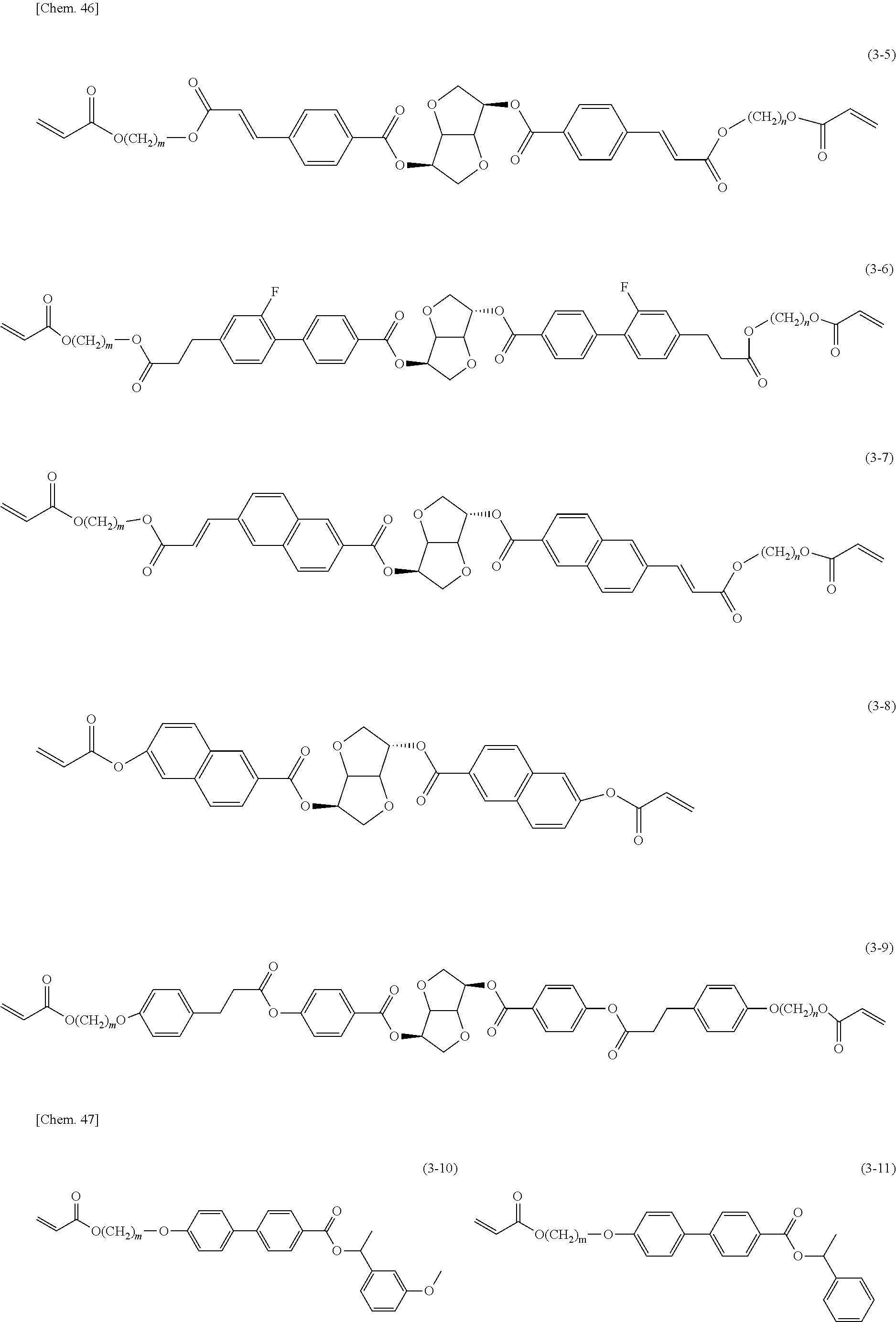

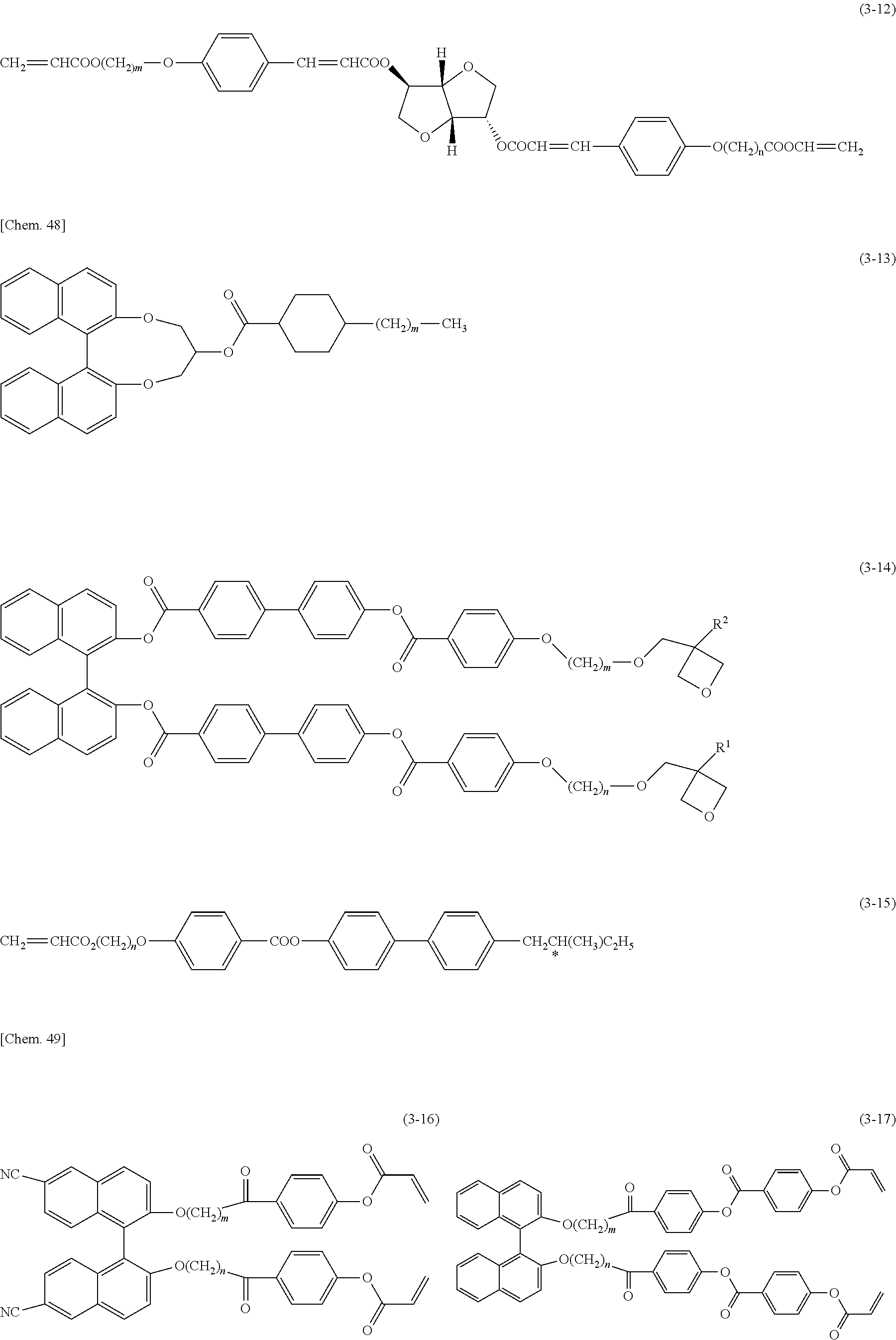

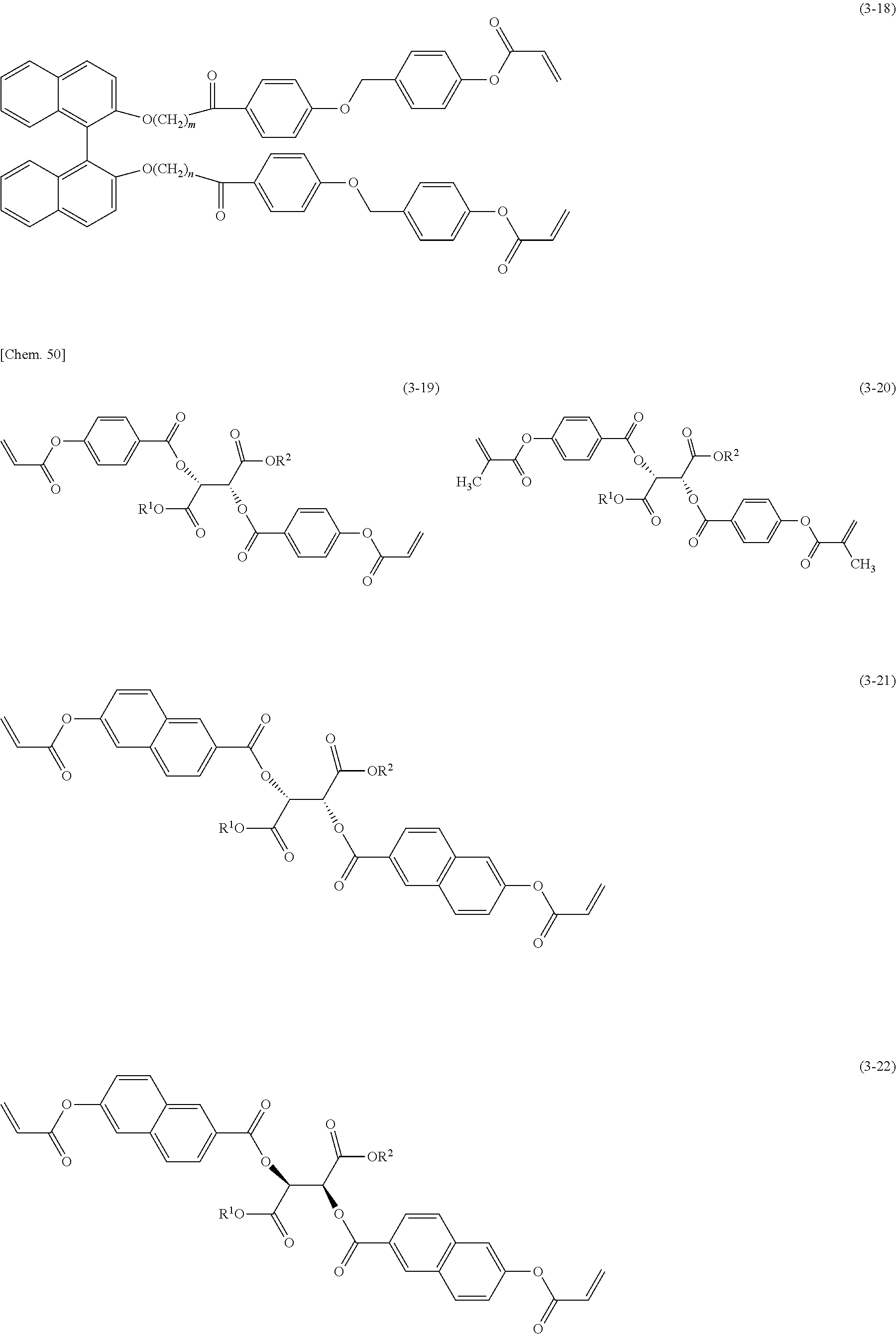

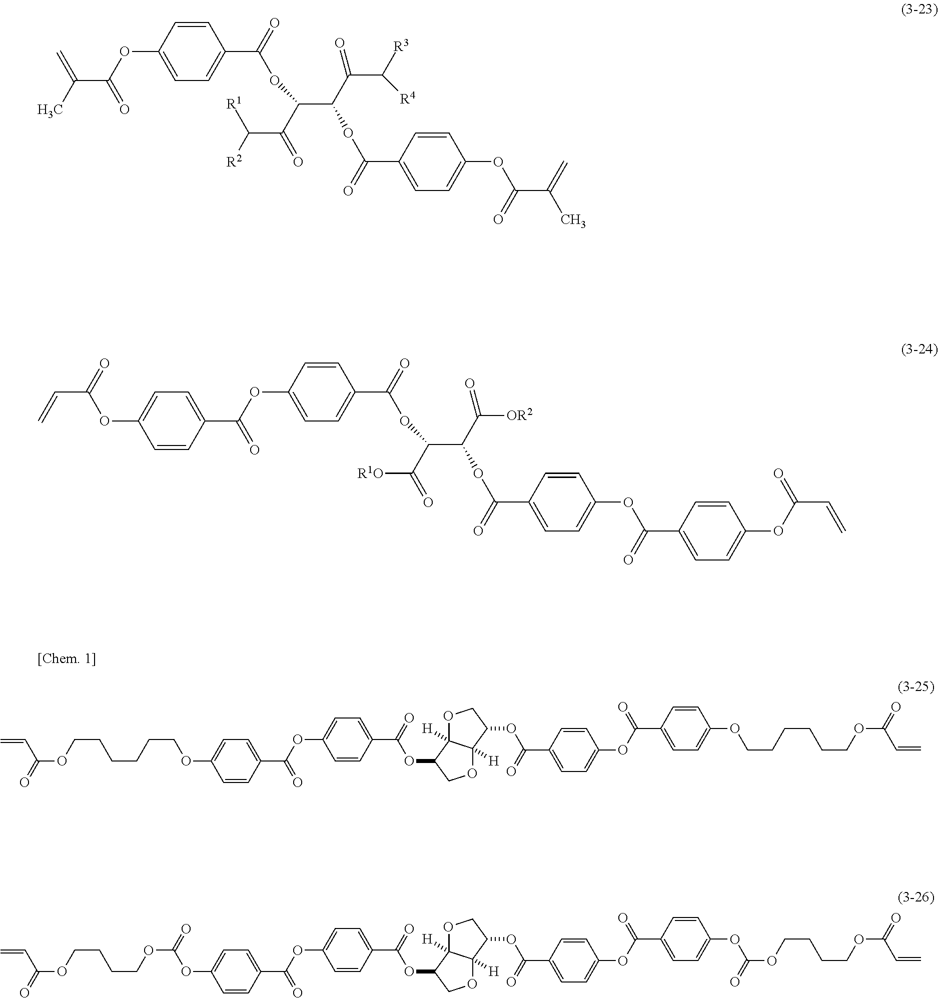

In the formulae, m, n, k, and l independently denote an integer in the range of 1 to 18, R¹ to R⁴ independently denote a hydrogen atom, an alkyl group having 1 to 6 carbon atoms, an alkoxy group having 1 to 6 carbon atoms, a carboxy group, or a cyano group. If these groups denote an alkyl group having 1 to 6 carbon atoms or an alkoxy group having 1 to 6 carbon atoms, all the groups may be unsubstituted or substituted with one or two or more halogen atoms.

Among the polymerizable chiral compounds represented by the general formulae (3-5) to (3-26), the chiral compounds with high helical twisting power (HTP) are particularly preferably polymerizable chiral compounds represented by the general formulae (3-5) to (3-9), (3-12) to (3-14), (3-16) to (3-18), (3-25), and (3-26), particularly more preferably the polymerizable chiral compounds represented by (3-8), (3-25), and (3-26).

To impart cholesteric properties to a resulting optical film and to form an optical film with high optical transparency, a polymerizable liquid crystal composition according to the present invention preferably contain 0.5 to 20 parts by mass, more preferably 1 to 15 parts by mass, particularly preferably 1.5 to 10 parts by mass, of the chiral compound per 100 parts by mass in total of a polymerizable liquid crystal compound used in the polymerizable liquid crystal composition.

### (Photopolymerization Initiator)

A polymerizable liquid crystal composition according to the present invention contains at least one or two or more oxime ester polymerization initiators. The oxime ester polymerization initiators in the present invention are polymerization initiators with a partial structure represented by the formula (4-1),

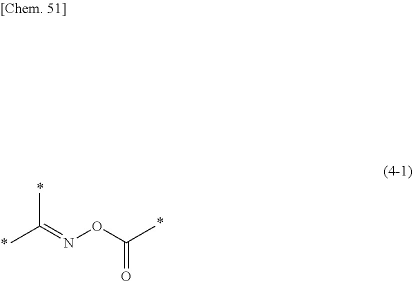

(* denotes a bonding arm)

and, more specifically, the compounds represented by the general formulae (4-2) and (4-3).

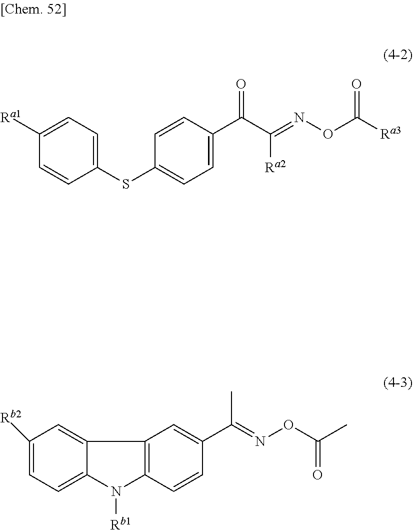

(wherein R^{a1} denotes a linear or branched alkyl group having 1 to 20 carbon atoms in which one —CH₂— or two or more nonadjacent —CH₂— groups are independently optionally substituted with —O—, —CO—, —COO—, or —OCO—, or a hydrogen atom,

R^{a2} denotes a linear or branched alkyl group having 1 to 20 carbon atoms in which one —CH₂— or two or more nonadjacent —CH₂— groups are independently optionally substituted with —O—, —CO—, —COO—, or —OCO—,

R^{a3} denotes a linear or branched alkyl group having 1 to 20 carbon atoms in which one —CH₂— or two or more nonadjacent —CH₂— groups are independently optionally substituted with —O—, —CO—, —COO—, or —OCO—, a phenyl group optionally having the substituent L, or a hydrogen atom, the substituent L having the same meaning as described above,

R^{b1} denotes a linear or branched alkyl group having 1 to 20 carbon atoms in which one —CH₂— or two or more nonadjacent —CH₂— groups are independently optionally substituted with —O—, —CO—, —COO—, or —OCO—, and

R^{b2} denotes a monovalent group with a molecular weight of 300 or less composed of a hydrogen atom, a carbon atom, and an oxygen atom)

Such a compound represented by the general formula (4-2) may be a compound represented by the following structural formula,

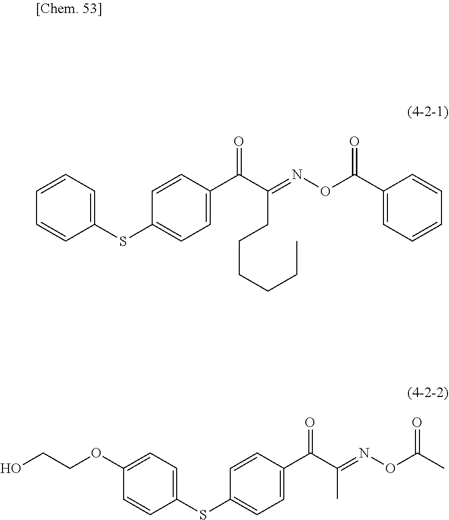

and such a compound represented by the general formula (4-3) may be a compound represented by the following structural formula.

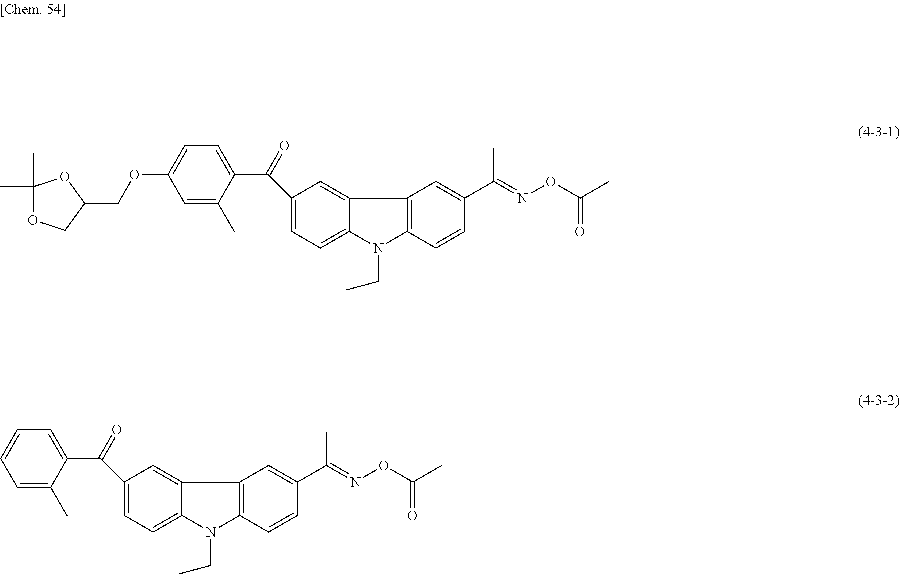

Among these, the compound represented by the formula (4-2-1) is particularly preferred in terms of its more significant effects of improving heat resistance.

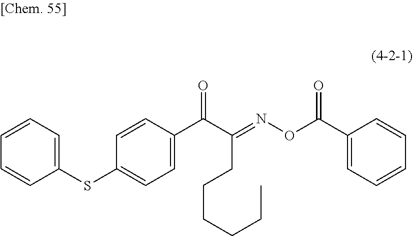 [SMILES: CCCCCC/C(=N\OC(=O)c1ccccc1)C(=O)c1ccc(Sc2ccccc2)cc1]

In the present invention, the oxime ester polymerization initiators may be used in combination with another photopolymerization initiator. Examples of the other photopolymerization initiator include “Irgacure 651”, “Irgacure 184”, “Darocur 1173”, “Irgacure 907”, “Irgacure 127”, “Irgacure 369”, “Irgacure 379”, “Irgacure 819”, “Irgacure 2959”, “Irgacure 1800”, “Irgacure 250”, “Irgacure 754”, “Irgacure 784”, “Lucirin TPO”, “Darocur 1173”, and “Darocur MBF” manufactured by BASF, “Esacure 1001M”, “Esacure KIPSO0”, “Speedcure BEM”, “Speedcure BMS”, “Speedcure MBP”, “Speedcure PBZ”, “Speedcure ITX”, “Speedcure DETX”, “Speedcure EBD”, “Speedcure MBB”, and “Speedcure BP” manufactured by LAMBSON, “Kayacure DMBI” manufactured by Nippon Kayaku Co., Ltd., “TAZ-A” manufactured by Nihon SiberHegner (now DKSH), “Adeka Optomer SP-152”, “Adeka Optomer SP-170”, “Adeka Optomer N-1414”, “Adeka Optomer N-1606”, and “Adeka Optomer N-1717” manufactured by Adeka Corporation, “Cyracure UVI-6990”, “Cyracure UVI-6974”, and “Cyracure UVI-6992” manufactured by UCC, “Adeka Optomer SP-150, SP-152, SP-170, SP-172” manufactured by Adeka Corporation, “Photoinitiator 2074” manufactured by Rhodia, “Irgacure 250” manufactured by BASF, “UV-9380C” manufactured by GE Silicones, and “DTS-102” manufactured by Midori Kagaku Co., Ltd.

The amount of photopolymerization initiator to be used preferably ranges from 0.1 to 10 parts by mass, particularly preferably 0.5 to 7 parts by mass, per 100 parts by mass of a polymerizable liquid crystal compound in a polymerizable liquid crystal composition. Use of 3 parts or more by mass of a photopolymerization initiator per 100 parts by mass of a polymerizable liquid crystal compound is preferred to improve the hardenability of an optically anisotropic body. These may be used alone or in combination, or a sensitizer may be added.

### (Organic Solvent)

An organic solvent may be added to a polymerizable liquid crystal composition according to the present invention. An organic solvent to be used is preferably, but not limited to, an organic solvent that can easily dissolve a polymerizable liquid crystal compound and that can evaporate at a temperature of 100° C. or less. Examples of such a solvent include aromatic hydrocarbons, such as toluene, xylene, cumene, and mesitylene, ester solvents, such as methyl acetate, ethyl acetate, propyl acetate, and butyl acetate, ketone solvents, such as methyl ethyl ketone (MEK), methyl isobutyl ketone (MIBK), cyclohexanone, and cyclopentanone, ether solvents, such as tetrahydrofuran, 1,2-dimethoxyethane, and anisole, amide solvents, such as N,N-dimethylformamide and N-methyl-2-pyrrolidone, and propylene glycol monomethyl ether acetate, diethylene glycol monomethyl ether acetate, γ-butyrolactone, and chlorobenzene. These may be used alone or in combination. At least one of ketone solvents, ether solvents, ester solvents, and aromatic hydrocarbon solvents is preferably used in terms of the stability of the solution.

A composition for use in the present invention can be applied to a substrate as a solution in an organic solvent. Organic solvents for use in a polymerizable liquid crystal composition may be used at any ratio, provided that the organic solvents do not significantly affect the application state. The total amount of organic solvents in a solution containing a polymerizable liquid crystal composition preferably ranges from 10% to 95% by mass, more preferably 12% to 90% by mass, particularly preferably 15% to 85% by mass.

For uniform dissolution, preferably, a polymerizable liquid crystal composition is dissolved in an organic solvent by heating and stirring. The heating temperature in the heating and stirring is adjusted for the solubility of the composition in the organic solvent and preferably ranges from 15° C. to 110° C., more preferably 15° C. to 105° C., still more preferably 15° C. to 100° C., particularly preferably 20° C. to 90° C., in terms of productivity.

The addition of a solvent is preferably accompanied by mixing using a mixer. Specific examples of the mixer include dispersers, dispersing apparatuses with impeller blades, such as propellers and turbine blades, paint shakers, planetary mixers, shaking apparatuses, shakers, and rotatory evaporators. Furthermore, ultrasonic irradiation apparatuses may also be used.

The rotational speed during the addition of a solvent is preferably adjusted for the type of mixer. To produce a uniform solution of a polymerizable liquid crystal composition, the rotational speed preferably ranges from 10 to 1000 rpm, more preferably 50 to 800 rpm, particularly preferably 150 to 600 rpm.

### (Polymerization Inhibitor)

A polymerization inhibitor is preferably added to a polymerizable liquid crystal composition according to the present invention. Examples of the polymerization inhibitor include phenolic compounds, quinone compounds, amine compounds, thioether compounds, and nitroso compounds.

Examples of the phenolic compounds include p-methoxyphenol, cresol, t-butylcatechol, 3,5-di-t-butyl-4-hydroxytoluene, 2,2′-methylenebis(4-methyl-6-t-butylphenol), 2,2′-methylenebis(4-ethyl-6-t-butylphenol), 4,4′-thiobis(3-methyl-6-t-butylphenol), 4-methoxy-1-naphthol, and 4,4′-dialkoxy-2,2′-bi-1-naphthol.

Examples of the quinone compounds include hydroquinone, methylhydroquinone, tert-butylhydroquinone, p-benzoquinone, methyl-p-benzoquinone, tert-butyl-p-benzoquinone, 2,5-diphenylbenzoquinone, 2-hydroxy-1,4-naphthoquinone, 1,4-naphthoquinone, 2,3-dichloro-1,4-naphthoquinone, anthraquinone, and diphenoquinone.

Examples of the amine compounds include p-phenylenediamine, 4-aminodiphenylamine, N,N′-diphenyl-p-phenylenediamine, N-i-propyl-N′-phenyl-p-phenylenediamine, N-(1,3-dimethylbutyl)-N′-phenyl-p-phenylenediamine, N,N′-di-2-naphthyl-p-phenylenediamine, diphenylamine, N-phenyl-β-naphthylamine, 4,4′-dicumyl-diphenylamine, and 4,4′-dioctyl-diphenylamine.

Examples of the thioether compounds include phenothiazine and distearyl thiodipropionate.

Examples of the nitroso compounds include N-nitrosodiphenylamine, N-nitrosophenylnaphthylamine, N-nitrosodinaphthylamine, p-nitrosophenol, nitrosobenzene, p-nitrosodiphenylamine, α-nitroso-β-naphthol, N,N-dimethyl p-nitrosoaniline, p-nitrosodiphenylamine, p-nitrondimethylamine, p-nitron-N,N-diethylamine, N-nitrosoethanolamine, N-nitrosodi-n-butylamine, N-nitroso-N-n-butyl-4-butanolamine, N-nitroso-diisopropanolamine, N-nitroso-N-ethyl-4-butanolamine, 5-nitroso-8-hydroxyquinoline, N-nitrosomorpholine, N-nitroso-N-phenylhydroxylamine ammonium salt, nitrosobenzene, 2,4,6-tri-tert-butylnitronbenzene, N-nitroso-N-methyl-p-toluenesulfonamide, N-nitroso-N-ethylurethane, N-nitroso-N-n-propylurethane, 1-nitroso-2-naphthol, 2-nitroso-1-naphthol, 1-nitroso-2-naphthol-3,6-sulfonic acid sodium, 2-nitroso-1-naphthol-4-sulfonic acid sodium, 2-nitroso-5-methylaminophenol hydrochloride, and 2-nitroso-5-methylaminophenol hydrochloride.

The amount of polymerization inhibitor to be added preferably ranges from 0.01% to 1.0% by mass, more preferably 0.05% to 0.5% by mass, of the polymerizable liquid crystal composition.

### (Thermal Polymerization Initiator)

A polymerizable liquid crystal composition according to the present invention may contain a thermal polymerization initiator as well as a photopolymerization initiator. The thermal polymerization initiator may be a traditional thermal polymerization initiator, for example, an organic peroxide, such as methyl acetoacetate peroxide, cumene hydroperoxide, benzoyl peroxide, bis(4-t-butylcyclohexyl)peroxy dicarbonate, t-butylperoxybenzoate, methyl ethyl ketone peroxide, 1,1-bis(t-hexylperoxy)3,3,5-trimethylcyclohexane, p-pentahydroperoxide, t-butylhydroperoxide, dicumyl peroxide, isobutyl peroxide, di(3-methyl-3-methoxybutyl)peroxy dicarbonate, or 1,1-bis(t-butylperoxy)cyclohexane, an azonitrile compound, such as 2,2′-azobisisobutyronitrile, 2,2′-azobis(2,4-dimethylvaleronitrile), an azoamidine compound, such as 2,2′-azobis(2-methyl-N-phenylpropion-amidine) dihydrochloride, an azoamide compound, such as 2,2′azobis{2-methyl-N-[1,1-bis(hydroxymethyl)-2-hydroxyethyl]propionamide}, or an alkylazo compound, such as 2,2′azobis(2,4,4-trimethylpentane). Specific examples include “V-40” and “VF-096” manufactured by Wako Pure Chemical Industries, Ltd. and “Perhexyl D” and “Perhexyl I” manufactured by Nippon Oil & Fats Co., Ltd. (now NOF Corporation).

The amount of thermal polymerization initiator to be used preferably ranges from 0.1 to 10 parts by mass, particularly preferably 0.5 to 5 parts by mass, per 100 parts by mass of a polymerizable liquid crystal compound in a polymerizable liquid crystal composition. These may be used alone or in combination.

### (Surfactant)

A polymerizable liquid crystal composition according to the present invention may contain at least one surfactant to decrease variations in the film thickness of an optically anisotropic body. Examples of the surfactant to be contained include alkyl carboxylates, alkyl phosphates, alkyl sulfonates, fluoroalkyl carboxylates, fluoroalkyl phosphates, fluoroalkyl sulfonates, polyoxyethylene derivatives, fluoroalkylethylene oxide derivatives, poly(ethylene glycol) derivatives, alkylammonium salts, and fluoroalkylammonium salts. In particular, fluorinated and acrylic surfactants are preferred.

Specific examples include “Megaface F-251”, “Megaface F-444”, “Megaface F-477”, “Megaface F-510”, “Megaface F-552”, “Megaface F-553”, “Megaface F-554”, “Megaface F-555”, “Megaface F-556”, “Megaface F-557”, “Megaface F-558”, “Megaface F-559”, “Megaface F-560”, “Megaface F-561”, “Megaface F-562”, “Megaface F-563”, “Megaface F-565”, “Megaface F-567”, “Megaface F-568”, “Megaface F-569”, “Megaface F-570”, “Megaface F-571”, “Megaface R-40”, “Megaface R-41”, “Megaface R-43”, “Megaface R-94”, “Megaface RS-72-K”, “Megaface RS-75”, “Megaface RS-76-E”, and “Megaface RS-90” (manufactured by DIC Corporation),

“Ftergent 100”, “Ftergent 100C”, “Ftergent 110”, “Ftergent 150”, “Ftergent 150CH”, “Ftergent A”, “Ftergent 100A-K”, “Ftergent 501”, “Ftergent 300”, “Ftergent 310”, “Ftergent 320”, “Ftergent 400SW”, “FTX-400P”, “Ftergent 251”, “Ftergent 215M”, “Ftergent 212MH”, “Ftergent 250”, “Ftergent 222F”, “Ftergent 212D”, “FTX-218”, “FTX-209F”, “FTX-213F”, “FTX-233F”, “Ftergent 245F”, “FTX-208G”, “FTX-240G”, “FTX-206D”, “FTX-220D”, “FTX-230D”, “FTX-240D”, “FTX-207S”, “FTX-211S”, “FTX-220S”, “FTX-230S”, “FTX-750FM”, “FTX-730FM”, “FTX-730FL”, “FTX-710FS”, “FTX-710FM”, “FTX-710FL”, “FTX-750LL”, “FTX-730LS”, “FTX-730LM”, “FTX-730LL”, and “FTX-710LL” (manufactured by NEOS Co., Ltd.),

“BYK-300”, “BYK-302”, “BYK-306”, “BYK-307”, “BYK-310”, “BYK-315”, “BYK-320”, “BYK-322”, “BYK-323”, “BYK-325”, “BYK-330”, “BYK-331”, “BYK-333”, “BYK-337”, “BYK-340”, “BYK-344”, “BYK-370”, “BYK-375”, “BYK-377”, “BYK-350”, “BYK-352”, “BYK-354”, “BYK-355”, “BYK-356”, “BYK-358N”, “BYK-361N”, “BYK-357”, “BYK-390”, “BYK-392”, “BYK—UV 3500”, “BYK—UV 3510”, “BYK—UV 3570”, and “BYK-Silclean 3700” (manufactured by BYK Japan KK),

“TEGO Rad 2100”, “TEGO Rad 2200N”, “TEGO Rad 2250”, “TEGO Rad 2300”, “TEGO Rad 2500”, “TEGO Rad 2600”, “TEGO Rad 2700”, “TEGO Flow 300”, “TEGO Flow 370”, “TEGO Flow 425”, “TEGO Flow ATF2”, and “TEGO Flow ZFS460” (manufactured by Evonik Industries AG.), and

“N215”, “N535”, “N605K”, and “N935” (manufactured by Solvay Solexis).

Although a surfactant is not an essential component in the present invention, the amount of surfactant, if present, preferably ranges from 0.01 to 2 parts by mass, more preferably 0.05 to 0.5 parts by mass, per 100 parts by mass of a polymerizable liquid crystal compound in a polymerizable liquid crystal composition.

The use of the surfactant can effectively decrease the tilt angle of the air interface in an optically anisotropic body formed of a polymerizable liquid crystal composition according to the present invention.

In addition to the surfactant that can effectively decrease the tilt angle of the air interface in an optically anisotropic body, a polymerizable liquid crystal composition according to the present invention may include a compound with a repeating unit represented by the following general formula (7) and with a weight-average molecular weight of 100 or more.

[Chem. 56]

CR¹¹R¹²—CR¹³R¹⁴ (7)

In the formula, R¹¹, R¹², R¹³, and R¹⁴ independently denote a hydrogen atom, a halogen atom, or a hydrocarbon group having 1 to 20 carbon atoms, and the hydrogen atoms in the hydrocarbon group are optionally substituted with one or more halogen atoms.

Preferred examples of the compound represented by the general formula (7) include polyethylene, polypropylene, polyisobutylene, paraffin, liquid paraffin, chlorinated polypropylene, chlorinated paraffin, and chlorinated liquid paraffin.

The amount of the compound represented by the general formula (7) to be added preferably ranges from 0.01 to 1 part by mass, more preferably 0.05 to 0.5 parts by mass, per 100 parts by mass of a polymerizable liquid crystal compound in a polymerizable liquid crystal composition.

(Non-Liquid-Crystal Compound with Polymerizable Group)

A compound that has a polymerizable group but is not a liquid crystal compound may be added to a polymerizable liquid crystal composition according to the present invention. Such a compound may typically be any compound recognized as a polymerizable monomer or a polymerizable oligomer in this technical field. The amount of non-liquid-crystal compound with a polymerizable group to be added preferably ranges from 0.01 to 15 parts by mass, more preferably 0.05 to 10 parts by mass, particularly preferably 0.05 to 5 parts by mass, per 100 parts by mass of a polymerizable liquid crystal compound in a polymerizable liquid crystal composition.

Specific examples include mono(meth)acrylates, such as methyl (meth)acrylate, ethyl (meth)acrylate, 2-hydroxyethyl acrylate, propyl (meth)acrylate, 2-hydroxypropyl (meth)acrylate, butyl (meth)acrylate, isobutyl (meth)acrylate, 4-hydroxybutyl (meth)acrylate, 2-hydroxybutyl (meth)acrylate, octyl (meth)acrylate, 2-ethylhexyl (meth)acrylate, dodecyl (meth)acrylate, stearyl (meth)acrylate, cyclohexyl (meth)acrylate, dicyclopentanyloxylethyl (meth)acrylate, isobornyloxylethyl (meth)acrylate, isobornyl (meth)acrylate, adamantyl (meth)acrylate, dimethyladamantyl (meth)acrylate, dicyclopentanyl (meth)acrylate, dicyclopentenyl (meth)acrylate, dicyclopentenyloxyethyl (meth)acrylate, methoxyethyl (meth)acrylate, ethyl carbitol (meth)acrylate, tetrahydrofurfuryl (meth)acrylate, benzyl (meth)acrylate, phenoxyethyl (meth)acrylate, 2-phenoxydiethylene glycol (meth)acrylate, ω-carboxy-polycaprolactone (n≈2) monoacrylate, 2-hydroxy-3-phenoxypropyl acrylate, 2-hydroxy-3-phenoxyethyl (meth)acrylate, (2-methyl-2-ethyl-1,3-dioxolane-4-yl)methyl (meth)acrylate, (3-ethyloxetane-3-yl)methyl (meth)acrylate, o-phenylphenolethoxy (meth)acrylate, dimethylamino(meth)acrylate, diethylamino(meth)acrylate, 2,2,3,3,3-pentafluoropropyl (meth)acrylate, 2,2,3,4,4,4-hexafluorobutyl (meth)acrylate, 2,2,3,3,4,4,4-heptafluorobutyl (meth)acrylate, 2-(perfluorobutyl)ethyl (meth)acrylate, 2-(perfluorohexyl)ethyl (meth)acrylate, 1H,1H,3H-tetrafluoropropyl (meth)acrylate, 1H,1H,5H-octafluoropentyl (meth)acrylate, 1H,1H,7H-dodecafluoroheptyl (meth)acrylate, 1H-1-(trifluoromethyl)trifluoroethyl (meth)acrylate, 1H, 1H,3H-hexafluorobutyl (meth)acrylate, 1,2,2,2-tetrafluoro-1-(trifluoromethyl)ethyl (meth)acrylate, 1H,1H-pentadecafluorooctyl (meth)acrylate, 1H,1H,2H,2H-tridecafluorooctyl (meth)acrylate, 2-(meth)acryloyloxyethylphthalic acid, 2-(meth)acryloyloxyethylhexahydrophthalic acid, glycidyl (meth)acrylate, 2-(meth)acryloyloxyethyl phosphate, acryloylmorpholine, dimethylacrylamide, dimethylaminopropylacrylamide, iropropylacrylamide, diethylacrylamide, hydroxyethylacrylamide, and N-acryloyloxyethylhexahydrophthalimide, diacrylates, such as 1,4-butanediol di(meth)acrylate, 1,6-hexanediol di(meth)acrylate, 1,9-nonanediol di(meth)acrylate, neopentyldiol di(meth)acrylate, tripropylene glycol di(meth)acrylate, ethylene glycol di(meth)acrylate, diethylene glycol di(meth)acrylate, triethylene glycol di(meth)acrylate, ethylene-oxide-modified bisphenol A di(meth)acrylate, tricyclodecane dimethanol di(meth)acrylate, 9,9-bis[4-(2-acryloyloxyethoxy)phenyl]fluorene, glycerin di(meth)acrylate, 2-hydroxy-3-acloyloxypropyl methacrylate, a 1,6-hexanediol diglycidyl ether acrylic acid adduct, and a 1,4-butanediol diglycidyl ether acrylic acid adduct, tri(meth)acrylates, such as trimethylolpropane tri(meth)acrylate, ethoxylated isocyanurate triacrylate, pentaerythritol tri(meth)acrylate, and ε-caprolactone-modified tris-(2-acryloyloxyethyl) isocyanurate, tetra(meth)acrylates, such as pentaerythritol tetra(meth)acrylate and ditrimethylolpropane tetra(meth)acrylate, dipentaerythritol hexa(meth)acrylate, oligomer type (meth)acrylates, various urethane acrylates, various macromonomers, epoxy compounds, such as ethylene glycol diglycidyl ether, diethylene glycol diglycidyl ether, propylene glycol diglycidyl ether, neopentyl glycol diglycidyl ether, 1,6-hexanediol diglycidyl ether, glycerin diglycidyl ether, and bisphenol A diglycidyl ether, and maleimides. These may be used alone or in combination.

### (Chain Transfer Agent)

A chain transfer agent is also preferably added to a polymerizable liquid crystal composition according to the present invention to improve the adhesion of an optically anisotropic body formed of the polymerizable cholesteric liquid crystal composition to a substrate. The chain transfer agent is preferably a thiol compound, more preferably a monothiol, dithiol, trithiol, or tetrathiol compound, still more preferably a trithiol compound. More specifically, the compounds represented by the following general formulae (8-1) to (8-13) are preferred.

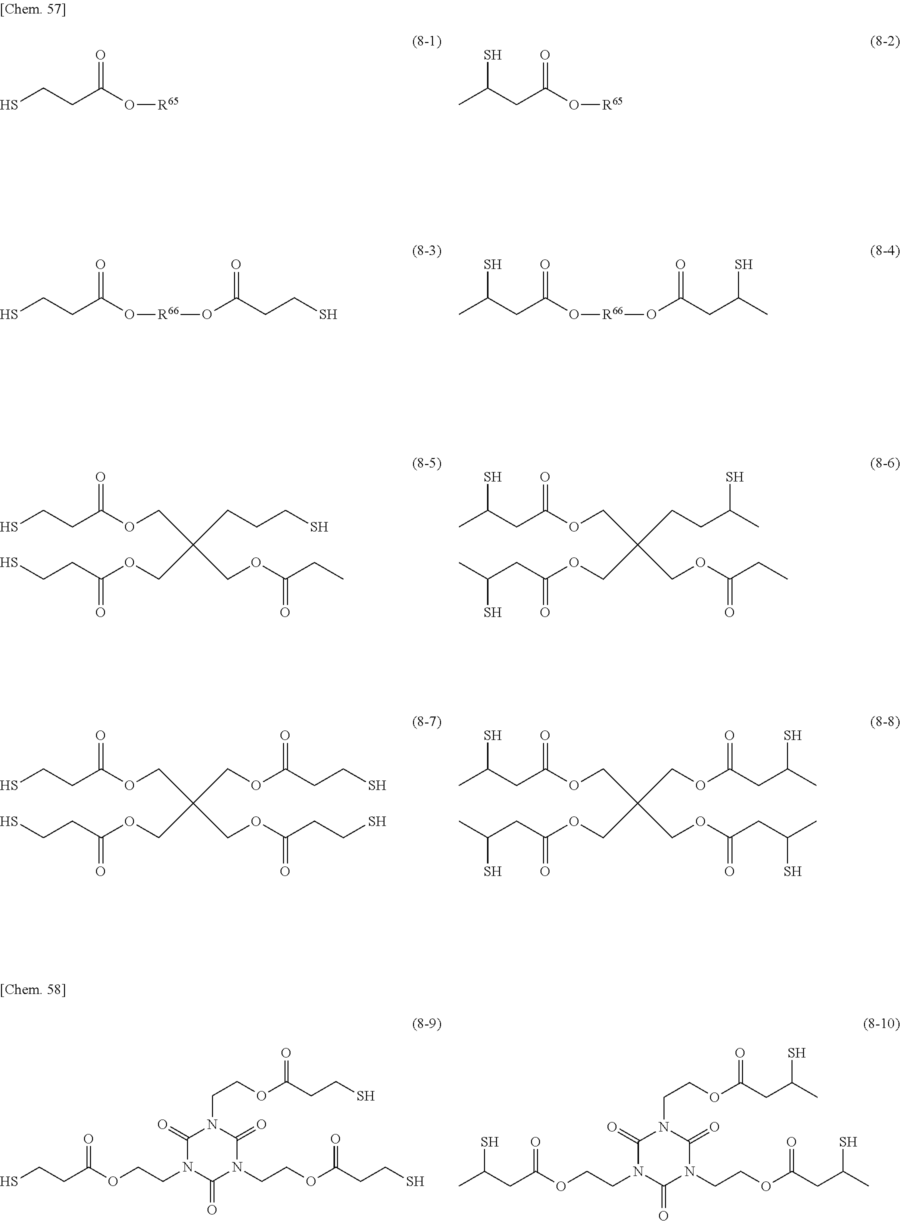

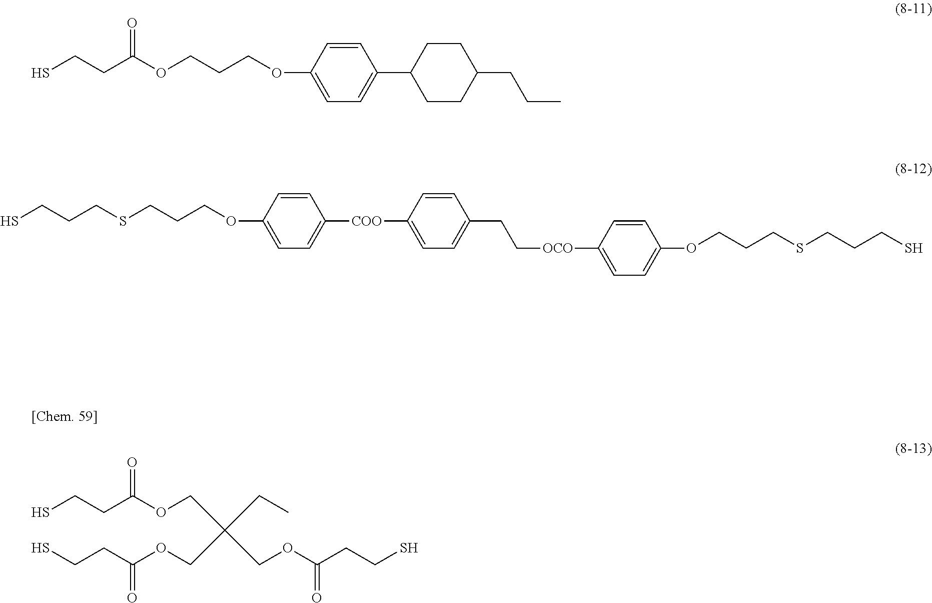

In the formulae, R⁶⁵ denotes an alkyl group having 2 to 18 carbon atoms, the alkyl group may be linear or branched, one or more methylene groups in the alkyl group are optionally substituted with an oxygen atom, a sulfur atom, —CO—, —OCO—, —COO—, or —CH═CH— without direct bonding of oxygen atoms or sulfur atoms, R⁶⁶ denotes an alkylene group having 2 to 18 carbon atoms, and one or more methylene groups in the alkylene group are optionally substituted with an oxygen atom, a sulfur atom, —CO—, —OCO—, —COO—, or —CH═CH— without direct bonding of oxygen atoms or sulfur atoms.

An α-methylstyrene dimer is also suitably used as a chain transfer agent other than thiols.

The amount of chain transfer agent to be added preferably ranges from 0.5 to 10 parts by mass, more preferably 1.0 to 5.0 parts by mass, per 100 parts by mass of a polymerizable liquid crystal compound in a polymerizable liquid crystal composition.

### (Colorant)

A polymerizable liquid crystal composition according to the present invention can contain a colorant, if necessary. A colorant to be used may be any traditional colorant that does not affect the alignment.

Examples of the colorant include dichroic dyes and fluorochromes. Examples of such colorants include polyazo dyes, anthraquinone dyes, cyanine dyes, phthalocyanine dyes, perylene dyes, perinone dyes, and squarylium dyes. The colorant is preferably a liquid crystalline colorant in terms of addition. For example, a colorant to be used is described in U.S. Pat. No. 2,400,877, Dreyer J. F., Phys. and Colloid Chem., 1948, 52, 808., “The Fixing of Molecular Orientation”, Dreyer J. F., Journal de Physique, 1969, 4, 114., “Light Polarization from Films of Lyotropic Nematic Liquid Crystals”, and J. Lydon, “Chromonics” in “Handbook of Liquid Crystals Vol. 2B: Low Molecular Weight Liquid Crystals II”, D. Demus, J. Goodby, G. W. Gray, H. W. Spiessm, V. Vill ed, Willey-VCH, P. 981-1007 (1998), Dichroic Dyes for Liquid Crystal Display A. V. Ivashchenko CRC Press, 1994, and “Kinouseishikisoshijo no shintenkai”, Chapter 1, p. 1, 1994, CMC.

For example, the dichroic dyes are represented by the following formulae (d-1) to (d-8).

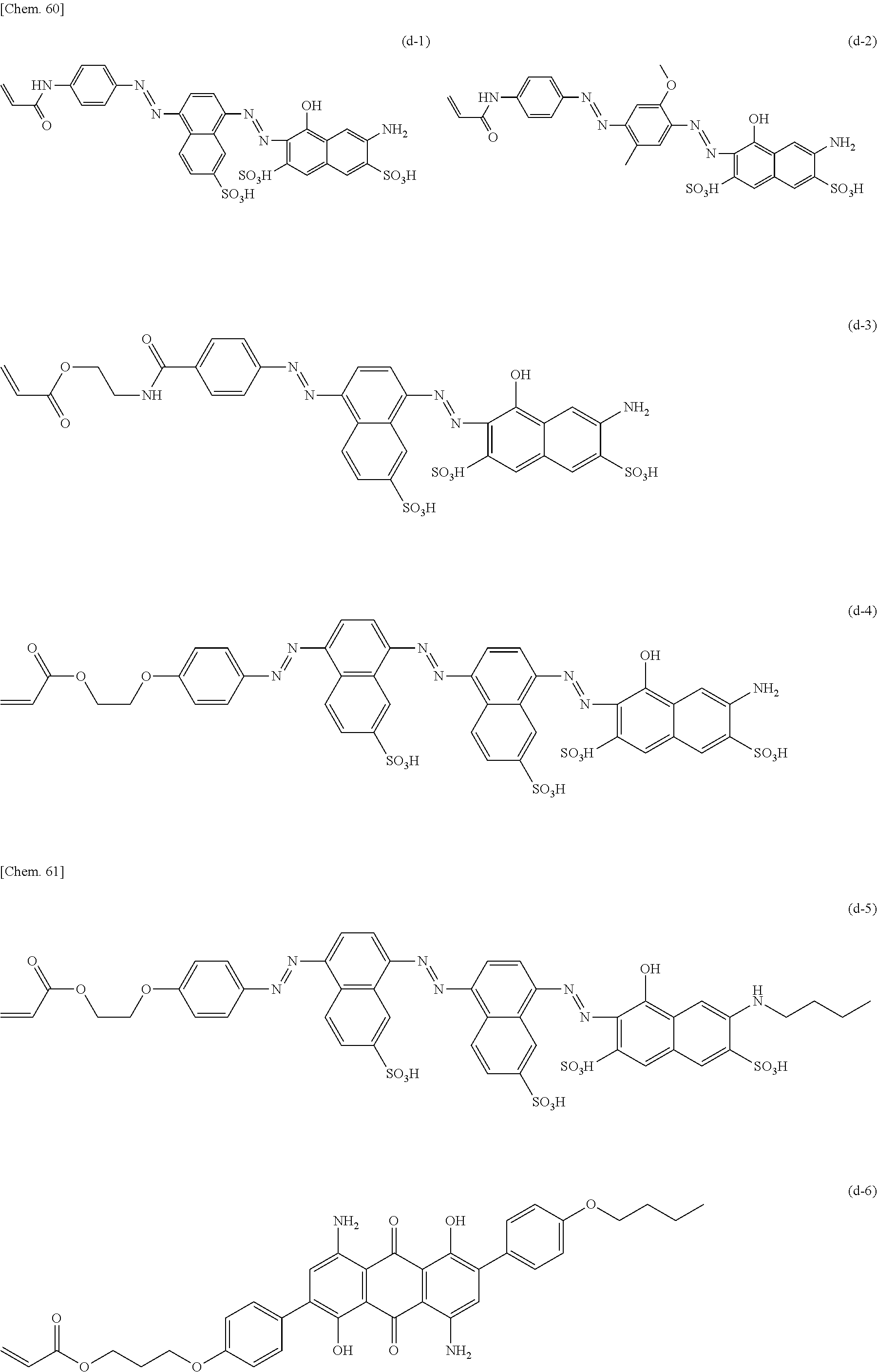

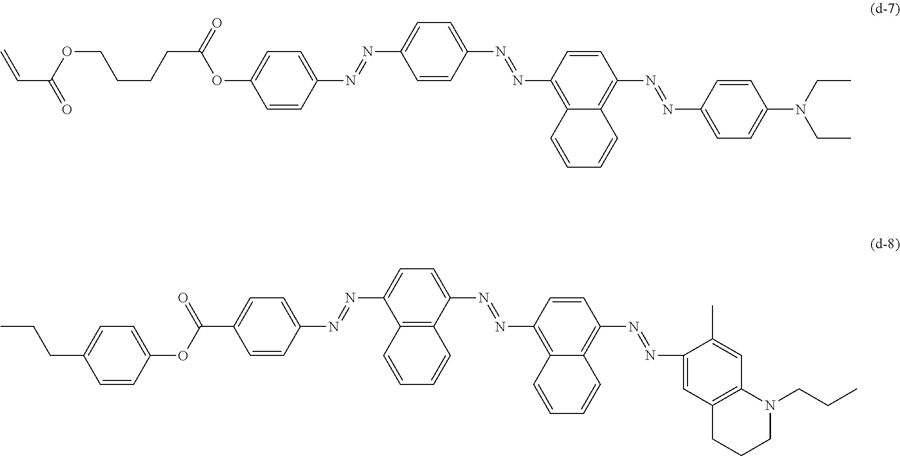

The amount of colorant, such as dichroic dye, to be added preferably ranges from 0.001 to 10 parts by mass, more preferably 0.01 to 5 parts by mass, per 100 parts by mass in total of a polymerizable liquid crystal compound in a powder mixture.

### (Filler)

A polymerizable liquid crystal composition according to the present invention can contain a filler, if necessary. A filler to be used may be any traditional filler that does not decrease the thermal conductivity of a resulting polymer. Specific examples of the filler include inorganic fillers, such as alumina, titanium white, aluminum hydroxide, talc, clay, mica, barium titanate, zinc oxide, and glass fiber, metal powders, such as a silver powder and a copper powder, thermal conductivity fillers, such as aluminum nitride, boron nitride, silicon nitride, gallium nitride, silicon carbide, magnesia (aluminum oxide), alumina (aluminum oxide), crystalline silica (silicon oxide), and fused silica (silicon oxide), and silver nanoparticles.

### (Other Additive Agents)

To adjust physical properties, additive agents, such as a polymerizable compound with no liquid crystallinity, a thixotropic agent, an ultraviolet absorber, an infrared absorber, an antioxidant, and a surface-treating agent, may be added for each purpose, provided that the alignment ability of liquid crystals is not significantly reduced.

### (Method for Producing Optical Film)

Next, an optical film according to the present invention is formed of a cured product of a polymerizable liquid crystal composition described above in detail. A method for producing an optical film from a polymerizable liquid crystal composition according to the present invention specifically includes applying a polymerizable liquid crystal composition to a substrate, drying the polymerizable liquid crystal composition, and then irradiating the polymerizable liquid crystal composition with ultraviolet light.

### (Substrate)

A substrate for use in an optical film according to the present invention is a substrate generally used in liquid crystal devices, displays, optical components, and optical films and may be formed of any heat-resistant material that can withstand heat during drying of an applied polymerizable liquid crystal composition according to the present invention. Examples of such a substrate include glass substrates, metal substrates, ceramic substrates, and organic materials, such as plastic substrates. In particular, examples of organic materials for the substrate include cellulose derivatives, polyolefin, polyester, polycarbonate, polyacrylate (acrylic resin), polyarylate, polyethersulfone, polyimide, poly(phenylene sulfide), poly(phenylene ether), nylon, and polystyrene. Among these, plastic substrates formed of polyester, polystyrene, polyacrylate, polyolefin, cellulose derivatives, polyarylate, polycarbonate, and the like are preferred, and substrates formed of polyester, polyacrylate, polyolefin, and cellulose derivatives are more preferred. Poly(ethylene terephthalate) (PET) is particularly preferably used as a polyester. A cycloolefin polymer (COP) is particularly preferably used as a polyolefin. Cellulose triacetate (TAC) is particularly preferably used as a cellulose derivative. Poly(methyl methacrylate) (PMMA) is particularly preferably used as a polyacrylate. The shape of the substrate may be flat or may have a curved surface. If necessary, these substrates may have an electrode layer, an antireflection function, or a reflection function.

In order to improve the coating performance or adhesiveness of a polymerizable liquid crystal composition according to the present invention, these substrates may be surface-treated. Examples of the surface treatment include ozone treatment, plasma treatment, corona treatment, and silane coupling treatment. In order to adjust light transmittance and reflectance, an organic thin film, an inorganic oxide thin film, or a thin metal film may be formed on the substrate by evaporation. In order to provide optical added value, the substrate may be a pickup lens, a rod lens, an optical disk, a retardation film, a light diffusing film, or a color filter. Among these, a pickup lens, a retardation film, a light diffusing film, and a color filter are preferred to further improve the added value.

### (Alignment Treatment)

The substrate is preferably a glass substrate alone or provided with an alignment film such that a polymerizable liquid crystal composition according to the present invention can be aligned during the application and drying of the polymerizable liquid crystal composition. Examples of alignment treatment include stretching, rubbing, polarized ultraviolet visible light irradiation, and ion beam treatment. The alignment film, if used, may be a traditional alignment film. Examples of such an alignment film include polyimide films, polyamide films, lecithin films, hydrophilic polymer films with a hydroxy group, a carboxy group, or a sulfonate group, hydrophilic inorganic compound films, and photo-alignment films. Examples of the hydrophilic polymer include poly(vinyl alcohol), poly(acrylic acid), sodium polyacrylate, poly(methacrylic acid), sodium polyalginate, polycarboxymethylcellulose sodium, pullulan, and poly(styrene sulfonate). Examples of the hydrophilic inorganic compound include inorganic compounds such as oxides and fluorides of Si, Al, Mg, and Zr. A hydrophilic substrate is effective in aligning an optical axis of an optically anisotropic body almost parallel to the direction normal to the substrate and is therefore preferably used to produce an optically anisotropic body of a positive C plate. A rubbed hydrophilic substrate, however, acts as a horizontal alignment film. Thus, rubbing of a hydrophilic polymer layer adversely affects vertical alignment and is unfavorable for obtaining an optical film of a positive C plate.

### (Coating)

A method for applying a polymerizable liquid crystal composition according to the present invention to the substrate may be a traditional method, such as an applicator method, a bar coating method, a spin coating method, a roll coating method, a direct gravure coating method, a reverse gravure coating method, a flexographic coating method, an ink jet method, a die coating method, a cap coating method, a dip coating method, or a slit coating method. After the polymerizable liquid crystal composition is applied, if necessary, a solvent in the polymerizable liquid crystal composition is evaporated.

### (Polymerization Process)

A polymerizable liquid crystal composition according to the present invention is typically polymerized by light irradiation, such as ultraviolet radiation, or by heating while a liquid crystal compound in the polymerizable liquid crystal composition has cholesteric alignment on a substrate. More specifically, for polymerization by light irradiation, ultraviolet radiation at 390 nm or less is preferred, and light irradiation at a wavelength in the range of 250 to 370 nm is most preferred. If ultraviolet light of 390 nm or less causes degradation of a polymerizable liquid crystal composition, ultraviolet light of 390 nm or more may preferably be used for polymerization. The light is preferably diffused unpolarized light.

### (Polymerization Method)

A method for polymerizing a polymerizable liquid crystal composition according to the present invention may be an active energy beam irradiation method or a thermal polymerization method. The active energy beam irradiation method is preferred because heating is not required and because the reaction proceeds at room temperature. In particular, an ultraviolet radiation method is preferred because of its simple operation.

The irradiation temperature is preferably a temperature at which a polymerizable liquid crystal composition according to the present invention can maintain its liquid crystal phase, and is preferably 50° C. or less if possible so as not to induce thermal polymerization of the polymerizable liquid crystal composition.

The radiation intensity and radiation energy in light irradiation, such as ultraviolet radiation, have a great influence on the heat resistance of a resulting optical film. Excessively low radiation intensity or radiation energy results in a partly incomplete polymerization reaction and affects heat resistance, and excessively high radiation intensity or radiation energy results in a difference in the degree of polymerization in the depth direction of the layer and also affects heat resistance.

With respect to radiation intensity, ultraviolet radiation with 30 to 2,000 mW/cm² UVA light (UVA is ultraviolet light in the range of 315 to 380 nm) is preferred, ultraviolet radiation with 50 to 1,500 mW/cm² UVA light is more preferred, ultraviolet radiation with 120 to 1,000 mW/cm² UVA light is still more preferred, and ultraviolet radiation with 250 to 1,000 mW/cm² UVA light is most preferred. With respect to radiation energy, ultraviolet radiation with 100 to 5,000 mJ/cm² UVA light is preferred, ultraviolet radiation with 150 to 4,000 mJ/cm² UVA light is more preferred, ultraviolet radiation with 200 to 3,000 mJ/cm² UVA light is still more preferred, and ultraviolet radiation with 300 to 1,000 mJ/cm² UVA light is most preferred. UV radiation may be performed multiple times. Preferably, the first radiation intensity is the UV intensity described above. More preferably, the first radiation energy is the UV radiation energy described above.

In the present invention, when a bifunctional polymerizable liquid crystal compound represented by the general formula (I-1) and a monofunctional polymerizable liquid crystal compound represented by the general formula (II-1) are used at an abundance ratio [(I-1)/(II-1)] in the range of 90/10 to 50/50 based on mass, UVA radiation in the range of 300 to 1,000 mJ/cm² is preferred in terms of heat resistance.

An optical film formed by polymerizing a polymerizable liquid crystal composition according to the present invention may be removed from a substrate and used alone as an optical film, or may not be removed from a substrate and used as an optical film without modification. In particular, such an optical film rarely contaminates other members and is useful as a substrate for lamination or as a laminate with another substrate.

An optical film thus formed can be a cholesteric reflective film with high color purity. Such a cholesteric reflective film can be used as a negative C plate in which a rod-like liquid crystal compound has cholesteric alignment on a substrate, a selective reflection film (band-stop filter) that reflects light with a particular wavelength, or a twisted positive A plate in which a rod-like liquid crystal compound has horizontal alignment on a substrate and has a twisted alignment state.

A cholesteric reflective film according to the present invention laminated with a λ/4 sheet and a dual brightness enhancement film (DBEF) can selectively reflect only unnecessary colors of light emitted from a light source and improve color purity as a display device.

An optical film according to the present invention can be appropriately used according to the intended use in various applications, such as liquid crystal devices, displays, optical devices, optical components, colorants, security marking, laser emission components, optical films, and compensation films, as well as the cholesteric reflective films, and can also be used as a brightness enhancement film, a reflective polarizer, or a viewing angle compensation film, for example.

For example, when an optical film according to the present invention is used as a brightness enhancement film, the brightness enhancement film includes a λ/4 sheet and a reflection polarizer. The reflection polarizer includes a first light reflective layer, a second light reflective layer, and a third light reflective layer in this order on the λ/4 sheet. The first light reflective layer, the second light reflective layer, and the third light reflective layer are formed of an optical film according to the present invention. One of the first light reflective layer, the second light reflective layer, and the third light reflective layer is a blue light reflective layer that has a reflectance peak with a reflection center wavelength in the range of 380 to 499 nm and with a half-width of 100 nm or less, one of them is a green light reflective layer that has a reflectance peak with a reflection center wavelength in the range of 500 to 599 nm and with a half-width of 200 nm or less, and one of them is a red light reflective layer that has a reflectance peak with a reflection center wavelength in the range of 600 to 750 nm and with a half-width of 150 nm or less. These layers are laminated, or the cholesteric liquid crystal pitch is changed on the top and the bottom of the layer, and one or two layers with a half-width in the range of 200 to 400 nm are laminated.

When an optical film according to the present invention is used as a reflective polarizer, the reflective polarizer includes a cholesteric reflective film, an adhesive layer, and a linearly polarizing film laminated, and the cholesteric reflective film is a cholesteric reflective film according to the present invention. The reflective polarizer may include at least one retardation film, and the retardation film may be retardation films with different phase differences. Retardation films are laminated by attaching an adhesive agent or an adhesive film to a resulting retardation film, and then bonding a cholesteric reflective film according to the present invention and the retardation film together with an adhesive agent or an adhesive film interposed therebetween. The adhesive agent or adhesive film, if used, is a traditional adhesive agent or adhesive film for use in optical films.

### EXAMPLES

The present invention is further described in the following synthesis examples, examples, and comparative examples. However, the present invention is not limited to these examples. Unless otherwise specified, “parts” and “%” are based on mass.

### (Preparation of Polymerizable Liquid Crystal Composition)

100 parts by mass in total of polymerizable liquid crystal compounds represented by the formulae (A-1) to (A-4) and the formulae (B-1) to (B-6), polymerizable chiral compounds represented by the formulae (C-1) and (C-2), polymerization initiators represented by the formulae (D-1) to (D-6), a polymerization inhibitor (E-1), and a surfactant (F-1) were mixed with solvents (G-1) and (G-2) at the ratios (parts by mass) listed in Tables 1 to 4 to prepare polymerizable liquid crystal compositions (1) to (28).

### (Preparation of Polymerizable Liquid Crystal Composition (1))

As listed in Table 1, 100 parts by mass in total of 34 parts by mass of the compound represented by the formula (A-1), 34 parts by mass of the compound represented by the formula (A-2), 22.6 parts by mass of the compound represented by the formula (B-5), 4.2 parts by mass of the compound represented by the formula (C-1), 5 parts by mass of (D-1), 0.1 parts by mass of (E-1), and 0.1 parts by mass of (F-1), 130 parts by mass of the organic solvent (G-1), and 56 parts by mass of the organic solvent (G-2) were stirred using a stirrer with a stirring propeller at a stirring speed of 500 rpm and at a solution temperature of 60° C. for 15 minutes and were then passed through a 0.2-μm membrane filter to prepare a polymerizable liquid crystal composition (1).

### (Preparation of Polymerizable Liquid Crystal Compositions (2) to (16) and Comparative Polymerizable Liquid Crystal Compositions (17) to (20))

Polymerizable liquid crystal compositions (2) to (16) and comparative polymerizable liquid crystal compositions (17) to (20) were prepared in the same manner as in the polymerizable liquid crystal composition (1) according to the present invention at the ratios listed in Tables 1 to 3.

TABLE 1

| Composition | (1) | (2) | (3) | (4) | (5) | (6) | (7) | (8) | (9) | (10) |
|---|---|---|---|---|---|---|---|---|---|---|
| (A-1) | 34 | 34 | 34 | 30 | 45.3 | 45.3 | 45.3 | 36.3 | 45.3 | 34 |
| (A-2) | 34 | 34 | 34 | 30 | 45.3 | 45.3 | | 36.3 | | 34 |
| (A-3) | | | | | | | | | 18.1 | |
| (A-4) | | | | | | | 45.3 | | | |
| (B-1) | | | | | | | | | | |
| (B-2) | | | | | | | | | | 22.5 |
| (B-3) | | | | | | | | | | |
| (B-4) | | | | | | | | | 9 | |
| (B-5) | 22.6 | 22.6 | 22.6 | 30.6 | | | | | 18.1 | |
| (B-6) | | | | | | | | 18 | | |
| (C-1) | 4.2 | 4.2 | 4.2 | 4.2 | 4.2 | | 4.2 | 4.2 | 4.3 | 4.3 |
| (C-2) | | | | | | 4.2 | | | | |
| (D-1) | 5 | | | 5 | 5 | 5 | 5 | 5 | 5 | 5 |
| (D-2) | | 5 | | | | | | | | |
| (D-3) | | | 5 | | | | | | | |
| (D-4) | | | | | | | | | | |
| (D-5) | | | | | | | | | | |
| (D-6) | | | | | | | | | | |
| (E-1) | 0.1 | 0.1 | 0.1 | 0.1 | 0.1 | 0.1 | 0.1 | 0.1 | 0.1 | 0.1 |
| (F-1) | 0.1 | 0.1 | 0.1 | 0.1 | 0.1 | 0.1 | 0.1 | 0.1 | 0.1 | 0.1 |
| (G-1) | 130 | 130 | 130 | 130 | 130 | 130 | 130 | 130 | 130 | 130 |
| (G-2) | 56 | 56 | 56 | 56 | 56 | 56 | 56 | 56 | 56 | 56 |

TABLE 2

| Composition | (11) | (12) | (13) | (14) | (15) | (16) | (17) | (18) | (19) | (20) |
|---|---|---|---|---|---|---|---|---|---|---|
| (A-1) | 34 | 34 | 34 | 25 | 20 | 20 | 34 | 30 | 30 | 45.3 |
| (A-2) | 34 | 34 | 34 | 25 | | | 34 | 30 | 30 | 45.3 |
| (A-3) | | | | | | | | | | |
| (A-4) | | | | | | | | | | |
| (B-1) | | | | 20.2 | 35.2 | 22.6 | | | | |
| (B-2) | 22.5 | | | 20.3 | 35.2 | 25.2 | | | | |
| (B-3) | | 22.6 | | | | | | | | |
| (B-4) | | | 22.6 | | | | | | | |
| (B-5) | | | | | | 22.6 | 22.6 | 30.6 | 30.6 | |
| (B-6) | | | | | | | | | | |
| (C-1) | 4.3 | 4.2 | 4.2 | 4.3 | 4.4 | 4.4 | 4.2 | 4.2 | 4.2 | 4.2 |
| (C-2) | | | | | | | | | | |
| (D-1) | | 5 | 5 | 5 | 5 | 5 | | | | |
| (D-2) | 5 | | | | | | | | | |
| (D-3) | | | | | | | | | | |
| (D-4) | | | | | | | 5 | | | 5 |
| (D-5) | | | | | | | | 5 | | |
| (D-6) | | | | | | | | | 5 | |
| (E-1) | 0.1 | 0.1 | 0.1 | 0.1 | 0.1 | 0.1 | 0.1 | 0.1 | 0.1 | 0.1 |
| (F-1) | 0.1 | 0.1 | 0.1 | 0.1 | 0.1 | 0.1 | 0.1 | 0.1 | 0.1 | 0.1 |
| (G-1) | 130 | 130 | 130 | 130 | 130 | 130 | 130 | 130 | 130 | 130 |
| (G-2) | 56 | 56 | 56 | 56 | 56 | 56 | 56 | 56 | 56 | 56 |

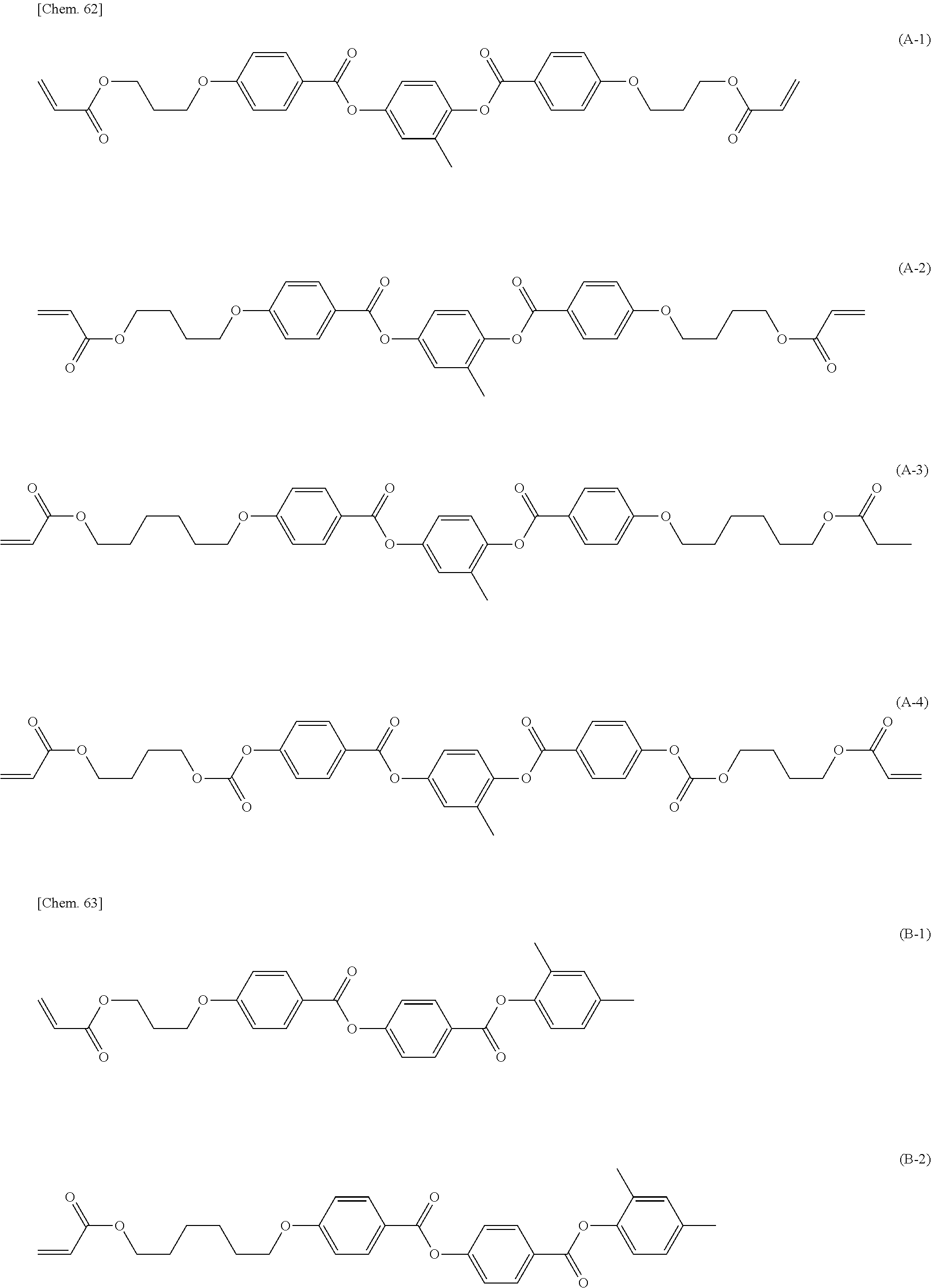

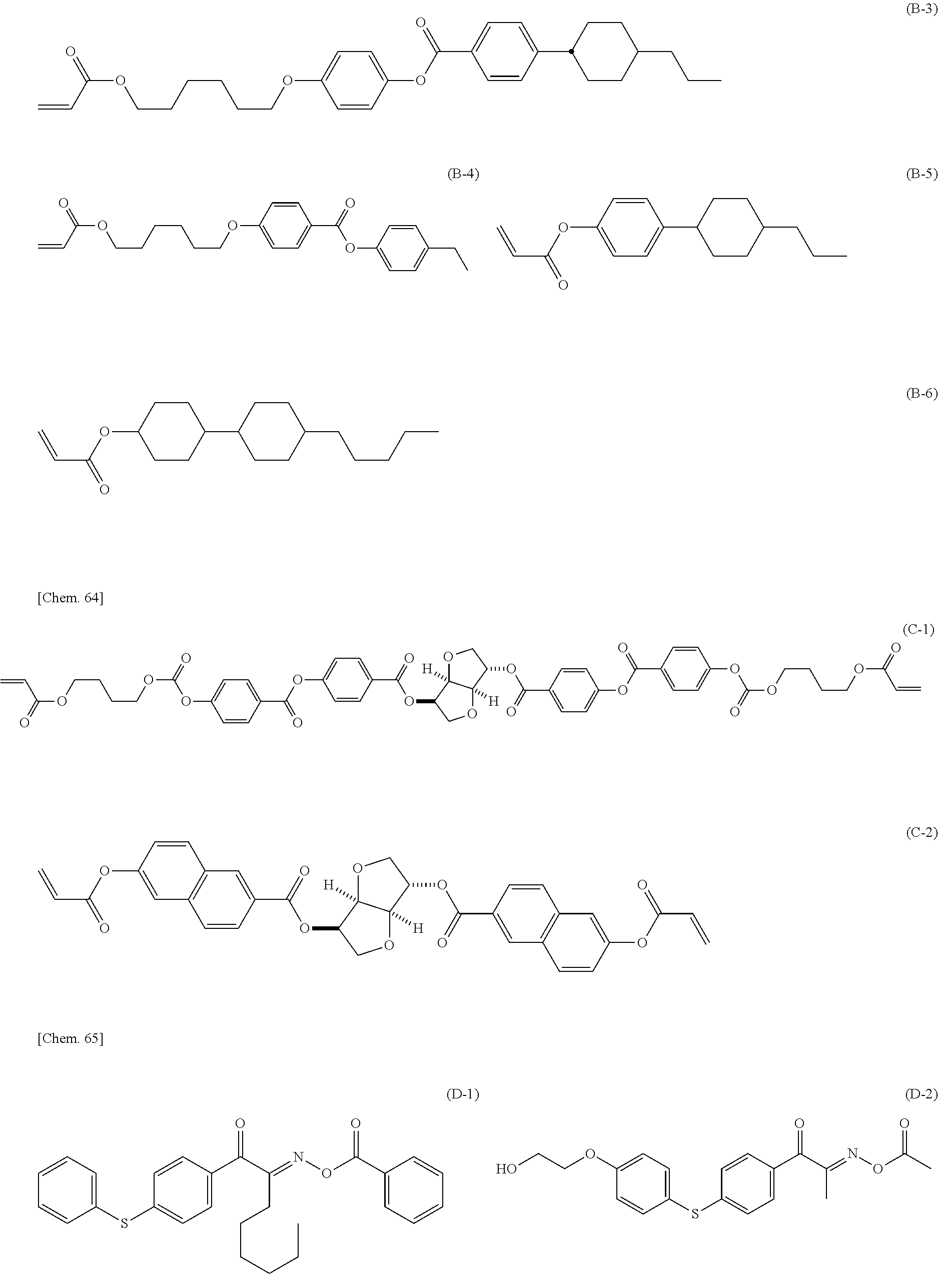

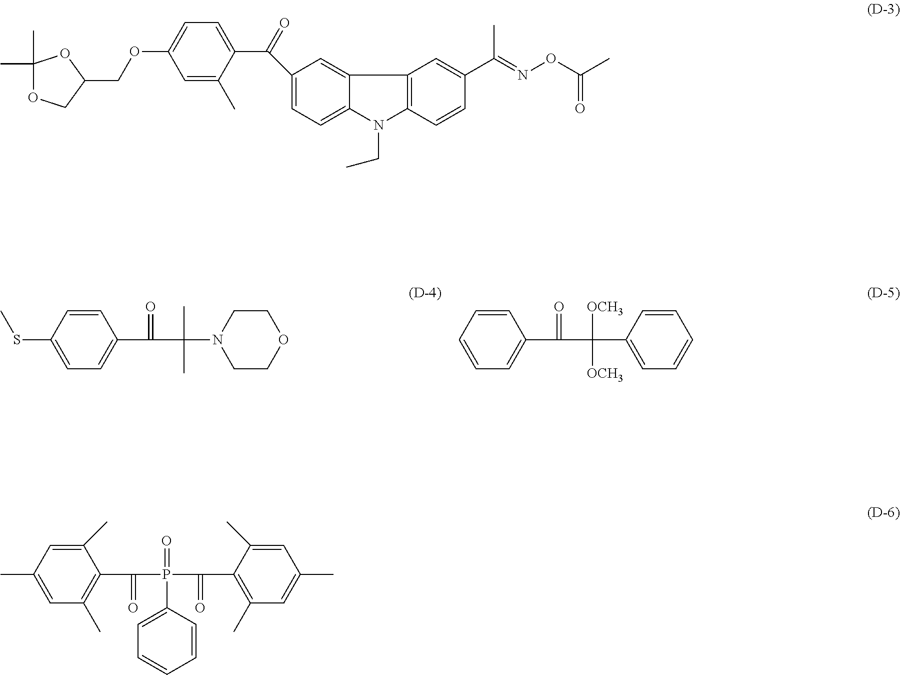

P-methoxyphenol (E-1)

Megaface R-40 (manufactured by DIC Corporation) (F-1)

Toluene (G-1)

Methyl ethyl ketone (G-2)

### Example 1

### (Measurement of Selective Reflection Wavelength)

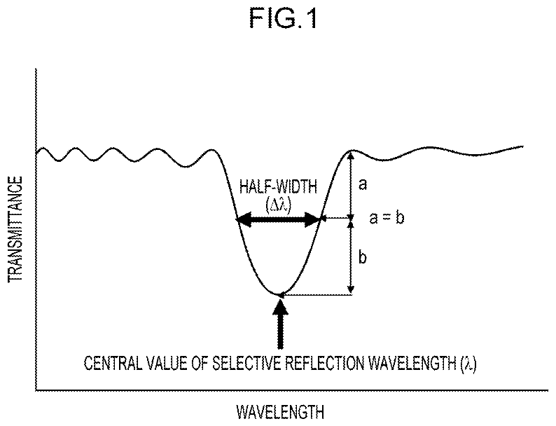

The prepared polymerizable liquid crystal composition (1) was applied to a glass substrate having a rubbed polyimide for horizontal alignment (SE-6414 manufactured by Nissan Chemical Industries, Ltd.) by a spin coating method at room temperature (25° C.) and at a rotational speed of 800 rpm for 15 seconds, was dried at 60° C. for 2 minutes, was left to stand at 25° C. for 1 minute, and was irradiated with 420 mJ/cm² UV light from a conveyor type metal halide lamp at a UVA maximum illuminance of 300 mW/cm² at room temperature to form a thin film of Example 1. The spectral transmittance of the resulting thin film was measured with an ultraviolet-visible spectrophotometer V-560 (manufactured by JASCO Corporation). The central value (λ) of a selective reflection wavelength and its half-width (Δλ) illustrated in FIG. 1 were determined from the spectral transmittance. Likewise, (λ) and (Δλ) were also determined after the thin film was left to stand in an oven at 85° C. for 24 hours.

### Examples 2 to 20 and Comparative Examples 1 to 4

Thin films of the polymerizable liquid crystal compositions (2) to (20) were also formed in the same manner, and (λ) and (Δλ) were determined before and after heating. In Examples 2 and 16, the UV radiation was changed to 90 mJ/cm² UV light with a UVA maximum illuminance of 120 mW/cm². In Examples 3 and 17, the UV radiation was changed to 2500 mJ/cm² UV light with a UVA maximum illuminance of 1000 mW/cm².

The results are shown in the tables below.

TABLE 3

| | | | | | | After 85° C. for | | Reflection |
|---|---|---|---|---|---|---|---|---|
| | | UV | UV | Initial | | 24 hours | | wavelenth |
| | | radiation | radiation | Reflection | Half- | Reflection | Half- | shift due to |
| | | intensity | energy | wavelength | width | wavelength | width | heating |
| | Composition | (mW/cm²) | (mJ/cm²) | λ (nm) | Δλ (nm) | λ (nm) | Δλ (nm) | (nm) |
| Example 1 | Composition (1) | 300 | 420 | 591 | 57 | 591 | 57 | 0 |
| Example 2 | Composition (1) | 120 | 90 | 590 | 58 | 595 | 57 | 5 |
| Example 3 | Composition (1) | 1000 | 2500 | 590 | 56 | 584 | 56 | −6 |
| Example 4 | Composition (2) | 300 | 420 | 593 | 58 | 596 | 57 | 3 |
| Example 5 | Composition (3) | 300 | 420 | 591 | 57 | 596 | 57 | 5 |
| Example 6 | Composition (4) | 300 | 420 | 595 | 50 | 595 | 50 | 0 |
| Example 7 | Composition (5) | 300 | 420 | 594 | 71 | 590 | 70 | −4 |
| Example 8 | Composition (6) | 300 | 420 | 596 | 71 | 592 | 70 | −4 |
| Example 9 | Composition (7) | 300 | 420 | 596 | 73 | 592 | 72 | −4 |
| Example 10 | Composition (8) | 300 | 420 | 590 | 59 | 591 | 58 | 1 |
| Example 11 | Composition (9) | 300 | 420 | 600 | 58 | 601 | 58 | 1 |
| Example 12 | Composition (10) | 300 | 420 | 598 | 70 | 598 | 70 | 0 |
| Example 13 | Composition (11) | 300 | 420 | 598 | 71 | 601 | 70 | 3 |
| Example 14 | Composition (12) | 300 | 420 | 595 | 68 | 594 | 67 | −1 |
| Example 15 | Composition (13) | 300 | 420 | 590 | 67 | 591 | 66 | 1 |
| Example 16 | Composition (13) | 120 | 90 | 589 | 68 | 595 | 68 | 6 |
| Example 17 | Composition (13) | 1000 | 2500 | 588 | 67 | 583 | 7 | −5 |
| Example 18 | Composition (14) | 300 | 420 | 590 | 68 | 594 | 69 | 4 |
| Example 19 | Composition (15) | 300 | 420 | 588 | 69 | 595 | 68 | 7 |
| Example 20 | Composition (16) | 300 | 420 | 595 | 59 | 602 | 59 | 7 |

TABLE 4

| | | | | | | After 85° C. | | |
|---|---|---|---|---|---|---|---|---|
| | | UV | UV | Initial | | for 24 hours | | Reflection |
| | | radiation | radiation | Reflection | Half- | Reflection | Half- | wavelength |
| | | intensity | energy | wavelenth | width | wavelength | width | shift due to |
| | Composition | (mW/cm²) | (mJ/cm²) | λ (nm) | Δλ (nm) | λ (nm) | Δλ (nm) | heating (nm) |
| Comparative | Composition (17) | 300 | 420 | 592 | 57 | 569 | 57 | −23 |
| example 1 | | | | | | | | |
| Comparative | Composition (18) | 300 | 420 | 579 | 50 | 568 | 49 | −11 |
| example 2 | | | | | | | | |
| Comparative | Composition (19) | 300 | 420 | 582 | 51 | 570 | 51 | −12 |
| example 3 | | | | | | | | |
| Comparative | Composition (20) | 300 | 420 | 595 | 72 | 585 | 71 | −10 |
| example 4 | | | | | | | | |

The results show that the shift in the selective reflection wavelength (λ) due to heating at 85° C. for 24 hours was smaller in the compositions of the examples than in the compositions of the comparative examples.

1. A polymerizable liquid crystal composition comprising: a bifunctional polymerizable liquid crystal compound represented by the following general formula (I-2); a chiral compound; and an oxime ester polymerization initiator,
P¹²¹-(Sp¹²¹-X¹²¹)_{q121}-MG¹²¹-(X¹²²-Sp¹²²)_{q122}-P¹²² (I-2)
(wherein P¹²¹ and P¹²² independently denote a polymerizable functional group, Sp¹²¹ and Sp¹²² independently denote an alkylene group having 1 to 18 carbon atoms or a single bond, one —CH₂— or two or more nonadjacent —CH₂— groups in the alkylene group are independently optionally substituted with —COO—, —OCO—, or —OCO—O—, aud one or two or more hydrogen atoms of the alkylene group are optionally substituted with a halogen atom or a CN group,
X¹²¹ aud X¹²² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CHCH—OCO—, —COO—CH═CH—, —OCO—CHCH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P¹²¹-Sp¹²¹, P¹²²-Sp¹²², -Sp¹²¹-X¹²¹, and -Sp¹²²-X¹²² have no direct bonding of heteroatoms), and q121 and q122 independently denote 0 or 1, and
IMG¹²¹ denotes a mesogenic group represented by the general formula (I-2-b),
-(A1-Z1)ᵣ₁-A2-Z2-A3- (I-2-b)
in the general formula (I-2-b), A1, A2, aud A3 independently denote a 1,4-phenylene group, a 1,4-cyclohexylene group, a 1,4-cyclohexenyl group, a tetrahydropyran-2,5-diyl group, a 1,3-dioxane-2,5-diyl group, a tetrahydrothiopyran-255-diyl group, a 1,4-bicyclo(2,2,2)octylene group, a decahydronaphthalene-2,6-diyl group, a pyridine-2,5-diyl group, a pyrimidine-2,5-diyl group, a pyrazine-2,5-diyl group, a thiophene-2,5-diyl group, a 1,2,3,4-tetrahydronaphthalene-2,6-diyl group, a 2,6-naphthylene group, a phenanthrene-2,7-diyl group, a 9,10-dihydrophenanthrene-2,7-diyl group, a 1,2,3,4,4a,9,10a-octahydrophenanthrene-2,7-diyl group, a 1,4-naphthylene group, a benzo[1,2-b:4,5-b′]dithiophene-2,6-diyl group, a benzo[1,2-b:4,5-b′]diselenophene-2,6-diyl group, a [1]benzothieno[3,2-b]thiophene-2,7-diyl group, a [1]benzoselenopheno[32-b]selenophene-2,7-diyl group, Or a fluorene-2,7-diyl group, Z1 and Z2 independently denote —COO—, —OCO—, —CH₂CH₂—, —OCH₂—, —CH₂O—, —CH═CH—, —C≡C—, —CH═CHCOO—, —OCOCH═CH—, —CH₂CH₂COO—, —CH₂CH₂OCO—, —COOCH₂CH₂—, —OCOCH₂CH₂—, —C═N—, —N═C—, —CONH—, —NHCO—, —C(CF₃)₂—, an alkyl group having 2 to 10 carbon atoms and optionally having a halogen atom, or a single bond, r1 denotes 0, 1, 2, or 3, a plurality of A1s, if present, may be the same or different, and a plurality of Z1s, if present, may be the same or different).

2. A polymerizable liquid crystal composition according to claim 1, wherein the polymerizable liquid crystal compound is a polymerizable liquid crystal compound represented by the following general formula (I-1), 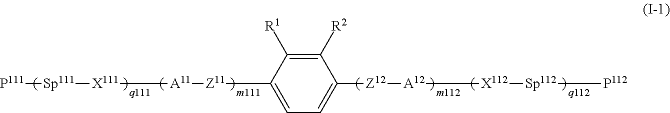
(wherein P¹¹¹ and P¹¹² independently denote a polymerizable functional group, Sp¹¹¹ and Sp¹¹² independently denote an alkylene group having 1 to 18 carbon atoms or a single bond, one —CH₂— or two or more nonadjacent —CH₂— groups in the alkylene group are independently optionally substituted with —COO—, —OCO—, or —OCO—O—, and one or two or more hydrogen atoms of the alkylene group are optionally substituted with a halogen atom or a CN group,
X¹¹¹ and X¹¹² independently denote —O—, —S—, —OCH₂—, —CH₂O—, —CO—, —COO—, —OCO—, —CO—S—, —S—CO—, —O—CO—O—, —CO—NH—, —NH—CO—, —SCH₂—, —CH₂S—, —CF₂O—, —OCF₂—, —CF₂S—, —SCF₂—, —CH═CH—COO—, —CH—CH—OCO—, —COO—CHCH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—N═CH—, —CF═CF—, —C≡C—, or a single bond (provided that P¹¹¹-Sp¹¹¹, P¹¹²-Sp¹¹², -Sp¹¹¹-X¹¹¹-, and -Sp¹¹²-X¹¹²- have no direct bonding of oxygen atoms),
q111 and q112 independently denote 0 or 1,
A¹¹ and A¹² independently denote a 1,4-phenylene group, a 1,4-cyclohexylene group, a bicyclo[2,2,2]octane-1,4-diyl group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, and these groups are unsubstituted or optionally substituted with at least one substituent L,
L denotes a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, an optionally substituted phenyl group, an optionally substituted phenylalkyl group, an optionally substituted cyclohexylalkyl group, or a linear or branched alkyl group having 1 to 20 carbon atoms in which one —CH₂— or two or more nonadjacent —CH₂— groups are independently optionally substituted with —O—, —S—, —CO—, —COO—, —OCO—, —CO—S—, —S—CO—, —O—CO—O—, —CO—NR⁰—, —NR⁰—CO—, —CH═CH—COO—, —CH═CH—COO—, —COO—CH═CH—, —OCO—CH═CH—, —CH═CH—, —N═N—, —CR⁰═N—, —CH═N—N═CH—, —CF═CF—, or (wherein R⁰ denotes a hydrogen atom or an alkyl group having 1 to 8 carbon atoms), a hydrogen atom of the alkyl group is optionally substituted with a fluorine atom, a plurality of Ls, if present, in the compound may be the same or different, a plurality of A¹¹s, if present, may be the same or different, and a plurality of A¹²s, if present, may be the same or different,
Z¹¹ and Z¹² independently denote —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CFS—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH's-COO—, —CH₂—OCO—, —CH═CH—, —N═N—, —CH═N—, —N═CH—, —CH═N—N═CH—, —CF═CF—, or a single bond, a plurality of Z¹¹s, if present, may be the same or different, and a plurality of Z¹²s, if present, may be the same or different,
m111 and m112 independently denote an integer in the range of 0 to 2, and
R¹ and R² independently denote a hydrogen atom, a fluorine atom, a cyano group, a hydroxy group, a nitro group, an alkyl group having 1 to 10 carbon atoms, an alkoxy group having 1 to 10 carbon atoms, an acyl group having 2 to 10 carbon atoms, an alkylcarbonyloxy group having 2 to 10 carbon atoms, an alkoxycarbonyl group having 2 to 10 carbon atoms, or an aromatic ring group having 5 to 12 carbon atoms, R¹ or R² denotes a group other than a hydrogen atom, or R², together with the substituent L of adjacent A¹² denotes a cyclic group).

3. The polymerizable liquid crystal composition according to claim 1, further comprising a monofunctional polymerizable liquid crystal compound represented by the following general formula (II-2), in addition to the bifunctional polymerizable liquid crystal compound,
p²²¹-Sp²²¹-X²²¹-MG²²¹-R²²¹ (II-2)
(wherein P²²¹ denotes a polymerizable functional group, Sp²²¹ denotes an alkylene group having 1 to 18 carbon atoms or a single bond, one —CH₂— or two or more nonadjacent —CH₂— groups in the alkylene group are independently optionally substituted with —O—, —COO—, —OCO—, or —OCO—O—, one or two or more hydrogen atoms of the alkylene group are optionally substituted with a halogen atom or a CN group, X²²¹ denotes —O—, —S—, —OCH₂—, —CH₂O—, —CO—, —OCO—, —CO—S—, —S—CO—, —O—CO—O—, —CO—NH—, —NH—CO—, —SCH₂—, —CH₂S—, —CF₂O—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —COO—CH₂—, —CH₂—COO—, —CH₂—OCO—, —CH═CH—, —N═N—, —CH═N—N═CH—, —CF═CF—, or —C≡C—, a single bond (provided that P²²¹-Sp²²¹ and Sp²²¹-X²²¹ have no direct bonding of heteroatoms other than C or H), MG²²¹ denotes a mesogenic group, R²²¹ denotes a hydrogen atom, a halogen atom, a cyano group, a linear or branched alkyl group having 1 to 12 carbon atoms, or a linear or branched alkenyl group having 1 to 12 carbon atoms, one —CH₂— or two or more nonadjacent —CH₂— groups in the alkyl group and the alkenyl group are independently optionally substituted with —O—, —S—, —CO—, —COO—, —OCO—, —CO—S—, —S—CO—, —O—CO—O—, —CO—NH—, —NH—CO—, —NH—, —N(CH₃)—, —CH═CH—COO—, —CH═CH—OCO—, —COO—CH═CH—, —OCO—CH═CH—, —CH═CH—, —CF═CF—, or —C≡C—, one or two or more hydrogen atoms of the alkyl group and the alkenyl group are independently optionally substituted with a halogen atom or a cyano group, and a plurality of substituents, if present, may be the same or different).

4. A polymerizable liquid crystal composition according to claim 3, wherein the monofunctional polymerizable liquid crystal compound is represented by the following general formula (II-1), 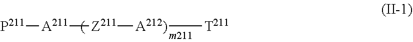
(in the general formula (II-1), P²¹¹ denotes a polymerizable functional group,
A²¹¹ and A²¹² independently denote a 1,4-phenylene group, a 1,4-cyclohexylene group, a bicyclo[2,2,2]octane-1,4-diyl group, a pyridine-2,5-diyl group, a pyrimidine-2,5-diyl group, a naphthalene-2,6-diyl group, a naphthalene-1,4-diyl group, a tetrahydronaphthalene-2,6-diyl group, a decahydronaphthalene-2,6-diyl group, or a 1,3-dioxane-2,5-diyl group, and these groups are unsubstituted or optionally substituted with at least one substituent L,
L denotes a fluorine atom, a chlorine atom, a bromine atom, an iodine atom, a pentafluorosulfuranyl group, a nitro group, a cyano group, an isocyano group, an amino group, a hydroxy group, a mercapto group, a methylamino group, a dimethylamino group, a diethylamino group, a diisopropylamino group, a trimethylsilyl group, a dimethylsilyl group, a thioisocyano group, an optionally substituted phenyl group, an optionally substituted phenylalkyl group, an optionally substituted cyclohexylalkyl group, or a linear or branched alkyl group having 1 to 20 carbon atoms in which one —CH₂— or two or more nonadjacent —CH₂— groups are independently optionally substituted with —O—, —S—, —CO—, —COO—, —OCO—, —CO—S—, —S—CO—, —O—CO—O—, —CO—NR⁰—, —NR⁰—CO—, —CH═CH—COO—, —CH═CH—OCO—, —COO—CH═CH—, —OCO—CHCH—, —CH═CH—, —N═N—, —CR⁰═N—, —N═CR⁰—, —CH═N—N═CH—, —CF═CF—, or —C≡C— (wherein R⁰ denotes a hydrogen atom or an alkyl group having 1 to 8 carbon atoms), a hydrogen atom of the alkyl group is optionally substituted with a fluorine atom, a plurality of Ls, if present, in the compound may be the same or different, a plurality of A²¹²s, if present, may be the same or different,
Z²¹¹ denotes —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—COO—, —CH₂CH₂—OCO—, —COO—CH₂—, —OCO—CH₂—, —CH₂—COO—, —CH₂—OCO—, —CH═CH—, —N═N—, —CH═N—, —N═CH—, —CH═N—N═CH—, —CF═CF—, —C≡C—, or a single bond, a plurality of Z²¹¹s, if present, may be the same or different,
m211 denotes an integer in the range of 1 to 3, and
T²¹¹ denotes a hydrogen atom, a —OH group, a —SH group, a —CN group, a —COOH group, an —NH₂ group, a —NO₂ group, a —COCH₃ group, —O(CH₂)ₙCH₃, or —(CH₂)₁CH₃, and n denotes integer in the range of 0 to 20).

5. The polymerizable liquid crystal composition according to claim 3, wherein the abundance ratio [bifunctional polymerizable liquid crystal compound/monofunctional polymerizable liquid crystal compound] of the bifunctional polymerizable liquid crystal compound to the monofunctional polymerizable liquid crystal compound based on mass ranges from 90/10 to 30/70.

6. A polymerizable liquid crystal composition according to claim 1, wherein the oxime ester polymerization initiator is represented by the following general formula (4-2), 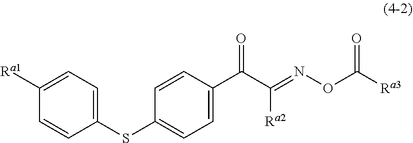
(wherein R^{a1} denotes a linear or branched alkyl group having 1 to 20 carbon atoms in which one —CH₂— or two or more nonadjacent —CH₂— groups are independently optionally substituted with —O—, —CO—, —COO—, or —OCO—, or a hydrogen atom,
R^{a2} denotes a linear or branched alkyl group having 1 to 20 carbon atoms in which one —CH₂— or two or more nonadjacent —CH₂— groups are independently optionally substituted with —O—, —CO—, —COO—, or —OCO—, and
R^{a3} denotes a linear or branched alkyl group having 1 to 20 carbon atoms in which one —CH₂— or two or more nonadjacent —CH₂— groups are independently optionally substituted with —O—, —CO—, —COO—, or —OCO—, a phenyl group optionally having at least one substituent L, or a hydrogen atom).

7. The polymerizable liquid crystal composition according to claim 1, further comprising an organic solvent.

8. An optical film comprising a cured product of the polymerizable liquid crystal composition according to claim 1.

9. A method for producing an optical film, comprising: applying the polymerizable crystal composition according to claim 7 to a substrate, drying the polymerizable liquid crystal composition, and then irradiating the polymerizable liquid crystal composition with ultraviolet light.

10. An image display apparatus comprising, the optical film according to claim 8.
